(19) United States
(12) Patent Application Publication
(10) Pub. No.: US 2022/0112119 A1
(43) Pub. Date: Apr. 14, 2022

(54) GLASS-BASED ARTICLES AND PROPERTIES THEREOF

(71) Applicant: CORNING INCORPORATED, Corning, NY (US)

(72) Inventors: Jaymin Amin, Corning, NY (US); George Halsey Beall, Big Flats, NY (US); Qiang Fu, Painted Post, NY (US); Charlene Marie Smith, Corning, NY (US); Ljerka Ukrainczyk, Ithaca, NY (US)

(73) Assignee: CORNING INCORPORATED, Corning, NY (US)

(21) Appl. No.: 17/499,383

(22) Filed: Oct. 12, 2021

Related U.S. Application Data
(60) Provisional application No. 63/090,688, filed on Oct. 12, 2020.

(51) Int. Cl. C03C 3/097; C03C 21/00; C03C 4/18

(52) U.S. Cl. CPC C03C 3/097; C03C 2204/00; C03C 4/18; C03C 21/001

(57) ABSTRACT

Glass-based articles, such as glass-ceramic articles, and the properties thereof are disclosed. In embodiments, the glass-based article may comprise the glass-based article has a phase assemblage comprising petalite and lithium disilicate.

This application claims the benefit of priority under 35 U.S.C. § 119 of U.S. Provisional Application Ser. No. 63/090,688 filed on Oct. 12, 2020, the content of which is relied upon and incorporated herein by reference in its entirety.

### FIELD

The present specification generally relates to glass-based articles and, more particularly, glass-ceramic articles formed from precursor glass compositions.

### TECHNICAL BACKGROUND

Various industries, including the consumer electronics industry, desire glass-based materials with relatively high strength. Glass-based articles, such as glass-ceramic articles may exhibit this property, at least relative to glass articles. However, other properties of the glass-ceramic articles may be insufficient for the intended use, including, without limitation, the light transmission characteristics, the drop performance characteristics, the scratch characteristics, and fracture toughness.

Accordingly, a need in the art exists for alternative glass-based articles.

### SUMMARY

Aspect 1. A glass-based article comprising: greater than or equal to 60 mol % and less than or equal to 72 mol % SiO₂; greater than 0 mol % and less than or equal to 6 mol % Al₂O₃; greater than or equal to 0 mol % and less than or equal to 2 mol % B₂O₃; greater than or equal to 20 mol % and less than or equal to 32 mol % Li₂O; greater than or equal to 0 mol % and less than or equal to 2 mol % Na₂O; greater than or equal to 0 mol % and less than or equal to 2 mol % K₂O; greater than or equal to 0.7 mol % and less than or equal to 2.2 mol % P₂O₅; and greater than or equal to 1.7 mol % and less than or equal to 4.5 mol % ZrO₂, wherein: the glass-based article has a phase assemblage comprising from 35-50 wt % petalite, 35-50 wt %, lithium disilicate, wherein a ratio of lithium disilicate to petalite is 0.8-1.

Aspect 2. The glass-based article of aspect 1 comprising: a surface compressive stress greater than or equal to 200 MPa and less than or equal to 350 MPa; and a depth of compression of greater than or equal to 0.14*t to less than or equal to 0.24*t, wherein t is a thickness of the glass article.

Aspect 3. The glass-based article of any one of aspect 1 or 2, wherein the depth of compression is greater than or equal to 85 μm and less than or equal to 150 μm.

Aspect 4. The glass-based article of any one of aspects 1 to 3, wherein the crystal grains of the glass-based article have an aspect ratio greater than 4.

Aspect 5. The glass-based article of any one of aspects 1 to 4, wherein a maximum dimension of the crystal grains of the glass-based article is less than 200 nm.

Aspect 6. The glass-based article of any one of aspects 1 to 5, comprising a fracture toughness greater than or equal to 1 MPa*m^{1/2}.

Aspect 7. The glass-based article of any one of aspects 1 to 6, comprising a transmittance color coordinate in CIELAB color space of L*=from 70 to 100; a*=from −20 to 40; and b*=from −60 to 60, for a CIE illuminant F02 under SCI UVC conditions.

Aspect 8. The glass-based article of any one of aspects 1 to 7, comprising a refractive index greater than or equal to 1.50 and less than or equal to 1.60.

Aspect 9. The glass-based article of any one of aspects 1 to 8, comprising an elastic modulus greater than or equal to 95 GPa and less than or equal to 110 GPa.

Aspect 10. The glass-based article of any one of aspects 1 to 9, comprising a density greater than or equal to 2.35 g/cm³ and less than or equal to 2.6 g/cm³.

Aspect 11. The glass-based article of any one of aspects 1 to 10, comprising an average visible transmittance greater than or equal to 89% at an article thickness of 0.6 mm for wavelengths from 400 nm to 770 nm.

Aspect 12. The glass-based article of any one of aspects 1 to 11, comprising an average visible reflectance greater than or equal to 4.4% and less than or equal to 4.8% at an article thickness of 0.6 mm for wavelengths from 400 nm to 770 nm.

Aspect 13. The glass-based article of any one of aspects 1 to 12, comprising an average UV transmittance greater than or equal to 70% at an article thickness of 0.6 mm for wavelengths from 350 nm to 400 nm.

Aspect 14. The glass-based article of any one of aspects 1 to 13, comprising an average UV reflectance greater than or equal to 4.7% and less than or equal to 5.0% at an article thickness of 0.6 mm for wavelengths from 350 nm to 400 nm.

Aspect 15. The glass-based article of any one of aspects 1 to 15, comprising an average infrared transmittance greater than or equal to 89% at an article thickness of 0.6 mm for wavelengths from 770 nm to 1000 nm.

Aspect 16. The glass-based article of any one of aspects 1 to 15, comprising an average infrared reflectance greater than or equal to 4.3% and less than or equal to 4.5% at an article thickness of 0.6 mm for wavelengths from 770 nm to 1000 nm.

Aspect 17. The glass-based article of any one of aspects 1 to 16, wherein a central tension is from greater than or equal to 90 MPa to less than or equal to 125 MPa.

Aspect 18. The glass-based article of any one of aspects 1 to 17, wherein a ratio of central tension to integrated tension area is from greater than or equal to 3.0 μm⁻¹ to less than or equal to 5.5 μm⁻¹.

Aspect 19. The glass-based article of any one of aspects 1 to 18, wherein a ratio of central tension to depth of compression is from greater than or equal to 0.6 MPa/μm to less than or equal to 1.0 MPa/μm.

Aspect 20. The glass-based article of any one of aspects 1 to 19, wherein a haze of the glass-based article is less than or equal to 0.15%.

Aspect 21. The glass-based article of any one of aspects 1 to 20, wherein the glass-based article has a failure height of greater than or equal to 100 cm.

Aspect 22. The glass-based article of any one of aspects 1 to 21, wherein the glass-based article has a retained strength of greater than or equal to 250 MPa.

Aspect 23. The glass-based article of any one of aspects 1 to 22, wherein the glass-based article has a hardness measured on the Mohs scale that is greater than or equal to 7.0.

Aspect 24. The glass-based article of any one of aspects 1 to 23, wherein the glass-based article has a scratch width of less than 300 μm when conducted using Knoop scratch testing at loads up to 8 N.

Aspect 25. The glass-based article of any one of aspects 1 to 24, wherein the glass-based article has a scratch width of less than 300 μm when conducted using conospherical scratch testing at loads up to 2 N.

Aspect 26. The glass-based article of any one of aspects 1 to 25, wherein the glass-based article has a fracture toughness greater than or equal to 1.0 MPa*m^{1/2}.

Aspect 27. The glass-based article of any one of aspects 1 to 26, wherein the glass-based article has a Poisson's ratio rom greater than or equal to 0.10 to less than or equal to 0.20.

Aspect 28. The glass-based article of any one of aspects 1 to 27, wherein the glass-based article has a shear modulus from greater than or equal to 35 GPa to less than or equal to 50 GPa.

Aspect 29. The glass-based article of any one of aspects 1 to 28, wherein a non-ion exchanged glass-based article has a Vicker's Hardness of greater than or equal to 750 kg_{f}/mm² to less than or equal to 840 kg_{f}/mm².

Aspect 30. The glass-based article of any one of aspects 1 to 29, wherein an ion exchanged glass-based article has a Vicker's Hardness of greater than or equal to 770 kg_{f}/mm² to less than or equal to 860 kg_{f}/mm².

Aspect 31. The glass-based article of any one of aspects 1 to 30, wherein the glass-based article has a volume resistivity from greater than or equal to 6.8 log(Ω-cm) to less than or equal to 8.3 log(Ω-cm).

Additional features and advantages of the glass-based articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 depicts an 31P NMR graph of phase assemblages for glass-ceramics;

FIGS. 2 and 3 are SEM micrographs depicting the interlocking or entangled microstructure of the formed glass-ceramic article that enhances the fracture toughness;

FIG. 4 schematically depicts a glass or glass-ceramic article having compressive stress regions;

FIGS. 5-8 are plots of CT/TA and CT*TA at various IOX conditions;

FIGS. 9 and 10 are plots of CT/DOC at various IOX conditions;

FIG. 11 is a transmittance curve of ion exchanged and non-ion exchanged glass-based articles;

FIGS. 12-14 schematically depict an apparatus and process for a drop testing a glass-based article;

FIG. 15 schematically depicts an apparatus and process for impact testing a glass-based article;

FIG. 16 shows AFM images of glass-based articles;

FIG. 17 graphically depicts surface roughness at various washing cycles using detergents with differing pH.

FIG. 18 shows AFM images of glass-based articles;

FIGS. 19 and 20 graphically depict water contact angle versus cycles of glass-based articles washed with detergents having differing pH;

FIG. 21 graphically depicts stress versus depth for ion exchange glass-based articles;

FIGS. 22-25 graphically depict results of drop testing of glass-based articles;

FIG. 26 shows the results of hardness measured on the Mohs scale for 0.8 mm thick glass-based articles;

FIG. 27 shows the mean maximum width in μm for Knoop Scratch tests on glass-based articles;

FIG. 28 shows the mean maximum width in μm for Conospherical Scratch tests on glass-based articles;

FIG. 29 shows a five step process of the corrosion testing;

FIG. 30 shows SIMS depth profiles of ion exchanged parts in pre-damp heat aging;

FIG. 31 shows optical micrographs glass-ceramics held for 500 hours at 85° C. and 85% relative humidity after being treated with 0.05% Li and 0.065% Li and corresponding FSM data;

FIG. 32 shows optical micrographs glass-ceramics held for 500 hours at 85° C. and 85% and corresponding FSM;

FIG. 33 shows SIMS depth profiles of approximate Na and OH concentrations before and after 500 hours at 85° C. and 85% relative humidity on glass-based articles, and corresponding FSM;

FIG. 34 shows SIMS depth profiles of approximate Na and OH concentrations before and after 500 hours at 85° C. and 85% relative humidity on glass-based articles and corresponding FSM;

FIG. 35 shows corrosion of glass-ceramics after 500 hours in 85° C. and 85% relative humidity and alkali species;

FIG. 36 is SIMS showing depth profiles of 0.6 mm SIOX and 0.5 mm new DIOX with near surface alkali changes limited to less than 0.1 μm after 500 hours in 85° C. and 85% relative humidity;

FIG. 37 is SIMS showing depth profiles of 0.5 mm new DIOX that has minimal near surface alkali changes compared to original DIOX after 72 hours in 85° C. and 85% relative humidity, and corresponding FSM;

FIG. 38 is SIMS showing depth profiles and corresponding FSM;

FIG. 39 is SIMS showing depth profiles of 0.8 mm new SIOX without Li on the left compared to 0.8 mm SIOX with Li on the right and corresponding FSM;

FIG. 40 is SIMS profiles of a sample ion exchanged with 0.1% Li (on the left) and ion exchanged without Li (on the right);

FIG. 41 is SIMS profiles of a sample ion exchanged with 0.1% Li (on the left) and ion exchanged without Li (on the right);

FIG. 42 shows hydrogen diffusion relative to depth for samples that were not ion exchanged with Li and for samples that were ion exchanged with 0.1 wt % Li;

FIG. 43 shows corrosion of glass ceramics after 500 hours in 85° C. and 85% relative humidity;

FIG. 44 is FSM images of glass-based articles for heat soaks were all performed at 85° C. and 85% relative humidity;

FIG. 45 is a cross hatch micrograph showing alternating layers;

FIG. 46 shows an SIMS profile on the left and micrograph of corrosion on the right of glass-ceramics prepared without Li present in the ion exchange, and FSM showing a blurry transition;

FIG. 47 shows depth of elemental ingress in mole fraction in the left image and concentration of components versus depth in the right image;

FIG. 48 shows an SIMS profile on the left and micrograph of corrosion on the right of glass-ceramics prepared without Li present in the ion exchange, and the FSM showing a blurry transition;

FIG. 49 shows depth of elemental ingress in mole fraction in the left image and concentration of components versus depth in the right image;

FIG. 50 shows depth of elemental ingress in mole fraction in the left image and a micrograph of the surface of the glass-ceramic where Li is present in the ion exchange;

FIG. 51 shows depth of elemental ingress in mole fraction in the left image and concentration of components versus depth in the right image;

FIG. 52 shows depth of elemental ingress in mole fraction in the left image and a micrograph of the surface of the glass-ceramic where Li is present in the ion exchange, and FSM showing a sharp transition;

FIG. 53 shows depth of elemental ingress in mole fraction in the left image and concentration of components versus depth in the right;

FIG. 54 shows depth of elemental ingress in mole fraction in the left image and a micrograph of the surface of the glass-ceramic where Li is present in the ion exchange, and FSM image;

FIG. 55 shows depth of elemental ingress in mole fraction in the left image and concentration of components versus depth in the right image;

FIG. 56 shows depth of elemental ingress in mole fraction in the left image and a micrograph of the surface of the glass-ceramic where Li is present in the ion exchange; and

FIG. 57 shows depth of elemental ingress in mole fraction in the left image and concentration of components versus depth in the right image.

### DETAILED DESCRIPTION

Disclosed herein are glass-based articles. As used herein, the terms “glass-based” and/or “glass-based article” mean any material or article made at least partially of glass, including glass and glass-ceramic materials. In embodiments, the glass-based article may be formed from a precursor glass composition that, when exposed to an appropriate heat treatment, converts the precursor glass composition to a glass-ceramic glass composition that includes at least one crystal phase.

The term “softening point,” as used herein, refers to the temperature at which the viscosity of the precursor glass composition is 1×10^{7.6} poise.

The term “annealing point,” as used herein, refers to the temperature at which the viscosity of the precursor glass composition is 1×10¹³ poise.

The terms “strain point” and “Tₛₜᵣₐᵢₙ” as used herein, refers to the temperature at which the viscosity of the precursor glass composition is 3×10¹⁴ poise.

The term “liquidus temperature,” as used herein, refers to the maximum temperature at which crystals can co-exist with molten glass in the glass melt in thermodynamic equilibrium.

The elastic modulus (also referred to as Young's modulus) of the glass-based article is provided in units of gigapascals (GPa). The elastic modulus of the glass is determined by resonant ultrasound spectroscopy on bulk samples of each glass-based article in accordance with ASTM C623.

The term “CTE,” as used herein, refers to the coefficient of thermal expansion of the glass-based article over a temperature range from about 20° C. to about 300° C.

Shear modulus is measured by resonant ultrasound spectroscopy in accordance with ASTM C623.

Strain and annealing points were measured according to the beam bending viscosity method which measures the viscosity of inorganic glass from 10¹² to 10¹⁴ poise as a function of temperature in accordance to with ASTM C598.

Softening points were measured according to the parallel place viscosity method which measures the viscosity of inorganic glass from 10⁷ to 10⁹ poise as a function of temperature, similar to the ASTM C1351M.

Liquidus temperatures were measured with the gradient furnace method according to ASTM C829-81.

The term “single ion exchange process,” as used herein, refers to a process in which the glass-based article is exposed to a single ion exchange solution, such as a KNO₃ or NaNO₃ molten salt bath.

The term “double ion exchange process,” as used herein, refers to a process in which the glass-based article is exposed to a first ion exchange solution and a second ion exchange solution.

The term “multiple ion exchange process,” as used herein, refers to a process in which the glass-based article is exposed to three or more ion exchange solutions.

The term “depth of compression” (DOC), as used herein, refers to the depth at which the stress crosses from a positive (compressive) stress to a negative (tensile) stress and thus exhibits a stress value of zero. DOC is measured by SLP 2000 (405 nm) using 6^{th} order polynomial fit

The term “depth of layer” (DOL), as used herein, refers to the depth within a glass-based article (i.e., the distance from a surface of the glass-based article to its interior region) at which an ion of a metal oxide or alkali metal oxide (e.g., the metal ion or alkali metal ion) diffuses into the glass-based article where the concentration of the ion reaches a minimum value, as determined by Glow Discharge-Optical Emission Spectroscopy (GD-OES)). Unless otherwise specified, the DOL is given as the depth of exchange of the slowest-diffusing ion introduced by an ion exchange (IOX) process.

A non-zero metal oxide concentration that varies from the first surface to a depth of layer (DOL) with respect to the metal oxide or that varies along at least a substantial portion of the article thickness (t) indicates that a stress has been generated in the article as a result of ion exchange. The variation in metal oxide concentration may be referred to herein as a metal oxide concentration gradient. The metal oxide that is non-zero in concentration and varies from the first surface to a DOL or along a portion of the thickness may be described as generating a stress in the glass-based article. The concentration gradient or variation of metal oxides is created by chemically strengthening a glass-based substrate in which a plurality of first metal ions in the glass-based substrate is exchanged with a plurality of second metal ions.

According to the convention normally used in the art, compression or compressive stress is expressed as a negative (<0) stress and tension or tensile stress is expressed as a positive (>0) stress. Throughout this description, however, CS is expressed as a positive or absolute value—i.e., as recited herein, CS=|CS|. The compressive stress (CS) has a maximum at or near the surface of the glass, and the CS varies with distance d from the surface according to a function.

Compressive stress (CS) and depth of layer (DOL) are measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. In the embodiments of the glass-based articles described herein, the concentrations of constituent components (e.g., SiO₂, Al₂O₃, and the like) are specified in mole percent (mol. %) on an oxide basis, unless otherwise specified.

The terms “free” and “substantially free,” when used to describe the concentration and/or absence of a particular constituent component in a glass-based article, means that the constituent component is not intentionally added to the glass-based article. However, the glass-based article may contain traces of the constituent component as a contaminant or tramp in amounts of less than 0.01 mol. %.

Transmittance data (total transmittance and diffuse transmittance) is measured with a Lambda 950 UV/Vis Spectrophotometer manufactured by PerkinElmer Inc. (Waltham, Mass. USA). The Lambda 950 apparatus was fitted with a 150 mm integrating sphere. Data was collected using an open beam baseline and a Spectralon® reference reflectance disk. For total transmittance (Total Tx), the sample is fixed at the integrating sphere entry point. For diffuse transmittance (Diffuse Tx), the Spectralon® reference reflectance disk over the sphere exit port is removed to allow on-axis light to exit the sphere and enter a light trap. A zero offset measurement is made, with no sample, of the diffuse portion to determine efficiency of the light trap. To correct diffuse transmittance measurements, the zero offset contribution is subtracted from the sample measurement using the equation: Diffuse Tx=Diffuse Measured−(Zero Offset*(Total Tx/100)). The scatter ratio is measured for all wavelengths as: (% Diffuse Tx/% Total Tx).

The term “average transmittance,” as used herein, refers to the average of transmittance measurements made within a given wavelength range with each whole numbered wavelength weighted equally. In the embodiments described herein, the “average transmittance” is reported over the wavelength range from 400 nm to 800 nm (inclusive of endpoints).

The term “transparent,” when used to describe a glass-ceramic article formed of a glass-ceramic composition described herein, means that the glass-ceramic article has an average transmittance of greater than or equal to 85% when measured at normal incidence for light in a wavelength range from 400 nm to 800 nm (inclusive of endpoints) at an article thickness of 0.8 mm.

The term “transparent haze,” when used to describe a glass-ceramic article formed of a glass-ceramic composition described herein, means that the glass-ceramic article has an average transmittance of greater than or equal to 70% and less than 85% when measured at normal incidence for light in a wavelength range from 400 nm to 800 nm (inclusive of endpoints) at an article thickness of 0.8 mm.

The term “translucent,” when used to describe a glass-ceramic article formed of a glass-ceramic composition described herein, means that the glass-ceramic article has an average transmittance greater than or equal to 20% and less than 70% when measured at normal incidence for light in a wavelength range from 400 nm to 800 nm (inclusive of endpoints) at an article thickness of 0.8 mm.

The term “opaque,” when used to describe a glass-ceramic article formed of a glass-ceramic composition herein, means that the glass-ceramic composition has an average transmittance less than 20% when measured at normal incidence for light in a wavelength range from 400 nm to 800 nm (inclusive of endpoints) at an article thickness of 0.8 mm.

The term “colorless,” as used herein, means that a sample of the glass-based article with a thickness of 10 mm has a transmittance in the visible portion of the electromagnetic spectrum (i.e., for wavelengths from 380 nm to 740 nm) is greater than 80%.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Petalite (LiAlSi₄O₁₀) is a monoclinic crystal possessing a three-dimensional framework structure with a layered structure having folded Si₂O₅ layers linked by Li and Al tetrahedral. The Li is in tetrahedral coordination with oxygen. Petalite is a lithium source and is used as a low thermal expansion phase to improve the thermal downshock resistance of glass-ceramic or ceramic parts.

In some embodiments, the weight percentage of the petalite crystalline phase in the glass-based articles described herein can be in a range from 20 to 70 wt %, 20 to 65 wt %, 20 to 60 wt %, 20 to 55 wt %, 20 to 50 wt %, 20 to 45 wt %, 20 to 40 wt %, 20 to 35 wt %, 20 to 30 wt %, 20 to 25 wt %, 25 to 70 wt %, 25 to 65 wt %, 25 to 60 wt %, 25 to 55 wt %, 25 to 50 wt %, 25 to 45 wt %, 25 to 40 wt %, 25 to 35 wt %, 25 to 30 wt %, 30 to 70 wt %, 30 to 65 wt %, 30 to 60 wt %, 30 to 55 wt %, 30 to 50 wt %, 30 to 45 wt %, 30 to 40 wt %, 30 to 35 wt %, 35 to 70 wt %, 35 to 65 wt %, 35 to 60 wt %, 35 to 55 wt %, 35 to 50 wt %, 35 to 45 wt %, 35 to 40 wt %, 40 to 70 wt %, 40 to 65 wt %, 40 to 60 wt %, 40 to 55 wt %, 40 to 70 wt %, 40 to 45 wt %, 45 to 70 wt %, 45 to 65 wt %, 45 to 60 wt %, 45 to 55 wt %, 45 to 50 wt %, 50 to 70 wt %, 50 to 65 wt %, 50 to 60 wt %, 50 to 55 wt %, 55 to 70 wt %, 55 to 65 wt %, 55 to 60 wt %, 60 to 70 wt %, 60 to 65 wt %, or 65 to 70 wt %, or any and all sub-ranges formed from any of these endpoints.

As noted above, the lithium silicate crystalline phase may be lithium disilicate or lithium metasilicate. Lithium disilicate (Li₂Si₂O₅) is an orthorhombic crystal based on corrugated sheets of {Si₂O₅} tetrahedral arrays. The crystals are typically tabular or lath-like in shape, with pronounced cleavage planes. Glass-ceramics based on lithium disilicate have highly desirable mechanical properties, including high body strength and fracture toughness, due to their microstructures of randomly-oriented interlocked crystals. This crystal structure forces cracks to propagate through the material via tortuous paths around the interlocked crystals thereby improving the strength and fracture toughness. Lithium metasilicate, Li₂SiO₃, has an orthorhombic symmetry with (Si₂O₆) chains running parallel to the c axis and linked together by lithium ions.

In embodiments, the weight percentage of the lithium silicate crystalline phase in the glass-based articles can be in a range from 20 to 60 wt %, 20 to 55 wt %, 20 to 50 wt %, 20 to 45 wt %, 20 to 40 wt %, 20 to 35 wt %, 20 to 30 wt %, 20 to 25 wt %, 25 to 60 wt %, 25 to 55 wt %, 25 to 50 wt %, 25 to 45 wt %, 25 to 40 wt %, 25 to 35 wt %, 25 to 30 wt %, 30 to 60 wt %, 30 to 55 wt %, 30 to 50 wt %, 30 to 45 wt %, 30 to 40 wt %, 30 to 35 wt %, 35 to 60 wt %, 35 to 55 wt %, 35 to 50 wt %, 35 to 45 wt %, 35 to 40 wt %, 40 to 60 wt %, 40 to 55 wt %, 40 to 50 wt %, 40 to 45 wt %, 45 to 60 wt %, 45 to 55 wt %, 45 to 50 wt %, 50 to 60 wt %, 50 to 55 wt %, or 55 to 60 wt %, or any and all sub-ranges formed from any of these endpoints.

In some embodiments, the glass-ceramic article has a residual glass content of 5 to 30 wt %, 5 to 25 wt %, 5 to 20 wt %, 5 to 15 wt %, 5 to 10 wt %, 10 to 30 wt %, 10 to 25 wt %, 10 to 20 wt %, 10 to 15 wt %, 15 to 30 wt %, 15 to 25 wt %, 15 to 20 wt %, 20 to 30 wt %, 20 to 25 wt %, or 25 to 30 wt %, as determined according to Rietveld analysis of the XRD spectrum. It should be understood that the residual glass content may be within a sub-range formed from any and all of the foregoing endpoints.

In embodiments, the ratio of lithium disilicate (wt %) to petalite (wt %) in the glass ceramic article is 0.5-1 or even 0.8-1. In embodiments, the ratio of lithium disilicate (wt %) to residual glass (wt %) in the glass ceramic article is 0.5-6 or even 1-5. In embodiments, the ratio of petalite (wt %) to residual glass (wt %) in the glass ceramic article is 0.5-6 or even 0.5.

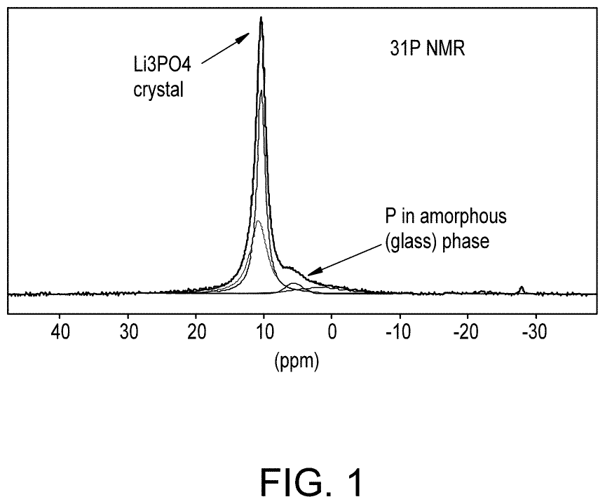

FIG. 1 includes the phase assemblage of one embodiment of a glass-ceramic article according to the embodiments described herein measured by DXR2 Smart Raman ThermoFischer and by XRD. The phase assemblage of the glass-ceramic article in this embodiment comprises greater than or equal to 40 wt % and less than or equal to 48 wt % lithium disilicate, greater than or equal to 39 wt % and less than or equal to 45 wt % petalite, and less than 3 wt % lithium metasilicate. It is believed that phase assemblage of the glass-ceramic embodiment depicted in FIG. 1 comprises greater than or equal to 10 wt % and less than or equal to 16 wt % glass phase, as measured by XRD Reitvald analysis, and crystalline Li₃PO₄ is included in this glass phase because its crystal size is too small to be detected by XRD. More specifically, and as shown in FIG. 1, the glass phase contains greater than or equal to 8 wt % and less than or equal to 12 wt % of total P₂O₅ in the amorphous phase, the remaining P₂O₅ is crystallized as Li₃PO₄ (based on 31P NMR analysis).

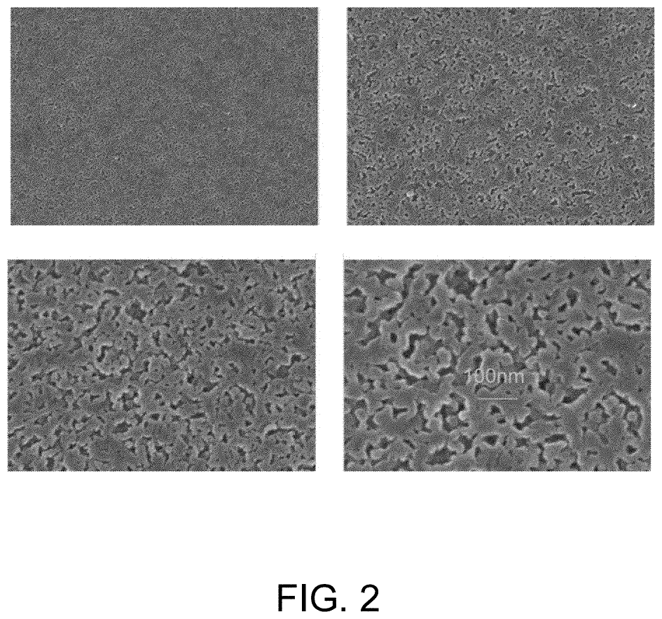

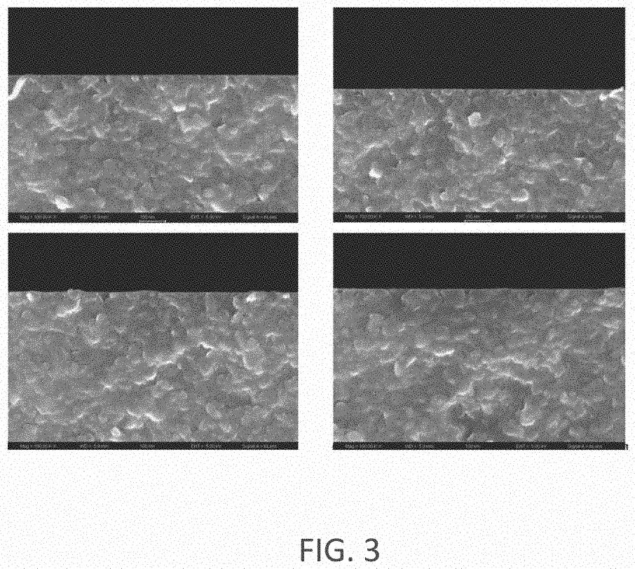

FIGS. 2 and 3 are SEM micrographs depicting the interlocking or entangled microstructure of the formed glass-ceramic article that enhances the fracture toughness of the glass-ceramic articles described herein. The micrographs in FIGS. 2 and 3 had the same composition as Example 1 (Table 2) below. The interlocking “prismatic blade” or rod-like structure is characteristic of both petalite and lithium disilicate. In general, the largest dimension of the crystal grains of the ceramic phases is less than 200 nm. In embodiments, the crystal grains of the glass ceramic article have an aspect ratio (i.e., the ratio of the longest dimension of the grain to the shortest dimension of the grain) of greater than or equal to 4 or even greater than or equal to 5.

There are two broad families of lithium disilicate glass-ceramics. The first group comprises those that are doped with ceria and a noble metal such as silver. These can be photosensitively nucleated via UV light and subsequently heat-treated to produce strong glass-ceramics such as Fotoceram®. The second family of lithium disilicate glass-ceramics is nucleated by the addition of P₂O₅, wherein the nucleating phase is Li₃PO₄. P₂O₅-nucleated lithium disilicate glass-ceramics have been developed for applications as varied as high-temperature sealing materials, disks for computer hard drives, transparent armor, and dental applications.

The precursor glass compositions (i.e., the precursor glasses) and glass-ceramics described herein may be generically described as lithium-containing aluminosilicate glasses or glass-ceramics and comprise SiO₂, Al₂O₃, and Li₂O. In addition to SiO₂, Al₂O₃, and Li₂O, the glasses and glass-ceramics embodied herein may further contain alkali oxides, such as Na₂O, K₂O, Rb₂O, or Cs₂O, as well as P₂O₅ and ZrO₂, and a number of other components as described below. In one or more embodiments, the major crystallite phases include petalite and lithium silicate, but β-spodumene solid solution, β-quartz solid solution, lithium phosphate, cristobalite, and rutile may also be present as minor phases depending on the compositions of the precursor glass.

SiO₂ is the primary glass former and can function to stabilize the network structure of precursor glasses and glass-ceramics. In embodiments, the precursor glass or glass-ceramic composition comprises from 55 to 80 mol % SiO₂. In embodiments, the precursor glass or glass-ceramic composition comprises from 60 to 80 mol % SiO₂. In embodiments, the precursor glass or glass-ceramic composition comprises from 60 to 75 mol % SiO₂. In embodiments, the precursor glass or glass-ceramic composition comprises from 60 to 72 mol % SiO₂. In some embodiments, the glass or glass-ceramic composition can comprise from 55 to 80 mol %, 55 to 77 mol %, 55 to 75 mol %, 55 to 73 mol %, 60 to 80 mol %, 60 to 77 mol %, 60 to 75 mol %, 60 to 73 mol %, 60 to 72 mol %, 65 to 80 mol %, 65 to 77 mol %, 65 to 75 mol %, 65 to 73 mol %, 65 to 72 mol %, 69 to 80 mol %, 69 to 77 mol %, 69 to 75 mol %, 69 to 73 mol %, 69 to 72 mol %, 70 to 80 mol %, 70 to 77 mol %, 70 to 75 mol %, 70 to 73 mol %, 73 to 80 mol %, 73 to 77 mol %, 73 to 75 mol %, 75 to 80 mol %, 75 to 77 mol %, or 77 to 80 mol % SiO₂, or any and all sub-ranges formed from any of these endpoints.

The concentration of SiO₂ should be sufficiently high (greater than 60 mol %) in order to form petalite crystal phase when the precursor glass is heat-treated to convert to a glass-ceramic. In other words, the concentration SiO₂, should be high enough to yield both the lithium silicate and petalite phases. The amount of SiO₂ may be limited to control melting temperature (200 poise temperature), as the melting temperature of pure SiO₂ or high-SiO₂ glasses is undesirably high.

Like SiO₂, Al₂O₃ may also provide stabilization to the network and also provides improved mechanical properties and chemical durability. If the amount of Al₂O₃ is too high, however, the fraction of lithium silicate crystals may be decreased, possibly to the extent that an interlocking structure cannot be formed. The amount of Al₂O₃ can be tailored to control viscosity. Further, if the amount of Al₂O₃ is too high, the viscosity of the melt is also generally increased. In embodiments, the glass or glass-ceramic composition can comprise from 0.5 to 20 mol % Al₂O₃. In embodiments, the glass or glass-ceramic composition can comprise from 0.5 to 15 mol % Al₂O₃. In embodiments, the glass or glass-ceramic composition can comprise from 0.5 to 10 mol % Al₂O₃. In embodiments, the glass or glass-ceramic composition can comprise from 0.5 to 8 mol % Al₂O₃. In embodiments, the glass or glass-ceramic composition can comprise from 0.6 to 6 mol % Al₂O₃. In embodiments, the glass or glass-ceramic composition can comprise from 1.0 to 8 mol % Al₂O₃. In embodiments, the glass or glass-ceramic composition can comprise from 1.0 to 6 mol % Al₂O₃. In embodiments, the glass or glass-ceramic composition can comprise from 1.0 to <6 mol % Al₂O₃. In some embodiments, the glass or glass-ceramic composition can comprise from 0.5 to 20 mol %, 0.5 to 18 mol %, 0.5 to 15 mol %, 0.5 to 12 mol %, 0.5 to 10 mol %, 0.5 to 9 mol %, 0.5 to 8 mol %, 0.5 to 6 mol %, 1 to 20 mol %, 1 to 18 mol %, 1 to 15 mol %, 1 to 12 mol %, 1 to 10 mol %, 1 to 9 mol %, 1 to 8 mol %, 1 to 6 mol %, 2 to 20 mol %, 2 to 18 mol %, 2 to 15 mol %, 2 to 12 mol %, 2 to 10 mol %, 2 to 9 mol %, 2 to 8 mol %, 2 to 6 mol %, 3 to 20 mol %, 3 to 18 mol %, 3 to 15 mol %, 3 to 12 mol %, 3 to 10 mol %, 3 to 8 mol %, 3 to 6 mol %, 4 to 20 mol %, 4 to 18 mol %, 4 to 15 mol %, 4 to 12 mol %, 4 to 8 mol %, or 4 to 6 mol % Al₂O₃, or any and all sub-ranges formed from any of these endpoints.

In the precursor glass and glass-ceramics described herein, Li₂O aids in forming both petalite and lithium silicate crystal phases. To obtain petalite and lithium silicate as the predominant crystal phases, it is desirable to have at least 10 mol % Li₂O in the composition. However, if the concentration of Li₂O is too high—greater than 40 mol %—the composition becomes very fluid and the delivery viscosity is low enough that a sheet cannot be formed. In some embodied compositions, the glass or glass-ceramic can comprise from 15 mol % to 35 mol % Li₂O. In other embodiments, the glass or glass-ceramic can comprise from 18 mol % to 32 mol % Li₂O. In other embodiments, the glass or glass-ceramic can comprise from 18 mol % to 30 mol % Li₂O. In other embodiments, the glass or glass-ceramic can comprise from 18 mol % to 28 mol % Li₂O. In other embodiments, the glass or glass-ceramic can comprise from 20 mol % to 30 mol % Li₂O. In some embodiments, the glass or glass-ceramic composition can comprise from 15 to 35 mol %, 15 to 32 mol %, 15 to 30 mol %, 15 to 28 mol %, 15 to 26 mol %, 15 to 24 mol %, 15 to 22 mol %, 18 to 35 mol %, 18 to 32 mol %, 18 to 30 mol %, 18 to 28 mol %, 18 to 26 mol %, 18 to 24 mol %, 18 to 22 mol %, 19 to 35 mol %, 19 to 32 mol %, 19 to 30 mol %, 19 to 28 mol %, 19 to 26 mol %, 19 to 24 mol %, 19 to 22 mol %, 20 to 35 mol %, 20 to 32 mol %, 20 to 30 mol %, 20 to 28 mol %, 20 to 26 mol %, 20 to 24 mol %, 20 to 22 mol % Li2O, or any and all sub-ranges formed from any of these endpoints.

As noted above, Li₂O is generally useful for forming the embodied glass-ceramics, but the other alkali oxides (e.g., K₂O and Na₂O) tend to decrease glass-ceramic formation and form an aluminosilicate residual glass in the glass-ceramic rather than a ceramic phase. It has been found that more than 8 wt % Na₂O or K₂O, or combinations thereof, leads to an undesirable amount of residual glass which can lead to deformation during crystallization and undesirable microstructures from a mechanical property perspective. However, concentrations below 8 wt % may be advantageous for ion exchange, enabling higher surface compression and/or metrology. In the embodiments described herein, the composition of the residual glass may be tailored to control viscosity during crystallization, minimizing deformation or undesirable thermal expansion, or control microstructure properties.

In general, the compositions described herein have low amounts of non-lithium alkali oxides. In some embodiments, the glass or glass-ceramic composition can comprise from 0 to 8 mol % R₂O, wherein R is one or more of the alkali cations Na and K. In some embodiments, the glass or glass-ceramic composition can comprise from >0 to 8 mol % R₂O, 0 to 7 mol % R₂O, >0 to 7 mol % R₂O, 0 to 6 mol % R₂O, >0 to 6 mol % R₂O, 0 to 5 mol % R₂O, >0 to 5 mol % R₂O, 0 to 4 mol % R₂O, >0 to 4 mol % R₂O, 0 to 3 mol % R₂O, >0 to 3 mol % R₂O, 0 to 2 mol % R₂O, >0 to 2 mol % R₂O, 0 to 1 mol % R₂O, >0 to 1 mol % R₂O, wherein R is one or more of the alkali cations Na and K. In some embodiments, the glass or glass-ceramic composition can comprise from 1 to 3 mol % R₂O, wherein R is one or more of the alkali cations Na and K. In some embodiments, the glass or glass-ceramic composition can comprise from 0 to 5 mol %, 0 to 4 mol %, 0 to 3 mol %, 0 to 2 mol %, 0 to 1 mol %, >0 to 5 mol %, >0 to 4 mol %, >0 to 3 mol %, >0 to 2 mol %, >0 to 1 mol %, to 5 mol %, 0 to 4 mol %, 0 to 3 mol %, 0 to 2 mol %, 0 to 1 mol %, 1 to 5 mol %, 1 to 4 mol %, 1 to 3 mol %, 1 to 2 mol %, 1.5 to 5 mol %, 1.5 to 4 mol %, 1.5 to 3 mol %, 1.5 to 2 mol % Na₂O, K₂O, or combinations thereof. It should be understood that the R₂O concentration may be within a sub-range formed from any and all of the foregoing endpoints.

B₂O₃ decreases the melting temperature of the glass precursor. Furthermore, the addition of B₂O₃ in the precursor glass and, thus, the glass-ceramics helps achieve an interlocking crystal microstructure and can also improve the damage resistance of the glass-ceramic. When boron in the residual glass is not charge balanced by alkali oxides or divalent cation oxides (such as MgO, CaO, SrO, BaO, and ZnO), it will be in trigonal-coordination state (or three-coordinated boron), which opens up the structure of the glass. The network around these three-coordinated boron atoms is not as rigid as tetrahedrally coordinated (or four-coordinated) boron. Without being bound by theory, it is believed that precursor glasses and glass-ceramics that include three-coordinated boron can tolerate some degree of deformation before crack formation compared to four-coordinated boron. By tolerating some deformation, the Vickers indentation crack initiation threshold values increase. Fracture toughness of the precursor glasses and glass-ceramics that include three-coordinated boron may also increase. Without being bound by theory, it is believed that the presence of boron in the residual glass of the glass-ceramic (and precursor glass) lowers the viscosity of the residual glass (or precursor glass), which facilitates the growth of lithium silicate crystals, especially large crystals having a high aspect ratio. A greater amount of three-coordinated boron (in relation to four-coordinated boron) is believed to result in glass-ceramics that exhibit a greater Vickers indentation crack initiation load. The amount of boron in general should be controlled to maintain chemical durability and mechanical strength of the cerammed bulk glass-ceramic. In other words, the amount of boron should be limited to less than 5 mol % in order to maintain chemical durability and mechanical strength.

In one or more embodiments, the glasses and glass-ceramics herein can comprise from 0 to 5 mol % or from 0 to 2 mol % B₂O₃. In embodiments, the glass or glass-ceramic composition can comprise from 0 to 10 mol %, 0 to 9 mol %, 0 to 8 mol %, 0 to 7 mol %, 0 to 6 mol %, 0 to 5 mol %, 0 to 4 mol %, 0 to 3 mol %, 0 to 2 mol %, 0 to 1 mol %, >0 to 10 mol %, >0 to 9 mol %, >0 to 8 mol %, >0 to 7 mol %, >0 to 6 mol %, >0 to 5 mol %, >0 to 4 mol %, >0 to 3 mol %, >0 to 2 mol %, >0 to 1 mol %, 1 to 10 mol %, 1 to 8 mol %, 1 to 6 mol %, 1 to 5 mol %, 1 to 4 mol %, 1 to 2 mol %, 2 to 10 mol %, 2 to 8 mol %, 2 to 6 mol %, 2 to 5 mol %, 2 to 4 mol %, 3 to 10 mol %, 3 to 8 mol %, 3 to 6 mol %, 3 to 5 mol %, 3 to 4 mol %, 4 to 10 mol %, 4 to 8 mol %, 4 to 6 mol %, 4 to 5 mol %, 5 to 10 mol %, 5 to 8 mol %, 5 to 7.5 mol %, 5 to 6 mol %, or 5 mol % to 5.5 mol % B₂O₃, or any and all sub-ranges formed from any of these endpoints. In some embodiments, the precursor glasses and glass-ceramics are substantially free of B₂O₃.

The glass and glass-ceramic compositions can include P₂O₅. P₂O₅ can function as a nucleating agent to produce bulk nucleation of the crystalline phase(s) from the glass and glass-ceramic compositions. If the concentration of P₂O₅ is too low, the precursor glass does crystallize, but only at higher temperatures (due to a lower viscosity); however, if the concentration of P₂O₅ is too high, devitrification upon cooling during precursor glass forming can be difficult to control. Embodiments can comprise from >0 to 5 mol % P₂O₅. Other embodiments can comprise >0 to 4 mol % P₂O₅, >0 to 3 mol % P₂O₅, or even >0 to 2.5 mol % P₂O₅, Embodied compositions can comprise from 0 to 5 mol %, 0 to 4.5 mol %, 0 to 4 mol %, 0 to 3.5 mol %, 0 to 3 mol %, 0 to 2.5 mol %, 0 to 2 mol %, 0 to 1.5 mol %, 0 to 1 mol %, >0 to 5 mol %, >0 to 4.5 mol %, >0 to 4 mol %, >0 to 3.5 mol %, >0 to 3 mol %, >0 to 2.5 mol %, >0 to 2 mol %, >0 to 1.5 mol %, >0 to 1 mol %, 0.2 to 5 mol %, 0.2 to 4.5 mol %, 0.2 to 4 mol %, 0.2 to 3.5 mol %, 0.2 to 2 mol %, 0.2 to 2.5 mol %, 0.2 to 2 mol %, 0.2 to 1.5 mol %, 0.2 to 1 mol %, 0.3 to 5 mol %, 0.3 to 4.5 mol %, 0.3 to 4 mol %, 0.3 to 3.5 mol %, 0.3 to 3 mol %, 0.3 to 2.5 mol %, 0.3 to 2 mol %, 0.3 to 1.5 mol %, 0.3 to 1 mol %, 0.4 to 5 mol %, 0.4 to 4.5 mol %, 0.4 to 4 mol %, 0.4 to 3.5 mol %, 0.4 to 3 mol %, 0.4 to 2.5 mol %, 0.4 to 2 mol %, 0.4 to 1.5 mol %, 0.4 to 1 mol %, 0.5 to 5 mol %, 0.5 to 4.5 mol %, 0.5 to 4 mol %, 0.5 to 3.5 mol %, 0.5 to 3 mol %, 0.5 to 2.5 mol %, 0.5 to 2 mol %, 0.5 to 1.5 mol %, 0.5 to 1 mol %, 0.7 to 5 mol %, 0.7 to 4.5 mol %, 0.7 to 4 mol %, 0.7 to 3.5 mol %, 0.7 to 3 mol %, 0.7 to 2.5 mol %, 0.7 to 2 mol %, 0.7 to 1.5 mol %, 0.7 to 1 mol %, 1 to 5 mol %, 1 to 4.5 mol %, 1 to 4 mol %, 1 to 3.5 mol %, 1 to 3 mol %, 1 to 2.5 mol %, 1 to 2 mol %, 1 to 1.5 mol %, 1.5 to 6 mol %, 1.5 to 5.5 mol %, 1.5 to 5 mol %, 1.5 to 4.5 mol %, 1.5 to 4 mol %, 1.5 to 3.5 mol %, 1.5 to 3 mol %, 1.5 to 2.5 mol %, 1.5 to 2 mol %, 2 to 6 mol %, 2 to 5.5 mol %, 2 to 5 mol %, 2 to 4.5 mol %, 2 to 4 mol %, 2 to 3.5 mol %, 2 to 3 mol %, 2 to 2.5 mol %, 2.5 to 6 mol %, 2.5 to 5.5 mol %, 2.5 to 5 mol %, 2.5 to 4.5 mol %, 2.5 to 4 mol %, 2.5 to 3.5 mol %, 2.5 to 3 mol % P₂O₅, or any and all sub-ranges formed from any of these endpoints.

In the glass and glass-ceramics described herein, additions of ZrO₂ can improve the stability of Li₂O—Al₂O₃—SiO₂—P₂O₅ glass by significantly reducing glass devitrification during forming and decreasing the liquidus temperature. Additions of ZrO₂ can form a primary liquidus phase at a high temperature, which significantly lowers the liquidus viscosity. ZrO₂ may also aid in the formation of transparent glasses. The addition of ZrO₂ can also decrease the petalite grain size, which aids in the formation of a transparent glass-ceramic. In some embodiments, the glass or glass-ceramic composition can comprise from 1 to 6 mol % ZrO₂. In some embodiments, the glass or glass-ceramic composition can comprise from 2 to 5 mol % ZrO₂. In some embodiments, the glass or glass-ceramic composition can comprise from 1 to 15 mol %, 1 to 12 mol %, 1 to 10 mol %, 1 to 8 mol %, 1 to 6 mol %, 1 to 4 mol %, 1.5 to 15 mol %, 1.5 to 12 mol %, 1.5 to 10 mol %, 1.5 to 8 mol %, 1.5 to 6 mol %, 1.5 to 4 mol %, 2 to 15 mol %, 2 to 12 mol %, 2 to 10 mol %, 2 to 8 mol %, 2 to 6 mol %, 2 to 4 mol %, 2.5 to 15 mol %, 2.5 to 12 mol %, 2.5 to 10 mol %, 2.5 to 8 mol %, 2.5 to 6 mol %, 2.5 to 4 mol %, 3 to 15 mol %, 3 to 12 mol %, 3 to 10 mol %, 3 to 8 mol %, 3 to 6 mol %, 3 to 4 mol %, 3.5 to 15 mol %, 3.5 to 12 mol %, 3.5 to 10 mol %, 3.5 to 8 mol %, 3.5 to 6 mol %, 3.5 to 5 mol % ZrO₂, or any and all sub-ranges formed from any of these endpoints.

In one or more embodiments, the glasses and glass-ceramics can comprise from 0 to 0.5 mol % SnO₂, or another fining agent. In embodiments, the glass or glass-ceramic composition can comprise from 0 to 0.5 mol %, 0 to 0.4 mol %, 0 to 0.3 mol %, 0 to 0.2 mol %, 0 to 0.1 mol %, 0.01 to 0.5 mol %, 0.01 to 0.4 mol %, 0.01 to 0.3 mol %, 0.01 to 0.2 mol %, 0.05 to 0.5 mol %, 0.05 to 0.4 mol %, 0.05 to 0.3 mol %, 0.05 to 0.2 mol %, 0.05 to 0.1 mol %, 0.1 to 0.5 mol %, 0.1 to 0.4 mol %, 0.1 to 0.3 mol %, 0.1 to 0.2 mol %, 0.2 to 0.5 mol %, 0.2 to 0.4 mol %, 0.2 to 0.3 mol %, 0.3 to 0.5 mol %, 0.3 mol % to 0.4 mol %, or 0.4 to 0.5 mol % SnO₂, or any and all sub-ranges formed from any of these endpoints.

In one or more embodiments, the glasses and glass-ceramics can comprise from 0 to 0.5 mol % Fe₂O₃. In embodiments, the glass or glass-ceramic composition can comprise from 0 to 0.5 mol %, 0 to 0.4 mol %, 0 to 0.3 mol %, 0 to 0.2 mol %, 0 to 0.1 mol %, 0.05 to 0.5 mol %, 0.05 to 0.4 mol %, 0.05 to 0.3 mol %, 0.05 to 0.2 mol %, 0.05 to 0.1 mol %, 0.1 to 0.5 mol %, 0.1 to 0.4 mol %, 0.1 to 0.3 mol %, 0.1 to 0.2 mol %, 0.2 to 0.5 mol %, 0.2 to 0.4 mol %, 0.2 to 0.3 mol %, 0.3 to 0.5 mol %, 0.3 mol % to 0.4 mol %, or 0.4 to 0.5 mol % Fe₂O₃, or any and all sub-ranges formed from any of these endpoints.

MgO can enter petalite crystals in a partial solid solution. In embodiments, the glasses and glass-ceramics described herein can comprise from 0 to 2 mol % MgO. In some embodiments, the glass or glass-ceramic composition can comprise from 0 to 2 mol %, %, 0 to 1.5 mol %, 0 to 1 mol %, 0 to 0.5, >0 to 2 mol %, >0 to 1.5 mol %, >0 to 1 mol %, >0 to 0.5 mol %, 0.5 to 2 mol %, 0.5 to 1.5 mol %, 0.5 to 1.0 mol % MgO, or any and all sub-ranges formed from any of these endpoints.

CaO can enter petalite crystals in a partial solid solution. In embodiments, the glasses and glass-ceramics described herein can comprise from 0 to 8 mol % CaO. In some embodiments, the glass or glass-ceramic composition can comprise from 0 to 2 mol %, %, 0 to 1.5 mol %, 0 to 1 mol %, 0 to 0.5, >0 to 2 mol %, >0 to 1.5 mol %, >0 to 1 mol %, >0 to 0.5 mol %, 0.5 to 2 mol %, 0.5 to 1.5 mol %, 0.5 to 1.0 mol % CaO, or any and all sub-ranges formed from any of these endpoints.

BaO can enter petalite crystals in a partial solid solution. In embodiments, the glasses and glass-ceramics described herein can comprise from 0 to 2 mol % BaO. In some embodiments, the glass or glass-ceramic composition can comprise from 0 to 2 mol %, %, 0 to 1.5 mol %, 0 to 1 mol %, 0 to 0.5, >0 to 2 mol %, >0 to 1.5 mol %, >0 to 1 mol %, >0 to 0.5 mol %, 0.5 to 2 mol %, 0.5 to 1.5 mol %, 0.5 to 1.0 mol % BaO, or any and all sub-ranges formed from any of these endpoints.

SrO can enter petalite crystals in a partial solid solution. In embodiments, the glasses and glass-ceramics described herein can comprise from 0 to 2 mol % SrO. In some embodiments, the glass or glass-ceramic composition can comprise from 0 to 2 mol %, %, 0 to 1.5 mol %, 0 to 1 mol %, 0 to 0.5, >0 to 2 mol %, >0 to 1.5 mol %, >0 to 1 mol %, >0 to 0.5 mol %, 0.5 to 2 mol %, 0.5 to 1.5 mol %, 0.5 to 1.0 mol % SrO, or any and all sub-ranges formed from any of these endpoints.

ZnO can enter petalite crystals in a partial solid solution. In embodiments, the glasses and glass-ceramics described herein can comprise from 0 to 2 mol % ZnO. In some embodiments, the glass or glass-ceramic composition can comprise from 0 to 2 mol %, %, 0 to 1.5 mol %, 0 to 1 mol %, 0 to 0.5, >0 to 2 mol %, >0 to 1.5 mol %, >0 to 1 mol %, >0 to 0.5 mol %, 0.5 to 2 mol %, 0.5 to 1.5 mol %, 0.5 to 1.0 mol % ZnO, or any and all sub-ranges formed from any of these endpoints.

In embodiments, the glasses and glass-ceramics described herein can comprise from 0 to 2 mol % La₂O₃. In some embodiments, the glass or glass-ceramic composition can comprise from 0 to 2 mol %, %, 0 to 1.5 mol %, 0 to 1 mol %, 0 to 0.5, >0 to 2 mol %, >0 to 1.5 mol %, >0 to 1 mol %, >0 to 0.5 mol %, 0.5 to 2 mol %, 0.5 to 1.5 mol %, 0.5 to 1.0 mol % La₂O₃, or any and all sub-ranges formed from any of these endpoints.

In embodiments, the glasses and glass-ceramics described herein can comprise from 0 to 2 mol % HfO₂. In some embodiments, the glass or glass-ceramic composition can comprise from 0 to 2 mol %, %, 0 to 1.5 mol %, 0 to 1 mol %, 0 to 0.5, >0 to 2 mol %, >0 to 1.5 mol %, >0 to 1 mol %, >0 to 0.5 mol %, 0.5 to 2 mol %, 0.5 to 1.5 mol %, 0.5 to 1.0 mol % HfO₂, or any and all sub-ranges formed from any of these endpoints.

In embodiments, the glasses and glass-ceramics described herein can comprise from 0 to 2 mol % GeO₂. In some embodiments, the glass or glass-ceramic composition can comprise from 0 to 2 mol %, %, 0 to 1.5 mol %, 0 to 1 mol %, 0 to 0.5, >0 to 2 mol %, >0 to 1.5 mol %, >0 to 1 mol %, >0 to 0.5 mol %, 0.5 to 2 mol %, 0.5 to 1.5 mol %, 0.5 to 1.0 mol % GeO₂, or any and all sub-ranges formed from any of these endpoints.

In embodiments, the glasses and glass-ceramics described herein can comprise from 0 to 2 mol % Ta₂O₅. In some embodiments, the glass or glass-ceramic composition can comprise from 0 to 2 mol %, %, 0 to 1.5 mol %, 0 to 1 mol %, 0 to 0.5, >0 to 2 mol %, >0 to 1.5 mol %, >0 to 1 mol %, >0 to 0.5 mol %, 0.5 to 2 mol %, 0.5 to 1.5 mol %, 0.5 to 1.0 mol % Ta₂O₅, or any and all sub-ranges formed from any of these endpoints.

In embodiments, the ratio of the total concentration of alkali oxides M₂O in mol % (e.g., M₂O=Li₂O+K₂O+Na₂O) to the total concentration of Al₂O₃ in mol. % (i.e., M₂O:Al₂O₃) is greater than or equal to 3 to less than or equal to 9, greater than or equal to 3 to less than or equal to 8, greater than or equal to 3 to less than or equal to 7, greater than or equal to 3 to less than or equal to 6, greater than or equal to 3 to less than or equal to 5, greater than or equal to 4 to less than or equal to 9, greater than or equal to 4 to less than or equal to 8, greater than or equal to 4 to less than or equal to 7, greater than or equal to 4 to less than or equal to 6, or even greater than or equal to 4 to less than or equal to 5.

In embodiments, the ratio of the total concentration of Li₂O in mol % to the total concentration of alkali oxides M₂O in mol % (i.e., Li₂O:M₂O) is greater than or equal to 0.6 to less than or equal to 1, greater than or equal to 0.7 to less than or equal to 1, greater than or equal to 0.8 to less than or equal to 1, or even greater than or equal to 0.9 to less than or equal to 1.

Table 1 includes an example composition space for the precursor glasses and glass-ceramics described according to one or more embodiments shown and described herein.

TABLE 1
Oxides in mol %
SiO₂: 60-72%
Al₂O₃: 0-6%
Li₂O: 20-32%
B₂O₃: 0-2%
Na₂O: 0-2%
K₂O: 0-2%
P₂O₅: 0.7-2.2%
ZrO₂: 1.7-4.5%
SnO₂: 0.05-0.5%
Fe₂O₃: 0-0.5%
MgO: 0-1%
ZnO: 0-1%
BaO: 0-1%
SrO: 0-1%
La₂O₃: 0-1%
GeO₂: 0-1%
Ta₂O₅: 0-1%

Table 2 includes several example compositions of glass precursor and/or glass-ceramic compositions, according to one or more embodiments shown and described herein.

TABLE 2

| mol % oxide | Ex. 1 | Ex. 2 | Ex. 3 | Ex. 4 | Ex. 5 |
|---|---|---|---|---|---|
| SiO₂ | 70.65 | 69.35 | 69.01 | 60.0 | 70.47 |
| Al₂O₃ | 4.20 | 3.73 | 2.73 | 1.0 | 4.24 |
| Li₂O | 22.10 | 21.68 | 21.57 | 26.0 | 22.05 |
| Na₂O | 0.00 | 0.49 | 0.98 | 1.0 | 0.07 |
| CaO | 0.00 | 0.00 | 0.00 | 6.5 | 0.00 |
| K₂O | 0.00 | 0.74 | 0.74 | 0.2 | 0.06 |
| P₂O₅ | 0.90 | 0.98 | 0.98 | 2.2 | 0.84 |
| ZrO₂ | 2.00 | 2.94 | 3.92 | 3.4 | 2.22 |
| SnO₂ | 0.01 | 0.10 | 0.10 | 0.01 | 0.01 |
| B₂O₃ | 0.00 | 0.00 | 0.00 | 0.00 | 0.00 |
| Li2O/R2O | 1.00 | 0.95 | 0.89 | | |
| R2O/Al2O3 | 5.26 | 6.14 | 8.88 | | |

Table 3 includes several example compositions of glass precursor and/or glass-ceramic compositions, according to one or more embodiments shown and described herein.

TABLE 3

| oxide (mol %) | Ex. 6 | Ex. 7 | Ex. 8 |
|---|---|---|---|
| SiO₂ | 70.29 | 71.78 | 69.53 |
| Al₂O₃ | 4.23 | 4.3 | 3.77 |
| Na₂O | 1.51 | 0.05 | 0.46 |
| K₂O | | 0.08 | 0.74 |
| Li₂O | 21.35 | 21.72 | 21.43 |
| CaO | | 0.02 | 0.02 |
| Fe₂O₃ | | 0.022 | 0.02 |
| ZrO₂ | 1.67 | 2.03 | 2.96 |
| SnO₂ | 0.08 | 0.01 | 0.08 |
| HfO₂ | | 0.02 | 0.1 |
| P₂O₅ | 0.87 | 0.38 | 0.99 |

The glass-ceramic articles formed from the glass-ceramic compositions described herein may be any suitable thickness, which may vary depending on the particular application for use of the glass-ceramic article. In embodiments, the glass-ceramic sheet embodiments may have a thickness greater than or equal to 250 μm and less than or equal to 6 mm, greater than or equal to 250 μm and less than or equal to 4 mm, greater than or equal to 250 μm and less than or equal to 2 mm, greater than or equal to 250 μm and less than or equal to 1 mm, greater than or equal to 250 μm and less than or equal to 750 μm, greater than or equal to 250 μm and less than or equal to 500 μm, greater than or equal to 500 μm and less than or equal to 6 mm, greater than or equal to 500 μm and less than or equal to 4 mm, greater than or equal to 500 μm and less than or equal to 2 mm, greater than or equal to 500 μm and less than or equal to 1 mm, greater than or equal to 500 μm and less than or equal to 750 μm, greater than or equal to 750 μm and less than or equal to 6 mm, greater than or equal to 750 μm and less than or equal to 4 mm, greater than or equal to 750 μm and less than or equal to 2 mm, greater than or equal to 750 μm and less than or equal to 1 mm, greater than or equal to 1 mm and less than or equal to 6 mm, greater than or equal to 1 mm and less than or equal to 4 mm, greater than or equal to 1 mm and less than or equal to 2 mm, greater than or equal to 2 mm and less than or equal to 6 mm, greater than or equal to 2 mm and less than or equal to 4 mm, or even greater than or equal to 4 mm and less than or equal to 6 mm, or any and all sub-ranges formed from any of these endpoints.

In embodiments, the processes for making the glass-ceramic article includes heat treating the precursor glass in an oven at one or more preselected temperatures for one or more preselected times to induce glass homogenization and crystallization (i.e., nucleation and growth) of one or more crystalline phases (e.g., having one or more compositions, amounts, morphologies, sizes or size distributions, etc.). In embodiments, the heat treatment may include (i) heating a precursor glass in an oven at a rate greater than or equal to 1° C./min and less than or equal to 10° C./min to a nucleation temperature; (ii) maintaining the precursor glass at the nucleation temperature in the oven for time greater than or equal to 0.25 hour and less than or equal to 4 hours to produce a nucleated crystallizable glass; (iii) heating the nucleated crystallizable glass in the oven at a rate greater than or equal to 1° C./min and less than or equal to 10° C./min to a crystallization temperature; (iv) maintaining the nucleated crystallizable glass at the crystallization temperature in the oven for a time greater than or equal to 0.25 hour and less than or equal to 4 hours to produce the glass-ceramic article; and (v) cooling the glass-ceramic article to room temperature.

In embodiments, the nucleation temperature may be greater than or equal to 600° C. and less than or equal to 900° C. In embodiments, the nucleation temperature may be greater than or equal to 600° C. or even greater than or equal to 650° C. In embodiments, the nucleation temperature may be less than or equal to 900° C. or even less than or equal to 800° C. In embodiments, the nucleation temperature may be greater than or equal to 600° C. and less than or equal to 900° C., greater than or equal to 600° C. and less than or equal to 800° C., greater than or equal to 650° C. and less than or equal to 900° C., or even greater than or equal to 650° C. and less than or equal to 800° C., or any and all sub-ranges formed from any of these endpoints.

In embodiments, the crystallization temperature may be greater than or equal to 700° C. and less than or equal to 1000° C. In embodiments, the crystallization temperature may be greater than or equal to 700° C. or even greater than or equal to 750° C. In embodiments, the crystallization temperature may be less than or equal to 1000° C. or even less than or equal to 900° C. In embodiments, the crystallization temperature may be greater than or equal to 700° C. and less than or equal to 1000° C., greater than or equal to 700° C. and less than or equal to 900° C., greater than or equal to 750° C. and less than or equal to 1000° C., or even greater than or equal to 750° C. and less than or equal to 900° C., or any and all sub-ranges formed from any of these endpoints.

One skilled in the art would understand that the heating rates, nucleation temperature, and crystallization temperature described herein refer to the heating rate and temperature of the oven in which the glass-ceramic composition is being heat treated.

In addition to the glass-ceramic compositions, temperature-temporal profiles of heat treatment steps of heating to the crystallization temperature and maintaining the temperature at the crystallization temperature are judiciously prescribed so as to produce one or more of the following desired attributes: crystalline phase(s) of the glass-ceramic article, proportions of one or more major crystalline phases and/or one or more minor crystalline phases and residual glass phases, crystal phase assemblages of one or more predominate crystalline phases and/or one or more minor crystalline phases and residual glass phases, and grain sizes or grain size distribution among one or more major crystalline phases and/or one or more minor crystalline phases, which in turn may influence the final integrity, quality, color, and/or opacity of the resulting glass-ceramic article.

The resulting glass-ceramic article may be provided as a sheet, which may then be reformed by pressing, blowing, bending, sagging, vacuum forming, or other means into curved or bend pieces of uniform thickness. Reforming may be done before thermally treating or the forming step may also serve as a thermal treatment step in which both forming and thermal treating are performed substantially simultaneously.

In embodiments, the glass-ceramic article has a density of greater than or equal to 2.2 and less than or equal 2.7 g/cm³ according to the Archimedes Method specified in ASTM C693. In embodiments, the glass-ceramic article has a density of greater than or equal to 2.25 and less than or equal 2.65 g/cm³. In embodiments, the glass-ceramic article has a density of greater than or equal to 2.3 and less than or equal 2.65 g/cm³. In embodiments, the glass-ceramic article has a density of greater than or equal to 2.3 and less than or equal 2.6 g/cm³.

In embodiments, the glass-ceramic article has a surface roughness Ra of less than or equal to 2 nm or even less than or equal to 1.5 nm. In embodiments, the surface roughness Ra may be greater than or equal to 1 nm and less than or equal to 2 nm or event greater than or equal to 1 nm and less than or equal to 1.5 nm. Without being bound by theory, it is believed that surface roughness within these ranges can be achieved by using a non-ceria based abrasive during touch polishing of the glass-ceramic article.

Glass-based articles according to embodiments disclosed herein may have improved chemical durability in comparison to conventional articles. This chemical durability may be measured by the presence of sodium on the surface of the glass-based article. In embodiments, the glass-based articles comprise less than 5.0 mol % sodium on the surface, such as less than or equal to 4.8 mol % sodium, less than or equal to 4.5 mol % sodium, less than or equal to 4.2 mol % sodium, less than or equal to 4.0 mol % sodium, less than or equal to 3.8 mol % sodium, less than or equal to 3.5 mol % sodium, less than or equal to 3.2 mol % sodium, less than or equal to 3.0 mol % sodium, less than or equal to 2.8 mol % sodium, less than or equal to 2.5 mol % sodium, less than or equal to 2.0 mol % sodium, including any and all subranges within the above ranges. The low sodium content on the surface of the glass-based article can, in embodiments, eliminate sodium carbonate corrosion on the glass-based article when it is soaked in damp heat (85° C./85% relative humidity) for 72 hours.

In embodiments, the glass compositions described herein are ion exchangeable to facilitate strengthening the glass article made from the glass compositions. In typical ion exchange processes, smaller metal ions in the glass compositions are replaced or “exchanged” with larger metal ions of the same valence within a layer that is close to the outer surface of the glass article made from the glass composition. The replacement of smaller ions with larger ions creates a compressive stress within the layer of the glass article made from the glass composition. In embodiments, the metal ions are monovalent metal ions (e.g., Li⁺, Na⁺, K⁺, and the like), and ion exchange is accomplished by immersing the glass article made from the glass composition in a bath comprising at least one molten salt of the larger metal ion that is to replace the smaller metal ion in the glass article. Alternatively, other monovalent ions such as Ag⁺, Tl⁺, Cu⁺, and the like may be exchanged for monovalent ions. The ion exchange process or processes that are used to strengthen the glass article made from the glass composition may include, but are not limited to, immersion in a single bath or multiple baths of like or different compositions with washing and/or annealing steps between immersions.

Upon exposure to the glass composition, the ion exchange solution (e.g., KNO₃ and/or NaNO₃ molten salt bath) may, according to embodiments, be at a temperature greater than or equal to 350° C. and less than or equal to 500° C., greater than or equal to 360° C. and less than or equal to 450° C., greater than or equal to 370° C. and less than or equal to 440° C., greater than or equal to 360° C. and less than or equal to 420° C., greater than or equal to 370° C. and less than or equal to 400° C., greater than or equal to 375° C. and less than or equal to 475° C., greater than or equal to 400° C. and less than or equal to 500° C., greater than or equal to 410° C. and less than or equal to 490° C., greater than or equal to 420° C. and less than or equal to 480° C., greater than or equal to 430° C. and less than or equal to 470° C., or even greater than or equal to 440° C. and less than or equal to 460° C., or any and all sub-ranges between the foregoing values. In embodiments, the glass composition may be exposed to the ion exchange solution for a duration greater than or equal to 2 hours and less than or equal to 48 hours, greater than or equal to 2 hours and less than or equal to 24 hours, greater than or equal to 2 hours and less than or equal to 12 hours, greater than or equal to 2 hours and less than or equal to 6 hours, greater than or equal to 8 hours and less than or equal to 44 hours, greater than or equal to 12 hours and less than or equal to 40 hours, greater than or equal to 16 hours and less than or equal to 36 hours, greater than or equal to 20 hours and less than or equal to 32 hours, or even greater than or equal to 24 hours and less than or equal to 28 hours, or any and all sub-ranges between the foregoing values.

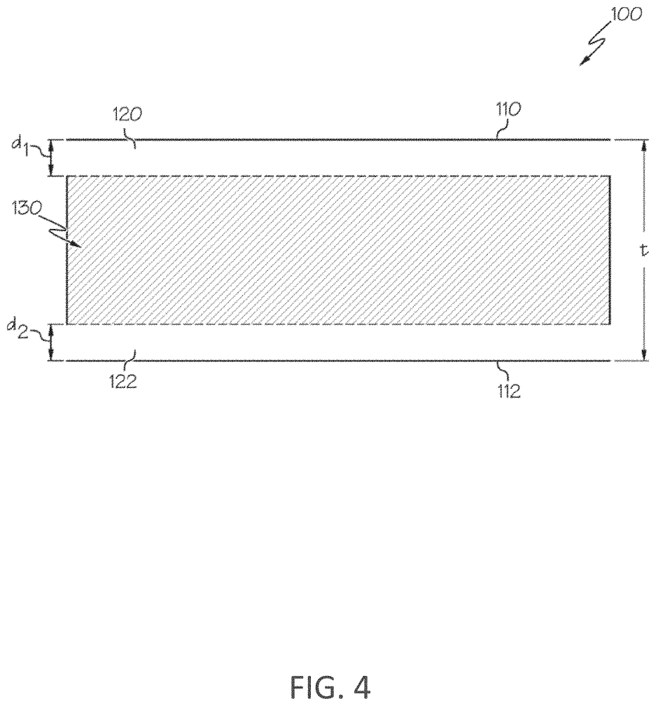

As mentioned above, in embodiments, the glass-based article may be strengthened, such as by ion exchange, making a glass-based article that is damage resistant for applications such as, but not limited to, glass for display covers. With reference to FIG. 4, the glass-based article has a first region under compressive stress (e.g., first and second compressive layers 120, 122 in FIG. 4) extending from the surface to a DOC of the glass and a second region (e.g., central region 130 in FIG. 4) under a tensile stress or CT extending from the DOC into the central or interior region of the glass. A first segment 120 extends from first surface 110 to a depth d₁ and a second segment 122 extends from second surface 112 to a depth d₂. Together, these segments define a compression or CS of glass 100.

In embodiments, the surface CS of the glass composition may be in the range from greater than or equal to 200 MPa to less than or equal to 350 MPa, such as from greater than or equal to 220 MPa to less than or equal to 350 MPa, from greater than or equal to 240 MPa to less than or equal to 350 MPa, from greater than or equal to 250 MPa to less than or equal to 350 MPa, from greater than or equal to 260 MPa to less than or equal to 350 MPa, from greater than or equal to 280 MPa to less than or equal to 350 MPa, from greater than or equal to 300 MPa to less than or equal to 350 MPa, from greater than or equal to 320 MPa to less than or equal to 350 MPa, from greater than or equal to 340 MPa to less than or equal to 350 MPa, from greater than or equal to 200 MPa to less than or equal to 340 MPa, from greater than or equal to 220 MPa to less than or equal to 340 MPa, from greater than or equal to 240 MPa to less than or equal to 340 MPa, from greater than or equal to 250 MPa to less than or equal to 340 MPa, from greater than or equal to 260 MPa to less than or equal to 340 MPa, from greater than or equal to 280 MPa to less than or equal to 340 MPa, from greater than or equal to 300 MPa to less than or equal to 340 MPa, from greater than or equal to 320 MPa to less than or equal to 340 MPa, from greater than or equal to 200 MPa to less than or equal to 320 MPa, from greater than or equal to 220 MPa to less than or equal to 320 MPa, from greater than or equal to 240 MPa to less than or equal to 320 MPa, from greater than or equal to 250 MPa to less than or equal to 320 MPa, from greater than or equal to 260 MPa to less than or equal to 320 MPa, from greater than or equal to 280 MPa to less than or equal to 320 MPa, from greater than or equal to 300 MPa to less than or equal to 320 MPa, from greater than or equal to 200 MPa to less than or equal to 300 MPa, from greater than or equal to 220 MPa to less than or equal to 300 MPa, from greater than or equal to 240 MPa to less than or equal to 300 MPa, from greater than or equal to 250 MPa to less than or equal to 300 MPa, from greater than or equal to 260 MPa to less than or equal to 300 MPa, from greater than or equal to 280 MPa to less than or equal to 300 MPa, from greater than or equal to 200 MPa to less than or equal to 280 MPa, from greater than or equal to 220 MPa to less than or equal to 280 MPa, from greater than or equal to 240 MPa to less than or equal to 280 MPa, from greater than or equal to 250 MPa to less than or equal to 280 MPa, from greater than or equal to 260 MPa to less than or equal to 280 MPa, from greater than or equal to 200 MPa to less than or equal to 260 MPa, from greater than or equal to 220 MPa to less than or equal to 260 MPa, from greater than or equal to 240 MPa to less than or equal to 260 MPa, from greater than or equal to 250 MPa to less than or equal to 260 MPa, from greater than or equal to 200 MPa to less than or equal to 250 MPa, from greater than or equal to 220 MPa to less than or equal to 250 MPa, from greater than or equal to 240 MPa to less than or equal to 250 MPa, from greater than or equal to 200 MPa to less than or equal to 240 MPa, or from greater than or equal to 220 MPa to less than or equal to 240 MPa, from greater than or equal to 200 MPa to less than or equal to 220 MPa, including any and all sub-ranges between the foregoing values.

In embodiments, the maximum CT of the glass-based article may be in the range from greater than or equal to 90 MPa to less than or equal to 125 MPa, such as from greater than or equal to 95 MPa to less than or equal to 125 MPa, from greater than or equal to 100 MPa to less than or equal to 125 MPa, from greater than or equal to 105 MPa to less than or equal to 125 MPa, from greater than or equal to 110 MPa to less than or equal to 125 MPa, from greater than or equal to 115 MPa to less than or equal to 125 MPa, from greater than or equal to 120 MPa to less than or equal to 125 MPa, from greater than or equal to 90 MPa to less than or equal to 120 MPa, from greater than or equal to 95 MPa to less than or equal to 120 MPa, from greater than or equal to 100 MPa to less than or equal to 120 MPa, from greater than or equal to 105 MPa to less than or equal to 120 MPa, from greater than or equal to 110 MPa to less than or equal to 120 MPa, from greater than or equal to 115 MPa to less than or equal to 120 MPa, from greater than or equal to 90 MPa to less than or equal to 115 MPa, from greater than or equal to 95 MPa to less than or equal to 115 MPa, from greater than or equal to 100 MPa to less than or equal to 115 MPa, from greater than or equal to 105 MPa to less than or equal to 115 MPa, from greater than or equal to 110 MPa to less than or equal to 115 MPa, from greater than or equal to 90 MPa to less than or equal to 110 MPa, from greater than or equal to 95 MPa to less than or equal to 110 MPa, from greater than or equal to 100 MPa to less than or equal to 110 MPa, from greater than or equal to 105 MPa to less than or equal to 110 MPa, from greater than or equal to 90 MPa to less than or equal to 105 MPa, from greater than or equal to 95 MPa to less than or equal to 105 MPa, from greater than or equal to 100 MPa to less than or equal to 105 MPa, from greater than or equal to 90 MPa to less than or equal to 100 MPa, from greater than or equal to 95 MPa to less than or equal to 100 MPa, from greater than or equal to 90 MPa to less than or equal to 95 MPa, including any and all sub-ranges between the foregoing values.

In embodiments, the DOC of the glass compositions may in the range from greater than or equal to 0.14 t to less than or equal to 0.24 t where t is the thickness of the articles, such as from greater than or equal to 0.15 t to less than or equal to 0.24 t, from greater than or equal to 0.16 t to less than or equal to 0.24 t, from greater than or equal to 0.17 t to less than or equal to 0.24 t, from greater than or equal to 0.18 t to less than or equal to 0.24 t, from greater than or equal to 0.19 t to less than or equal to 0.24 t, from greater than or equal to 0.20 t to less than or equal to 0.24 t, from greater than or equal to 0.21 t to less than or equal to 0.24 t, from greater than or equal to 0.22 t to less than or equal to 0.24 t, from greater than or equal to 0.23 t to less than or equal to 0.24 t, from greater than or equal to 0.14 t to less than or equal to 0.23 t, from greater than or equal to 0.15 t to less than or equal to 0.23 t, from greater than or equal to 0.16 t to less than or equal to 0.23 t, from greater than or equal to 0.17 t to less than or equal to 0.23 t, from greater than or equal to 0.18 t to less than or equal to 0.23 t, from greater than or equal to 0.19 t to less than or equal to 0.23 t, from greater than or equal to 0.20 t to less than or equal to 0.23 t, from greater than or equal to 0.21 t to less than or equal to 0.23 t, from greater than or equal to 0.22 t to less than or equal to 0.23 t, from greater than or equal to 0.14 t to less than or equal to 0.22 t, from greater than or equal to 0.15 t to less than or equal to 0.22 t, from greater than or equal to 0.16 t to less than or equal to 0.22 t, from greater than or equal to 0.17 t to less than or equal to 0.22 t, from greater than or equal to 0.18 t to less than or equal to 0.22 t, from greater than or equal to 0.19 t to less than or equal to 0.22 t, from greater than or equal to 0.20 t to less than or equal to 0.22 t, from greater than or equal to 0.21 t to less than or equal to 0.22 t, from greater than or equal to 0.14 t to less than or equal to 0.21 t, from greater than or equal to 0.15 t to less than or equal to 0.21 t, from greater than or equal to 0.16 t to less than or equal to 0.21 t, from greater than or equal to 0.17 t to less than or equal to 0.21 t, from greater than or equal to 0.18 t to less than or equal to 0.21 t, from greater than or equal to 0.19 t to less than or equal to 0.21 t, from greater than or equal to 0.20 t to less than or equal to 0.21 t, from greater than or equal to 0.14 t to less than or equal to 0.20 t, from greater than or equal to 0.15 t to less than or equal to 0.20 t, from greater than or equal to 0.16 t to less than or equal to 0.20 t, from greater than or equal to 0.17 t to less than or equal to 0.20 t, from greater than or equal to 0.18 t to less than or equal to 0.20 t, from greater than or equal to 0.19 t to less than or equal to 0.20 t, from greater than or equal to 0.14 t to less than or equal to 0.19 t, from greater than or equal to 0.15 t to less than or equal to 0.19 t, from greater than or equal to 0.16 t to less than or equal to 0.19 t, from greater than or equal to 0.17 t to less than or equal to 0.19 t, from greater than or equal to 0.18 t to less than or equal to 0.19 t, from greater than or equal to 0.14 t to less than or equal to 0.18 t, from greater than or equal to 0.15 t to less than or equal to 0.18 t, from greater than or equal to 0.16 t to less than or equal to 0.18 t, from greater than or equal to 0.17 t to less than or equal to 0.18 t, from greater than or equal to 0.14 t to less than or equal to 0.17 t, from greater than or equal to 0.15 t to less than or equal to 0.17 t, from greater than or equal to 0.16 t to less than or equal to 0.17 t, from greater than or equal to 0.14 t to less than or equal to 0.16 t, from greater than or equal to 0.15 t to less than or equal to 0.16 t, from greater than or equal to 0.14 t to less than or equal to 0.15 t, including any and all sub-ranges between the foregoing values.

In embodiments, the DOC of the glass composition may be in the range from greater than or equal to 85 μm to less than or equal to 150 μm, such as from greater than or equal to 95 μm to less than or equal to 150 μm, from greater than or equal to 100 μm to less than or equal to 150 μm, from greater than or equal to 110 μm to less than or equal to 150 μm, from greater than or equal to 120 μm to less than or equal to 150 μm, from greater than or equal to 130 μm to less than or equal to 150 μm, from greater than or equal to 140 μm to less than or equal to 150 μm, from greater than or equal to 85 μm to less than or equal to 140 μm, from greater than or equal to 95 μm to less than or equal to 140 μm, from greater than or equal to 100 μm to less than or equal to 140 μm, from greater than or equal to 110 μm to less than or equal to 140 μm, from greater than or equal to 120 μm to less than or equal to 140 μm, from greater than or equal to 130 μm to less than or equal to 140 μm, from greater than or equal to 85 μm to less than or equal to 130 μm, from greater than or equal to 95 μm to less than or equal to 130 μm, from greater than or equal to 100 μm to less than or equal to 130 μm, from greater than or equal to 110 μm to less than or equal to 130 μm, from greater than or equal to 120 μm to less than or equal to 130 μm, from greater than or equal to 85 μm to less than or equal to 120 μm, from greater than or equal to 95 μm to less than or equal to 120 μm, from greater than or equal to 100 μm to less than or equal to 120 μm, from greater than or equal to 110 μm to less than or equal to 120 μm, from greater than or equal to 85 μm to less than or equal to 110 μm, from greater than or equal to 95 μm to less than or equal to 110 μm, from greater than or equal to 100 μm to less than or equal to 110 μm, from greater than or equal to 85 μm to less than or equal to 100 μm, from greater than or equal to 95 μm to less than or equal to 100 μm, from greater than or equal to 85 μm to less than or equal to 100 μm, from greater than or equal to 95 μm to less than or equal to 100 μm, from greater than or equal to 85 μm to less than or equal to 95 μm, including any and all sub-ranges between the foregoing values.

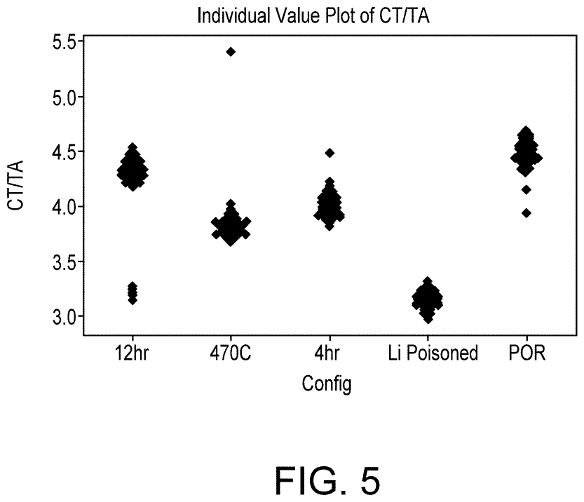

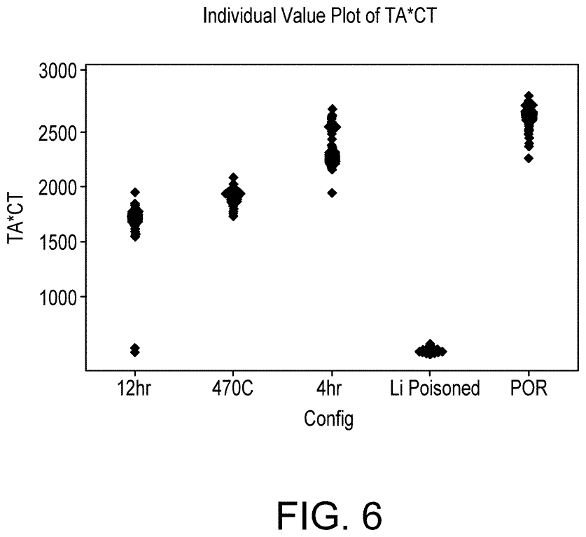

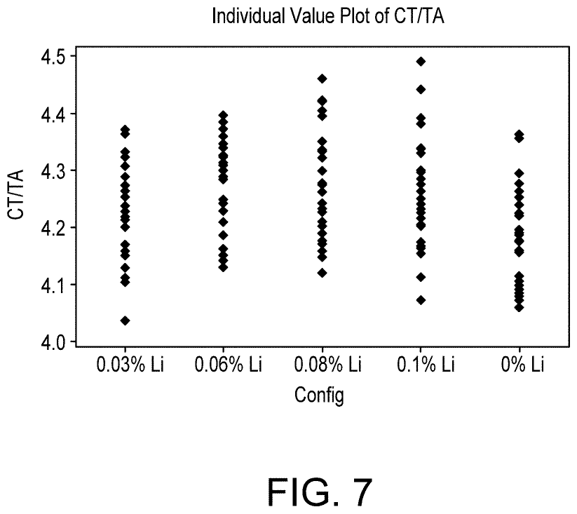

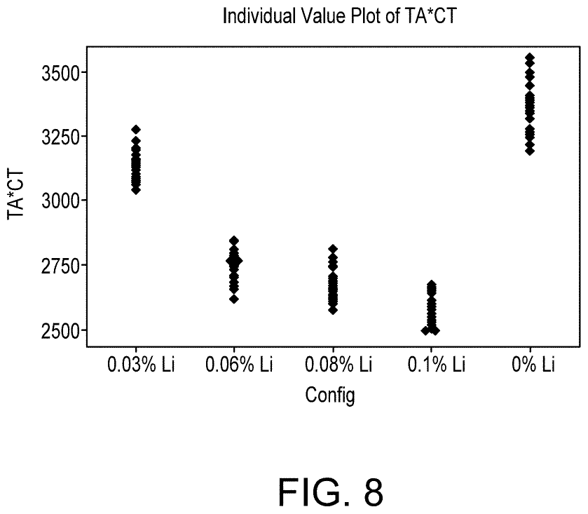

The CT may be measured as a ratio of CT (MPa) to integrated tension area (MPa*μm), referred to as CT/TA. According to embodiments, CT/TA is from greater than or equal to 3.0 μm⁻¹ to less than or equal to 5.5 μm⁻¹, such as from greater than or equal to 3.2 μm⁻¹ to less than or equal to 5.5 μm⁻¹, from greater than or equal to 3.5 μm⁻¹ to less than or equal to 5.5 μm⁻¹, from greater than or equal to 3.8 μm⁻¹ to less than or equal to 5.5 μm⁻¹, from greater than or equal to 4.0 μm⁻¹ to less than or equal to 5.5 μm⁻¹, from greater than or equal to 4.2 μm⁻¹ to less than or equal to 5.5 μm⁻¹, from greater than or equal to 4.5 μm⁻¹ to less than or equal to 5.5 μm⁻¹, from greater than or equal to 4.8 μm⁻¹ to less than or equal to 5.5 μm⁻¹, from greater than or equal to 5.0 μm⁻¹ to less than or equal to 5.5 μm⁻¹, from greater than or equal to 5.2 μm⁻¹ to less than or equal to 5.5 μm⁻¹, from greater than or equal to 3.0 μm⁻¹ to less than or equal to 5.2 μm⁻¹, from greater than or equal to 3.2 μm⁻¹ to less than or equal to 5.2 μm⁻¹, from greater than or equal to 3.5 μm⁻¹ to less than or equal to 5.2 μm⁻¹, from greater than or equal to 3.8 μm⁻¹ to less than or equal to 5.2 μm⁻¹, from greater than or equal to 4.0 μm⁻¹ to less than or equal to 5.2 μm⁻¹, from greater than or equal to 4.2 μm⁻¹ to less than or equal to 5.2 μm⁻¹, from greater than or equal to 4.5 μm⁻¹ to less than or equal to 5.2 μm⁻¹, from greater than or equal to 4.8 μm⁻¹ to less than or equal to 5.2 μm⁻¹, from greater than or equal to 5.0 μm⁻¹ to less than or equal to 5.2 μm⁻¹, from greater than or equal to 3.0 μm⁻¹ to less than or equal to 5.0 μm⁻¹, from greater than or equal to 3.2 μm⁻¹ to less than or equal to 5.0 μm⁻¹, from greater than or equal to 3.5 μm⁻¹ to less than or equal to 5.0 μm⁻¹, from greater than or equal to 3.8 μm⁻¹ to less than or equal to 5.0 μm⁻¹, from greater than or equal to 4.0 μm⁻¹ to less than or equal to 5.0 μm⁻¹, from greater than or equal to 4.2 μm⁻¹ to less than or equal to 5.0 μm⁻¹, from greater than or equal to 4.5 μm⁻¹ to less than or equal to 5.0 μm⁻¹, from greater than or equal to 4.8 μm⁻¹ to less than or equal to 5.0 μm⁻¹, from greater than or equal to 3.0 μm⁻¹ to less than or equal to 4.8 μm⁻¹, from greater than or equal to 3.2 μm⁻¹ to less than or equal to 4.8 μm⁻¹, from greater than or equal to 3.5 μm⁻¹ to less than or equal to 4.8 μm⁻¹, from greater than or equal to 3.8 μm⁻¹ to less than or equal to 4.8 μm⁻¹, from greater than or equal to 4.0 μm⁻¹ to less than or equal to 4.8 μm⁻¹, from greater than or equal to 4.2 μm⁻¹ to less than or equal to 4.8 μm⁻¹, from greater than or equal to 4.5 μm⁻¹ to less than or equal to 4.8 μm⁻¹, from greater than or equal to 3.0 μm⁻¹ to less than or equal to 4.5 μm⁻¹, from greater than or equal to 3.2 μm⁻¹ to less than or equal to 4.5 μm⁻¹, from greater than or equal to 3.5 μm⁻¹ to less than or equal to 4.5 μm⁻¹, from greater than or equal to 3.8 μm⁻¹ to less than or equal to 4.5 μm⁻¹, from greater than or equal to 4.0 μm⁻¹ to less than or equal to 4.5 μm⁻¹, from greater than or equal to 4.2 μm⁻¹ to less than or equal to 4.5 μm⁻¹, from greater than or equal to 3.0 μm⁻¹ to less than or equal to 4.2 μm⁻¹, from greater than or equal to 3.2 μm⁻¹ to less than or equal to 4.2 μm⁻¹, from greater than or equal to 3.5 μm⁻¹ to less than or equal to 4.2 μm⁻¹, from greater than or equal to 3.8 μm⁻¹ to less than or equal to 4.2 μm⁻¹, from greater than or equal to 4.0 μm⁻¹ to less than or equal to 4.2 μm⁻¹, from greater than or equal to 3.0 μm⁻¹ to less than or equal to 4.0 μm⁻¹, from greater than or equal to 3.2 μm⁻¹ to less than or equal to 4.0 μm⁻¹, from greater than or equal to 3.5 μm⁻¹ to less than or equal to 4.0 μm⁻¹, from greater than or equal to 3.8 μm⁻¹ to less than or equal to 4.0 μm⁻¹, from greater than or equal to 3.0 μm⁻¹ to less than or equal to 3.8 μm⁻¹, from greater than or equal to 3.2 μm⁻¹ to less than or equal to 3.8 μm⁻¹, from greater than or equal to 3.5 μm⁻¹ to less than or equal to 3.8 μm⁻¹, from greater than or equal to 3.0 μm⁻¹ to less than or equal to 3.5 μm⁻¹, from greater than or equal to 3.2 μm⁻¹ to less than or equal to 3.5 μm⁻¹, from greater than or equal to 3.0 μm⁻¹ to less than or equal to 3.2 μm⁻¹, including any and all subranges within the above ranges. Plots of CT/TA and CT*TA at various IOX conditions are shown in FIGS. 5-8.

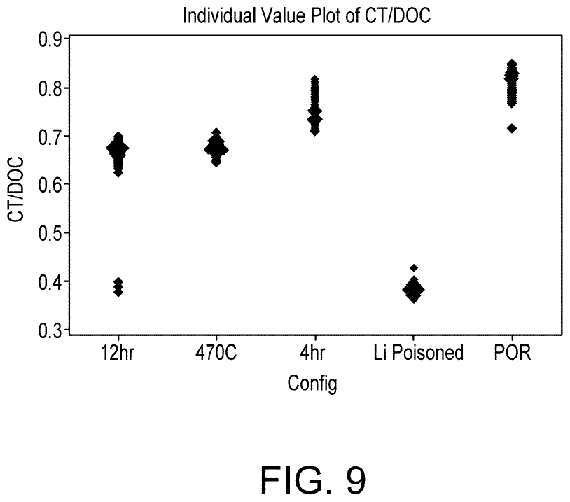

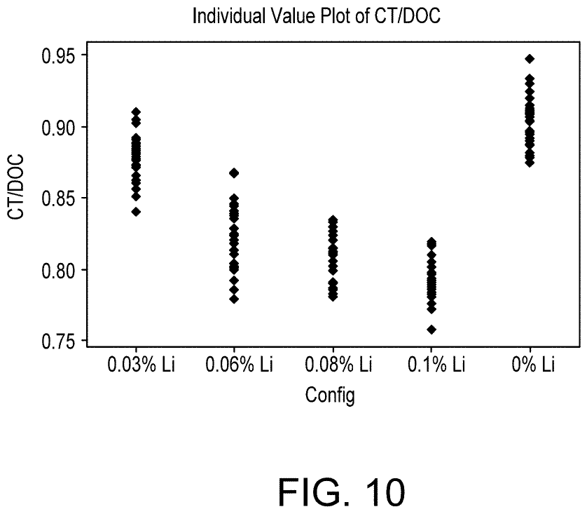

The CT may also be described as a ratio of DOC, referred to as CT/DOC (MPa/μm). According to embodiments, glass-based articles have a CT/DOC from greater than or equal to 0.6 MPa/μm to less than or equal to 1.0 MPa/μm, such as from greater than or equal to 0.7 MPa/μm to less than or equal to 1.0 MPa/μm, from greater than or equal to 0.8 MPa/μm to less than or equal to 1.0 MPa/μm, from greater than or equal to 0.9 MPa/μm to less than or equal to 1.0 MPa/μm, from greater than or equal to 0.6 MPa/μm to less than or equal to 0.9 MPa/μm, from greater than or equal to 0.7 MPa/μm to less than or equal to 0.9 MPa/μm, from greater than or equal to 0.8 MPa/μm to less than or equal to 0.9 MPa/μm, from greater than or equal to 0.6 MPa/μm to less than or equal to 0.8 MPa/μm, from greater than or equal to 0.7 MPa/μm to less than or equal to 0.8 MPa/μm, from greater than or equal to 0.6 MPa/μm to less than or equal to 0.7 MPa/μm, including any and all subranges within the above ranges. Plots of CT/DOC at various IOX conditions are shown in FIGS. 9 and 10.

According to embodiments, glass-based articles have a UV (350 to 400 nm) reflectance measured by a spectrometer (Cary 5000, Perkin-Elmer 950, Hitachi U-4001) from greater than or equal to 4.7% to less than or equal to 5.0%, such as from greater than or equal to 4.8% to less than or equal to 5.0%, from greater than or equal to 4.9% to less than or equal to 5.0%, from greater than or equal to 4.7% to less than or equal to 4.9%, from greater than or equal to 4.8% to less than or equal to 4.9%, or from greater than or equal to 4.7% to less than or equal to 4.8%, including any and all subranges within the above ranges.

According to embodiments, glass-based articles have a visible light (440 to 770 nm) reflectance measured by a spectrometer (Cary 5000, Perkin-Elmer 950, Hitachi U-4001) from greater than or equal to 4.4% to less than or equal to 4.8%, such as from greater than or equal to 4.5% to less than or equal to 4.8%, from greater than or equal to 4.6% to less than or equal to 4.8%, from greater than or equal to 4.7% to less than or equal to 4.8%, from greater than or equal to 4.4% to less than or equal to 4.7%, from greater than or equal to 4.5% to less than or equal to 4.7%, from greater than or equal to 4.6% to less than or equal to 4.7%, from greater than or equal to 4.4% to less than or equal to 4.6%, from greater than or equal to 4.5% to less than or equal to 4.6%, from greater than or equal to 4.4% to less than or equal to 4.5%, including any and all subranges within the above ranges.

According to embodiments, glass-based articles have an IR (770 to 1000 nm) reflectance measured by a spectrometer (Cary 5000, Perkin-Elmer 950, Hitachi U-4001) from greater than or equal to 4.3% to less than or equal to 4.5%, such as from greater than or equal to 4.4% to less than or equal to 4.5%, or greater than or equal to 4.4% to less than or equal to 4.5%, including any and all subranges within the above ranges.

According to embodiments, glass-based articles have an UV (350 to 400 nm) transmittance measured by a spectrometer (Cary 5000, Perkin-Elmer 950) that is greater than or equal to 70%, such as greater than or equal to 72%, greater than or equal to 75%, greater than or equal to 78%, greater than or equal to 80%, greater than or equal to 82%, greater than or equal to 85%, greater than or equal to 88%, including any and all subranges within the above ranges.

According to embodiments, glass-based articles have an visible light (400 to 770 nm) transmittance measured by a spectrometer (Cary 5000, Perkin-Elmer 950) that is greater than or equal to 89%, such as greater than or equal to 90%, greater than or equal to 92%, greater than or equal to 94%, greater than or equal to 96%, greater than or equal to 98%, including any and all subranges within the above ranges.

According to embodiments, glass-based articles have an IR (770 to 1000 nm) transmittance measured by a spectrometer (Cary 5000, Perkin-Elmer 950) that is greater than or equal to 90%, such as greater than or equal to 92%, greater than or equal to 94%, greater than or equal to 96%, greater than or equal to 98%, including any and all subranges within the above ranges.

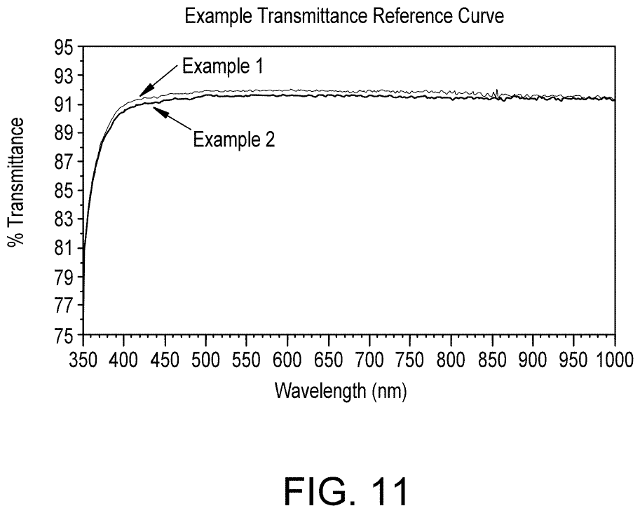

According to embodiments, glass-based articles have a transmittance of IR having a wavelength of 940 nm plus or minus 20 nm measured by a spectrometer (Cary 5000, Perkin-Elmer 950) that is greater than or equal to 90%, such as greater than or equal to 92%, greater than or equal to 94%, greater than or equal to 96%, greater than or equal to 98%, including any and all subranges within the above ranges. A transmission curve according to embodiments is shown in FIG. 11.

According to embodiments, glass-based articles have a L*a*b* color measured according to F2, CIE 1964 10° calculated from transmission on polished sample according to ASTM E308-08 at wavelength 380 to 770 nm as follows: L* from greater than or equal to 96.00 to less than or equal to 97.00, such as from greater than or equal to 96.17 to less than or equal to 96.75; a* from greater than or equal to −0.01 to −0.07, such as from greater than or equal to −0.02 to less than or equal to −0.06; b* from greater than or equal to 0.30 to less than or equal to 0.80, such as from greater than or equal to 0.31 to less than or equal to 0.77.

According to embodiments, the glass-based articles have a refractive index at wavelengths from 365 nm to 790 nm measured by Metricon or Abbe refractometer from greater than or equal to 1.50 to less than or equal to 1.60, such as from greater than or equal to 1.51 to less than or equal to 1.60, from greater than or equal to 1.52 to less than or equal to 1.60, from greater than or equal to 1.53 to less than or equal to 1.60, from greater than or equal to 1.54 to less than or equal to 1.60, from greater than or equal to 1.55 to less than or equal to 1.60, from greater than or equal to 1.56 to less than or equal to 1.60, from greater than or equal to 1.57 to less than or equal to 1.60, from greater than or equal to 1.58 to less than or equal to 1.60, from greater than or equal to 1.59 to less than or equal to 1.60, from greater than or equal to 1.50 to less than or equal to 1.59, from greater than or equal to 1.51 to less than or equal to 1.59, from greater than or equal to 1.52 to less than or equal to 1.59, from greater than or equal to 1.53 to less than or equal to 1.59, from greater than or equal to 1.54 to less than or equal to 1.59, from greater than or equal to 1.55 to less than or equal to 1.59, from greater than or equal to 1.56 to less than or equal to 1.59, from greater than or equal to 1.57 to less than or equal to 1.59, from greater than or equal to 1.58 to less than or equal to 1.59, from greater than or equal to 1.50 to less than or equal to 1.58, from greater than or equal to 1.51 to less than or equal to 1.58, from greater than or equal to 1.52 to less than or equal to 1.58, from greater than or equal to 1.53 to less than or equal to 1.58, from greater than or equal to 1.54 to less than or equal to 1.58, from greater than or equal to 1.55 to less than or equal to 1.58, from greater than or equal to 1.56 to less than or equal to 1.58, from greater than or equal to 1.57 to less than or equal to 1.58, from greater than or equal to 1.50 to less than or equal to 1.57, from greater than or equal to 1.51 to less than or equal to 1.57, from greater than or equal to 1.52 to less than or equal to 1.57, from greater than or equal to 1.53 to less than or equal to 1.57, from greater than or equal to 1.54 to less than or equal to 1.57, from greater than or equal to 1.55 to less than or equal to 1.57, from greater than or equal to 1.56 to less than or equal to 1.57, from greater than or equal to 1.50 to less than or equal to 1.56, from greater than or equal to 1.51 to less than or equal to 1.56, from greater than or equal to 1.52 to less than or equal to 1.56, from greater than or equal to 1.53 to less than or equal to 1.56, from greater than or equal to 1.54 to less than or equal to 1.56, from greater than or equal to 1.55 to less than or equal to 1.56, from greater than or equal to 1.50 to less than or equal to 1.55, from greater than or equal to 1.51 to less than or equal to 1.55, from greater than or equal to 1.52 to less than or equal to 1.55, from greater than or equal to 1.53 to less than or equal to 1.55, from greater than or equal to 1.54 to less than or equal to 1.55, from greater than or equal to 1.50 to less than or equal to 1.54, from greater than or equal to 1.51 to less than or equal to 1.54, from greater than or equal to 1.52 to less than or equal to 1.54, from greater than or equal to 1.53 to less than or equal to 1.54, from greater than or equal to 1.50 to less than or equal to 1.53, from greater than or equal to 1.51 to less than or equal to 1.53, from greater than or equal to 1.52 to less than or equal to 1.53, from greater than or equal to 1.50 to less than or equal to 1.52, from greater than or equal to 1.51 to less than or equal to 1.52, from greater than or equal to 1.50 to less than or equal to 1.51, including any and all subranges within the above ranges.

According to embodiments, the glass-based articles have a haze measured by BYK Haze-Gard Plus of less than or equal to 0.15%, such as less than or equal to 0.12%, less than or equal to 0.10%, less than or equal to 0.08%, less than or equal to 0.06%, less than or equal to 0.04%, less than or equal to 0.02%, including any and all subranges within the above ranges.

The term “failure height,” as used herein, refers to the lowest height from which a device including a glass-based article can be dropped and the glass-based article fails (i.e., cracks). The Drop Test Method is used to determine the failure height on a device. The Drop Test Method involves performing face-drop testing on a puck with a glass-based article attached thereto. The glass-based article is attached to the puck with tesa® 61385 double sided adhesive tape to hold the glass-based article to the puck during the drop test described herein below. The glass-based article to be tested has a thickness similar or equal to the thickness that will be used in a given hand-held consumer electronic device, such as 0.5 mm or 0.6 mm. A puck refers to a structure meant to mimic the size, shape, and weight distribution of a given device, such as a cell phone. Hereinafter, the term “puck,” refers to a structure that has a weight of 126.0 grams, a length of 133.1 mm, a width of 68.2 mm, and a height of 9.4 mm. In embodiments, the puck has the dimensions and weight similar to a handheld electronic device.

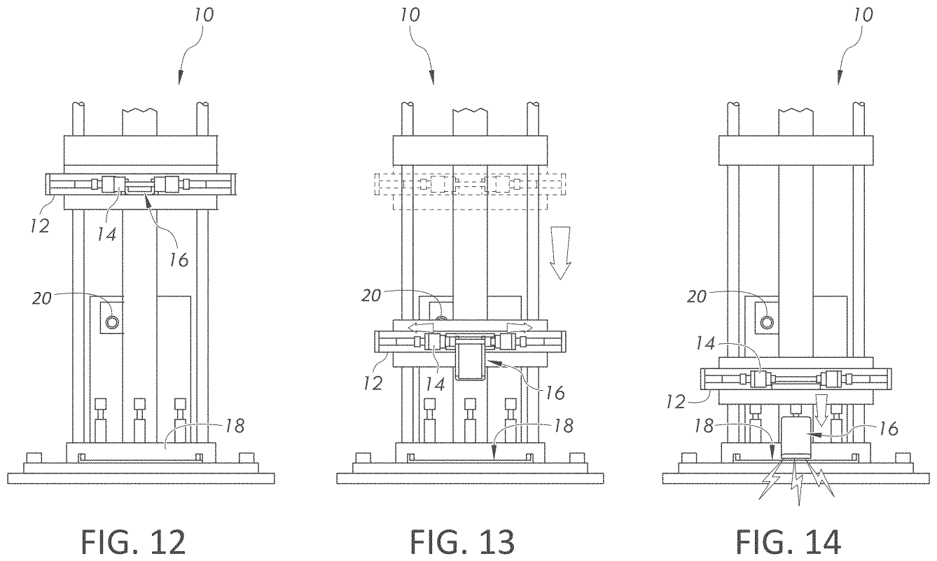

An exemplary device-drop machine that may be used to conduct the Drop Test Method is shown as reference number 10 in FIG. 12. The device-drop machine 10 includes a chuck 12 having chuck jaws 14. The puck 16 is staged in the chuck jaws 14 with the glass article attached thereto and facing downward. The chuck 12 is ready to fall from, for example, an electro-magnetic chuck lifter. Referring now to FIG. 13, the chuck 12 is released and during its fall, the chuck jaws 14 are triggered to open by, for example, a proximity sensor 20. As the chuck jaws 14 open, the puck 16 is released. Referring now to FIG. 14, the falling puck 16 strikes a drop surface 18. The drop surface 18 may be sandpaper, such as 180 grit sandpaper, positioned on a steel plate. If the glass-based article attached to the puck survives the fall (i.e., does not crack), the chuck 12 is set at an increased height and the test is repeated. The failure height is then the lowest height from which the puck including the glass article is dropped and the glass composition fails. A single glass-based article is tested at multiple heights, such as at 22 cm, 30 cm, 40 cm, 50 cm, 60 cm, and increments of 10 centimeters until the glass-based article fails by showing damage. The sandpaper is replaced upon failure of the glass-based article. Unless otherwise indicated 180 grit sandpaper is used herein.

In embodiments, the glass-based article may have a failure height of greater than or equal to 100 cm, greater than or equal to 110 cm, greater than or equal to 120 cm, greater than or equal to 130 cm, greater than or equal to 140 cm, greater than or equal to 150 cm, greater than or equal to 160 cm, greater than or equal to 170 cm, greater than or equal to 180 cm, greater than or equal to 190 cm, or greater than or equal to 200 cm as measured for an article having a thickness of 0.6 mm according to the Drop Test Method on 180 grit sandpaper. In embodiments, the glass-based article may have a failure height in the range from greater than or equal to 100 cm to less than or equal to 200 cm, from greater than or equal to 120 cm to less than or equal to 180 cm, from greater than or equal to 140 cm to less than or equal to 160 cm, or from greater than or equal to 145 cm to less than or equal to 155 cm, as measured for an article having a thickness of 0.6 mm according to the Drop Test Method on 180 grit sandpaper. In embodiments, the glass composition may have a failure height of greater than or equal to 150 cm, greater than or equal to 160 cm, greater than or equal to 170 cm, greater than or equal to 180 cm, greater than or equal to 190 cm, or greater than or equal to 200 cm as measured for an article having a thickness of 0.6 mm according to the Drop Test Method on 180 grit sandpaper. In embodiments, the glass composition may have a failure height in the range from greater than or equal to 150 cm to less than or equal to 200 cm, from greater than or equal to 160 cm to less than or equal to 190 cm, from greater than or equal to 165 cm to less than or equal to 185 cm, or from greater than or equal to 170 cm to less than or equal to 180 cm, as measured for an article having a thickness of 0.6 mm according to the Drop Test Method on 180 grit sandpaper. The above ranges include any and all sub-ranges between the foregoing values.

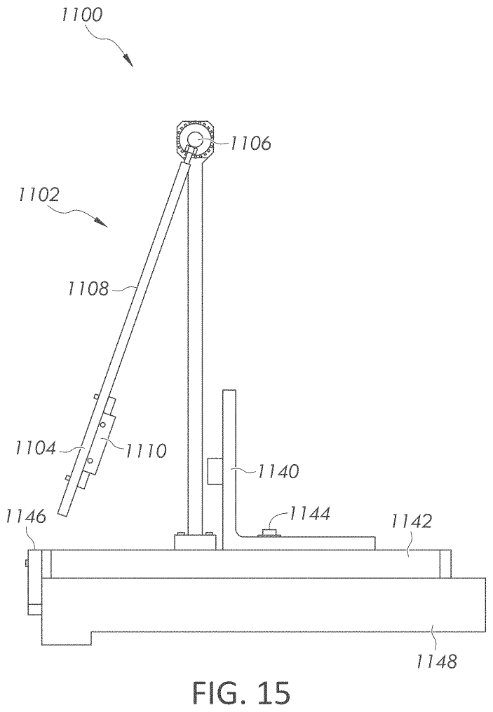

The term “retained strength,” as used herein, refers to the strength of a glass article after damage introduction by an impact force when the article is bent to impart tensile tress. Damage is introduced according to the method described in U.S. Patent Publication No. 2019/0072469 A1, which is incorporated herein by reference. For example, an apparatus for impact testing a glass article is shown as reference number 1100 in FIG. 15. The apparatus 1100 includes a pendulum 1102 including a bob 1104 attached to a pivot 1106. The term “bob” on a pendulum, as used herein, is a weight suspended from and connected to a pivot by an arm. Thus, the bob 1104 shown is connected to the pivot 1106 by an arm 1108. The bob 1104 includes a base 1110 for receiving a glass article, and the glass article is affixed to the base. The apparatus 1100 further includes an impacting object 1140 positioned such that when the bob 1104 is released from a position at an angle greater than zero from the equilibrium position, the surface of the bob 1104 contacts the impacting object 1140. The impacting object includes an abrasive sheet having an abrasive surface to be placed in contact with the outer surface of the glass article. The abrasive sheet may comprise sandpaper, which may have a grit size in the range of 30 grit to 1000 grit, or 100 grit to 300 grit, for example 80 grit, 120 grit, 180 grit, and 1000 grit sandpaper). Unless otherwise indicated 80 grit sandpaper was used herein to measure retained strength.

For purposes of this disclosure, the impacting object was in the form of a 6 mm diameter disk of 80 grit, 120 grit, or 180 grit sandpaper affixed to the apparatus. A glass article having a thickness of approximately 600.0 μm was affixed to the bob. For each impact, a fresh sandpaper disk was used. Damage on the glass article was done at approximately 500.0 N impact force by pulling the swing of the arm of the apparatus to approximately a 90° angle. Approximately 10 samples of each glass article were impacted.

Twenty-four after the damage introduction, the glass articles were fractured in four-point bending (4PB). The damaged glass article was placed on support rods (support span) with the damaged site on the bottom (i.e., on the tension side) and between the load roads (loading span). For purposes of this disclosure, the loading span was 18 mm and the support span was 36 mm. The radius of curvature of load and support rods was 3.2 mm. Loading was done at a constant displacement rate of 5 mm/min using a screw-driven testing machine (Instron®, Norwood, Mass., USA) until failure of the glass. The 4PB tests were performed at a temperature of 22° C.±2° C. and at a relative humidity (RH) of 50%±5%.

The applied fracture stress (or the applied stress to failure) σₐₚₚ in four-point bending (4PB) was calculated from the equation,

$${σ}_{app} = \frac{1}{( 1 - {v}^{2} )} \frac{3 P ( L - a )}{2 {bh}^{2}} \qquad ( 1 )$$

where, P is the maximum load to failure, L (=36 mm) is the distance between support rods (support span), a (=18 mm) is the distance between the loading rods (loading span), b is the width of the glass plate, h is the thickness of the glass plate and v is the Poisson's Ratio of the glass composition. The term (1/(1−v²)) in Eq. (1) considers the stiffening effect of a plate. In four-point bending, stress is constant under the loading span and thus, the damaged site is under mode I uniaxial tensile stress loading. The stressing rate of the 4-point bend testing for the specimens was estimated to be between 15 to 17 MPa per sec. The retained strength of the glass composition is the highest applied fracture stress at which failure does not occur.

In embodiments, the glass-based article may have a retained strength of greater than or equal to 250 MPa, greater than or equal to 275 MPa, greater than or equal to 300 MPa, or greater than or equal to 325 MPa as measured for an article having a thickness of 600.0 μm after impact with 80 grit sandpaper with a force of 500.0 N. In embodiments, the glass composition may have a retained strength in the range from greater than or equal to 250 MPa to less than or equal to 400 MPa, greater than or equal to 275 MPa to less than or equal to 375 MPa, or from greater than or equal to 300 MPa to less than or equal to 350 MPa as measured for an article having a thickness of 600.0 μm after impact with 80 grit sandpaper with a force of 500.0 N. The above ranges any and all sub-ranges between the foregoing values.

In embodiments, glass-based articles have a hardness measured on the Mohs scale as set forth in American Federation of Mineralogical Societies, “Mohs Scale of Mineral Hardness” May 16, 2010. (http://web.archive.org/web/20100516034340/http:/www.amfed.org/t_mohs.htm) that is greater than or equal to 7.0, such as greater than or equal to 7.5, greater than or equal to 8.0, greater than or equal to 8.5. In embodiments, glass-based articles have a hardness measured on the Mohs scale from greater than or equal to 7.0 to less than or equal to 8.5, from greater than or equal to 7.5 to less than or equal to 8.5, greater than or equal to 8.0 to less than or equal to 8.5, including any and all sub-ranges between the foregoing values.

Knoop scratch testing is conducted using a Knoop indenter at various loads and speeds and measuring the resulting scratch width. As used herein, the Knoop scratch test includes applying a 5 Newton (N) load at a speed of 9.34 mm/min, applying a 8 N load at a speed of 9.34 mm/min, and ramping from a 1 N load to a 8 N load at a speed of 9.34 mm/min. Tests were conducted along a glass-based article with a 10 mm length.

In embodiments, the glass-based articles have scratch widths less than 300 μm when conducting the Knoop scratch testing at the loads up to 2 N and speeds, such as scratch widths less than or equal to 275 μm, scratch widths less than or equal to 250 μm, scratch widths less than or equal to 225 μm, scratch widths less than or equal to 200 μm, scratch widths less than or equal to 175 μm, or scratch widths less than or equal to 150 μm. In embodiments, the glass-based articles have scratch widths from greater than or equal to 50 μm to less than or equal to 300 μm, greater than or equal to 75 μm to less than or equal to 300 μm, greater than or equal to 100 μm to less than or equal to 300 μm, greater than or equal to 125 μm to less than or equal to 300 μm, greater than or equal to 150 μm to less than or equal to 300 μm, greater than or equal to 175 μm to less than or equal to 300 μm, greater than or equal to 200 μm to less than or equal to 300 μm, greater than or equal to 225 μm to less than or equal to 300 μm, greater than or equal to 250 μm to less than or equal to 300 μm, greater than or equal to 275 μm to less than or equal to 300 μm, from greater than or equal to 50 μm to less than or equal to 275 μm, greater than or equal to 75 μm to less than or equal to 275 μm, greater than or equal to 100 μm to less than or equal to 275 μm, greater than or equal to 125 μm to less than or equal to 275 μm, greater than or equal to 150 μm to less than or equal to 275 μm, greater than or equal to 175 μm to less than or equal to 275 μm, greater than or equal to 200 μm to less than or equal to 275 μm, greater than or equal to 225 μm to less than or equal to 275 μm, greater than or equal to 250 μm to less than or equal to 275 μm, from greater than or equal to 50 μm to less than or equal to 250 μm, greater than or equal to 75 μm to less than or equal to 250 μm, greater than or equal to 100 μm to less than or equal to 250 μm, greater than or equal to 125 μm to less than or equal to 250 μm, greater than or equal to 150 μm to less than or equal to 250 μm, greater than or equal to 175 μm to less than or equal to 250 μm, greater than or equal to 200 μm to less than or equal to 250 μm, greater than or equal to 225 μm to less than or equal to 250 μm, from greater than or equal to 50 μm to less than or equal to 225 μm, greater than or equal to 75 μm to less than or equal to 225 μm, greater than or equal to 100 μm to less than or equal to 225 μm, greater than or equal to 125 μm to less than or equal to 225 μm, greater than or equal to 150 μm to less than or equal to 225 μm, greater than or equal to 175 μm to less than or equal to 225 μm, greater than or equal to 200 μm to less than or equal to 225 μm, from greater than or equal to 50 μm to less than or equal to 200 μm, greater than or equal to 75 μm to less than or equal to 200 μm, greater than or equal to 100 μm to less than or equal to 200 μm, greater than or equal to 125 μm to less than or equal to 200 μm, greater than or equal to 150 μm to less than or equal to 200 μm, greater than or equal to 175 μm to less than or equal to 200 μm, from greater than or equal to 50 μm to less than or equal to 175 μm, greater than or equal to 75 μm to less than or equal to 175 μm, greater than or equal to 100 μm to less than or equal to 175 μm, greater than or equal to 125 μm to less than or equal to 175 μm, greater than or equal to 150 μm to less than or equal to 175 μm, from greater than or equal to 50 μm to less than or equal to 150 μm, greater than or equal to 75 μm to less than or equal to 150 μm, greater than or equal to 100 μm to less than or equal to 150 μm, greater than or equal to 125 μm to less than or equal to 150 μm, from greater than or equal to 50 μm to less than or equal to 125 μm, greater than or equal to 75 μm to less than or equal to 125 μm, greater than or equal to 100 μm to less than or equal to 125 μm, from greater than or equal to 50 μm to less than or equal to 100 μm, greater than or equal to 75 μm to less than or equal to 100 μm, from greater than or equal to 50 μm to less than or equal to 75 μm, including any and all subranges within the forgoing ranges.

Scratch testing using a conospherical tip at a load of 5 N and a speed of 5 mm/min and at a load of 1 N and a speed of 5 mm/min were also conducted. The width of scratches on glass-based articles were then measured to determine the scratch resistance. According to embodiments, glass-based articles had a scratch width using a conospherical tip of less than 250 μm at a 1 N load, such as a scratch width of less than or equal to 225 μm, a scratch width of less than or equal to 200 μm, a scratch width of less than or equal to 175 μm, a scratch width of less than or equal to 150 μm, or a scratch width of less than or equal to 100 μm. According to embodiments, the glass-based articles had a scratch width using a conospherical tip from greater than or equal to 50 μm to less than or equal to 225 μm, such as from greater than or equal to 75 μm to less than or equal to 225 μm, from greater than or equal to 100 μm to less than or equal to 225 μm, from greater than or equal to 125 μm to less than or equal to 225 μm, from greater than or equal to 150 μm to less than or equal to 225 μm, from greater than or equal to 175 μm to less than or equal to 225 μm, from greater than or equal to 200 μm to less than or equal to 225 μm, from greater than or equal to 50 μm to less than or equal to 200 μm, from greater than or equal to 75 μm to less than or equal to 200 μm, from greater than or equal to 100 μm to less than or equal to 200 μm, from greater than or equal to 125 μm to less than or equal to 200 μm, from greater than or equal to 150 μm to less than or equal to 200 μm, from greater than or equal to 175 μm to less than or equal to 200 μm, from greater than or equal to 50 μm to less than or equal to 175 μm, from greater than or equal to 75 μm to less than or equal to 175 μm, from greater than or equal to 100 μm to less than or equal to 175 μm, from greater than or equal to 125 μm to less than or equal to 175 μm, from greater than or equal to 150 μm to less than or equal to 175 μm, from greater than or equal to 50 μm to less than or equal to 150 μm, from greater than or equal to 75 μm to less than or equal to 150 μm, from greater than or equal to 100 μm to less than or equal to 150 μm, from greater than or equal to 125 μm to less than or equal to 150 μm, from greater than or equal to 50 μm to less than or equal to 125 μm, from greater than or equal to 75 μm to less than or equal to 125 μm, from greater than or equal to 100 μm to less than or equal to 125 μm, from greater than or equal to 50 μm to less than or equal to 100 μm, from greater than or equal to 75 μm to less than or equal to 100 μm, from greater than or equal to 50 μm to less than or equal to 75 μm, including any and all subranges within these ranges.

In embodiments, the K_{1C} fracture toughness of the glass-based article measured by a chevron notch short bar method may be greater than or equal to 1.0 MPa*m^{1/2}, greater than or equal to 1.2 MPa*m^{1/2}, greater than or equal to 1.5 MPa*m^{1/2}, greater than or equal to 1.8 MPa*m^{1/2}, greater than or equal to 2.0 MPa*m^{1/2}, greater than or equal to 2.2 MPa*m^{1/2}, greater than or equal to 2.5 MPa*m^{1/2}, greater than or equal to 2.8 MPa*m^{1/2,} or greater than or equal to 3.0 MPa*m^{1/2} . In embodiments, the K_{1C} fracture toughness of the glass composition as measured by a chevron notch short bar method may be in the range of from greater than or equal to 1.0 MPa*m^{1/2} to less than or equal to 3.0 MPa*m^{1/2}, greater than or equal to 1.2 MPa*m^{1/2} to less than or equal to 3.0 MPa*m^{1/2} , greater than or equal to 1.5 MPa*m^{1/2} to less than or equal to 3.0 MPa*m^{1/2} , greater than or equal to 1.8 MPa*m^{1/2} to less than or equal to 3.0 MPa*m^{1/2}, greater than or equal to 2.0 MPa*m^{1/2} to less than or equal to 3.0 MPa*m^{1/2}, greater than or equal to 2.2 MPa*m^{1/2} to less than or equal to 3.0 MPa*m^{1/2}, greater than or equal to 2.5 MPa*m^{1/2} to less than or equal to 3.0 MPa*m^{1/2}, greater than or equal to 2.8 MPa*m^{1/2} to less than or equal to 3.0 MPa*m^{1/2,} from greater than or equal to 1.0 MPa*m^{1/2 to} less than or equal to 2.8 MPa*m^{1/2}, greater than or equal to 1.2 MPa*m^{1/2} to less than or equal to 2.8 MPa*m^{1/2}, greater than or equal to 1.5 MPa*m^{1/2} to less than or equal to 2.8 MPa*m^{1/2}, greater than or equal to 1.8 MPa*m^{1/2} to less than or equal to 2.8 MPa*m^{1/2}, greater than or equal to 2.0 MPa*m^{1/2} to less than or equal to 2.8 MPa*m^{1/2}, greater than or equal to 2.2 MPa*m^{1/2} to less than or equal to 2.8 MPa*m^{1/2} , greater than or equal to 2.5 MPa*m^{1/2} to less than or equal to 2.8 MPa*m^{1/2}, from greater than or equal to 1.0 MPa*m^{1/2} to less than or equal to 2.5 MPa*m^{1/2}, greater than or equal to 1.2 MPa*m^{1/2} to less than or equal to 2.5 MPa*m^{1/2}, greater than or equal to 1.5 MPa*m^{1/2} to less than or equal to 2.5 MPa*m^{1/2}, greater than or equal to 1.8 MPa*m^{1/2} to less than or equal to 2.5 MPa*m^{1/2}, greater than or equal to 2.0 MPa*m^{1/2} to less than or equal to 2.5 MPa*m^{1/2}, greater than or equal to 2.2 MPa*m^{1/2} to less than or equal to 2.5 MPa*m^{1/2}, from greater than or equal to 1.0 MPa*m^{1/2} to less than or equal to 2.2 MPa*m^{1/2}, greater than or equal to 1.2 MPa*m^{1/2} to less than or equal to 2.2 MPa*m^{1/2}, greater than or equal to 1.5 MPa*m^{1/2} to less than or equal to 2.2 MPa*m^{1/2}, greater than or equal to 1.8 MPa*m^{1/2} to less than or equal to 2.2 MPa*m^{1/2}, greater than or equal to 2.0 MPa*m^{1/2} to less than or equal to 2.2 MPa*m^{1/2}, from greater than or equal to 1.0 MPa*m^{1/2} to less than or equal to 2.0 MPa*m^{1/2}, greater than or equal to 1.2 MPa*m^{1/2} to less than or equal to 2.0 MPa*m^{1/2}, greater than or equal to 1.5 MPa*m^{1/2} to less than or equal to 2.0 MPa*m^{1/2}, greater than or equal to 1.8 MPa*m^{1/2} to less than or equal to 2.0 MPa*m^{1/2}, from greater than or equal to 1.0 MPa*m^{1/2} to less than or equal to 1.8 MPa*m^{1/2}, greater than or equal to 1.2 MPa*m^{1/2} to less than or equal to 1.8 MPa*m^{1/2} , greater than or equal to 1.5 MPa*m^{1/2} to less than or equal to 1.8 MPa*m^{1/2}, from greater than or equal to 1.0 MPa*m^{1/2} to less than or equal to 1.5 MPa*m^{1/2}, greater than or equal to 1.2 MPa*m^{1/2} to less than or equal to 1.5 MPa*m^{1/2}, from greater than or equal to 1.0 MPa*m^{1/2} to less than or equal to 1.2 MPa*m^{1/2}. It should be understood that the fracture toughness may be within a sub-range formed from any and all of the foregoing endpoints.

The Young's modulus of glass-based articles according to embodiments measured by Resonant Ultrasonic Measurement on 6×8×10 mm sample is from greater than or equal to 100 GPa to less than or equal to 110 GPa, such as from greater than or equal to 102 GPa to less than or equal to 110 GPa, from greater than or equal to 104 GPa to less than or equal to 110 GPa, from greater than or equal to 106 GPa to less than or equal to 110 GPa, from greater than or equal to 108 GPa to less than or equal to 110 GPa, from greater than or equal to 100 GPa to less than or equal to 108 GPa, from greater than or equal to 102 GPa to less than or equal to 108 GPa, from greater than or equal to 104 GPa to less than or equal to 108 GPa, from greater than or equal to 106 GPa to less than or equal to 108 GPa, from greater than or equal to 100 GPa to less than or equal to 106 GPa, from greater than or equal to 102 GPa to less than or equal to 106 GPa, from greater than or equal to 104 GPa to less than or equal to 106 GPa, from greater than or equal to 100 GPa to less than or equal to 104 GPa, from greater than or equal to 102 GPa to less than or equal to 104 GPa, from greater than or equal to 100 GPa to less than or equal to 102 GPa, including any and all subranges within the above ranges.

The Poisson's ratio of glass-based articles according to embodiments measured by Resonant Ultrasonic Measurement on 6×8×10 mm sample is from greater than or equal to 0.10 to less than or equal to 0.20, such as from greater than or equal to 0.12 to less than or equal to 0.20, from greater than or equal to 0.14 to less than or equal to 0.20, from greater than or equal to 0.16 to less than or equal to 0.20, from greater than or equal to 0.18 to less than or equal to 0.20, from greater than or equal to 0.10 to less than or equal to 0.18, from greater than or equal to 0.12 to less than or equal to 0.18, from greater than or equal to 0.14 to less than or equal to 0.18, from greater than or equal to 0.16 to less than or equal to 0.18, from greater than or equal to 0.10 to less than or equal to 0.16, from greater than or equal to 0.12 to less than or equal to 0.16, from greater than or equal to 0.14 to less than or equal to 0.16, from greater than or equal to 0.10 to less than or equal to 0.14, from greater than or equal to 0.12 to less than or equal to 0.14, from greater than or equal to 0.10 to less than or equal to 0.12, including any and all subranges within the above ranges.

The shear modulus of glass-based articles according to embodiments measured by Resonant Ultrasonic Measurement on 6×8×10 mm sample is from greater than or equal to 35 GPa to less than or equal to 50 GPa, such as from greater than or equal to 38 GPa to less than or equal to 50 GPa, from greater than or equal to 40 GPa to less than or equal to 50 GPa, from greater than or equal to 42 GPa to less than or equal to 50 GPa, from greater than or equal to 45 GPa to less than or equal to 50 GPa, from greater than or equal to 48 GPa to less than or equal to 50 GPa, from greater than or equal to 35 GPa to less than or equal to 48 GPa, from greater than or equal to 38 GPa to less than or equal to 48 GPa, from greater than or equal to 40 GPa to less than or equal to 48 GPa, from greater than or equal to 42 GPa to less than or equal to 48 GPa, from greater than or equal to 45 GPa to less than or equal to 48 GPa, from greater than or equal to 35 GPa to less than or equal to 45 GPa, from greater than or equal to 38 GPa to less than or equal to 45 GPa, from greater than or equal to 40 GPa to less than or equal to 45 GPa, from greater than or equal to 42 GPa to less than or equal to 45 GPa, from greater than or equal to 35 GPa to less than or equal to 42 GPa, from greater than or equal to 38 GPa to less than or equal to 42 GPa, from greater than or equal to 40 GPa to less than or equal to 42 GPa, from greater than or equal to 35 GPa to less than or equal to 40 GPa, from greater than or equal to 38 GPa to less than or equal to 40 GPa, from greater than or equal to 35 GPa to less than or equal to 38 GPa, including any and all subranges within the above ranges.

Glass-based articles according to embodiments have a Vickers hardness on non-ion exchanged articles measured according to C1327 Standard for Vickers Indenter for Advanced Ceramics of greater than or equal to 750 kg_{f}/mm² to less than or equal to 840 kg_{f}/mm², such as greater than or equal to 770 kg_{f}/mm² to less than or equal to 840 kg_{f}/mm², greater than or equal to 790 kg_{f}/mm² to less than or equal to 840 kg_{f}/mm², greater than or equal to 800 kg_{f}/mm² to less than or equal to 840 kg_{f}/mm², greater than or equal to 820 kg_{f}/mm² to less than or equal to 840 kg_{f}/mm², greater than or equal to 750 kg_{f}/mm² to less than or equal to 820 kg_{f}/mm², greater than or equal to 770 kg_{f}/mm² to less than or equal to 820 kg_{f}/mm², greater than or equal to 790 kg_{f}/mm² to less than or equal to 820 kg_{f}/mm², greater than or equal to 800 kg_{f}/mm² to less than or equal to 820 kg_{f}/mm², greater than or equal to 750 kg_{f}/mm² to less than or equal to 800 kg_{f}/mm², greater than or equal to 770 kg_{f}/mm² to less than or equal to 800 kg_{f}/mm², greater than or equal to 790 kg_{f}/mm² to less than or equal to 800 kg_{f}/mm², greater than or equal to 750 kg_{f}/mm² to less than or equal to 790 kg_{f}/mm², greater than or equal to 770 kg_{f}/mm² to less than or equal to 790 kg_{f}/mm², greater than or equal to 750 kg_{f}/mm² to less than or equal to 770 kg_{f}/mm², including any and all subranges within the above ranges.

Glass-based articles according to embodiments have a Vickers hardness on ion exchanged articles measured according to C1327 Standard for Vickers Indenter for Advanced Ceramics of greater than or equal to 770 kg_{f}/mm² to less than or equal to 860 kg_{f}/mm², such as greater than or equal to 790 kg_{f}/mm² to less than or equal to 860 kg_{f}/mm², greater than or equal to 800 kg_{f}/mm² to less than or equal to 860 kg_{f}/mm², greater than or equal to 820 kg_{f}/mm² to less than or equal to 860 kg_{f}/mm², greater than or equal to 840 kg_{f}/mm² to less than or equal to 860 kg_{f}/mm², greater than or equal to 770 kg_{f}/mm² to less than or equal to 840 kg_{f}/mm², greater than or equal to 790 kg_{f}/mm² to less than or equal to 840 kg_{f}/mm², greater than or equal to 800 kg_{f}/mm² to less than or equal to 840 kg_{f}/mm², greater than or equal to 820 kg_{f}/mm² to less than or equal to 840 kg_{f}/mm², greater than or equal to 770 kg_{f}/mm² to less than or equal to 820 kg_{f}/mm², greater than or equal to 790 kg_{f}/mm² to less than or equal to 820 kg_{f}/mm², greater than or equal to 800 kg_{f}/mm² to less than or equal to 820 kg_{f}/mm², greater than or equal to 770 kg_{f}/mm² to less than or equal to 800 kg_{f}/mm², greater than or equal to 790 kg_{f}/mm² to less than or equal to 800 kg_{f}/mm², greater than or equal to 770 kg_{f}/mm² to less than or equal to 790 kg_{f}/mm², including any and all subranges within the above ranges.

According to embodiments, glass-based articles have a volume resistivity (Ω-cm log ρ (150° C.)) measured according to ASTM-D257 Impedance Method from greater than or equal to 6.8 log(Ω-cm) to less than or equal to 8.3 log(Ω-cm), such as from greater than or equal to 7.0 log(Ω-cm) to less than or equal to 8.3 log(Ω-cm), from greater than or equal to 7.2 log(Ω-cm) to less than or equal to 8.3 log(Ω-cm), from greater than or equal to 7.4 log(Ω-cm) to less than or equal to 8.3 log(Ω-cm), from greater than or equal to 7.6 log(Ω-cm) to less than or equal to 8.3 log(Ω-cm), from greater than or equal to 7.8 log(Ω-cm) to less than or equal to 8.3 log(Ω-cm), from greater than or equal to 8.0 log(Ω-cm) to less than or equal to 8.3 log(Ω-cm), from greater than or equal to 8.2 log(Ω-cm) to less than or equal to 8.3 log(Ω-cm), from greater than or equal to 6.8 log(Ω-cm) to less than or equal to 8.2 log(Ω-cm), from greater than or equal to 7.0 log(Ω-cm) to less than or equal to 8.2 log(Ω-cm), from greater than or equal to 7.2 log(Ω-cm) to less than or equal to 8.2 log(Ω-cm), from greater than or equal to 7.4 log(Ω-cm) to less than or equal to 8.2 log(Ω-cm), from greater than or equal to 7.6 log(Ω-cm) to less than or equal to 8.2 log(Ω-cm), from greater than or equal to 7.8 log(Ω-cm) to less than or equal to 8.2 log(Ω-cm), from greater than or equal to 8.0 log(Ω-cm) to less than or equal to 8.2 log(Ω-cm), from greater than or equal to 6.8 log(Ω-cm) to less than or equal to 8.0 log(Ω-cm), from greater than or equal to 7.0 log(Ω-cm) to less than or equal to 8.0 log(Ω-cm), from greater than or equal to 7.2 log(Ω-cm) to less than or equal to 8.0 log(Ω-cm), from greater than or equal to 7.4 log(Ω-cm) to less than or equal to 8.0 log(Ω-cm), from greater than or equal to 7.6 log(Ω-cm) to less than or equal to 8.0 log(Ω-cm), from greater than or equal to 7.8 log(Ω-cm) to less than or equal to 8.0 log(Ω-cm), from greater than or equal to 6.8 log(Ω-cm) to less than or equal to 7.8 log(Ω-cm), from greater than or equal to 7.0 log(Ω-cm) to less than or equal to 7.8 log(Ω-cm), from greater than or equal to 7.2 log(Ω-cm) to less than or equal to 7.8 log(Ω-cm), from greater than or equal to 7.4 log(Ω-cm) to less than or equal to 7.8 log(Ω-cm), from greater than or equal to 7.6 log(Ω-cm) to less than or equal to 7.8 log(Ω-cm), from greater than or equal to 6.8 log(Ω-cm) to less than or equal to 7.6 log(Ω-cm), from greater than or equal to 7.0 log(Ω-cm) to less than or equal to 7.6 log(Ω-cm), from greater than or equal to 7.2 log(Ω-cm) to less than or equal to 7.6 log(Ω-cm), from greater than or equal to 7.4 log(Ω-cm) to less than or equal to 7.6 log(Ω-cm), from greater than or equal to 6.8 log(Ω-cm) to less than or equal to 7.4 log(Ω-cm), from greater than or equal to 7.0 log(Ω-cm) to less than or equal to 7.4 log(Ω-cm), from greater than or equal to 7.2 log(Ω-cm) to less than or equal to 7.4 log(Ω-cm), from greater than or equal to 6.8 log(Ω-cm) to less than or equal to 7.2 log(Ω-cm), from greater than or equal to 7.0 log(Ω-cm) to less than or equal to 7.2 log(Ω-cm), from greater than or equal to 6.8 log(Ω-cm) to less than or equal to 7.0 log(Ω-cm), including any and all subranges within the above ranges.

According to one or more embodiments, glass-based articles have dielectric properties and loss tangent at various frequencies as shown in the tables below.

TABLE 4

| | Dielectric | Loss |
|---|---|---|
| | constant | tangent |
| | (+/−5%) | (+/−0.01) |
| Frequency (Hz) | | |
| 1000 | 5.97 | 0.037 |
| 5000 | 5.81 | 0.023 |
| 10000 | 5.76 | 0.019 |
| 50000 | 5.66 | 0.013 |
| 100000 | 5.65 | 0.010 |
| 500000 | 5.61 | 0.008 |
| 1000000 | 5.59 | 0.008 |
| Frequency (MHz) | | |
| 54 | 5.49 | 0.019 |
| 163 | 5.48 | 0.021 |
| 272 | 5.48 | 0.023 |
| 381 | 5.48 | 0.024 |
| 490 | 5.47 | 0.025 |
| 599 | 5.47 | 0.024 |
| 397.2 | 5.58 | 0.006 |
| 911.6 | 5.58 | 0.004 |
| 1499 | 5.57 | 0.005 |
| 1977 | 5.57 | 0.005 |
| 2466 | 5.56 | 0.005 |
| 2986 | 5.56 | 0.005 |

The glass-ceramic articles described herein may be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, watches and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (e.g., smartphones, tablet computers, watches, personal computers, ultrabooks, televisions, and cameras), an architectural glass, and/or an automotive glass may comprise a glass-article article as described herein.

For example, the glass-ceramic article may be incorporated into a consumer electronic device including a housing having front, back, and side surfaces; electrical components (not shown) that are at least partially inside or entirely within the housing and including at least a controller, a memory, and a display at or adjacent to the front surface of the housing; and a cover substrate at or over the front surface of the housing such that it is over the display. In embodiments, at least one of the cover substrate and a portion of housing may include any of the glass-ceramic articles disclosed herein.

### EXAMPLES

The embodiments described herein will be further clarified by the following examples.

### Example 1

Surface Roughness

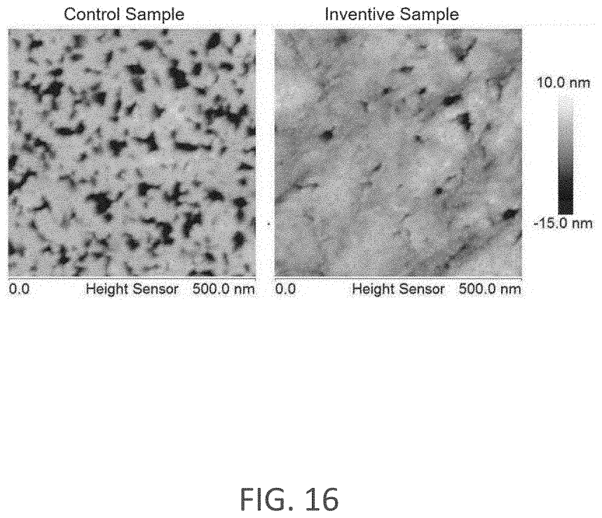

Two glass-ceramic substrates having the composition of Example 1 (Table 2) were prepared and ion exchanged under the same conditions. Following the ion exchange process, the control sample was polished with a conventional, ceria-based polishing slurry and the inventive sample was polished with a non-ceria-based slurry. Following polishing, the surface roughness Ra of the control sample and the inventive sample were measured and atomic force microscope (AFM) images of each surface were collected. The AFM images are presented as FIG. 16. It was determined that the control sample had a surface roughness Ra of approximately 3 nm and the inventive sample had a surface roughness Ra of 1.5 nm.

Without wishing to be bound by theory, it is believe that the ceria-based polishing results in preferential etching of the crystal grains which, in turn, causes nanometer scale pitting and a corresponding increase in the surface roughness relative to the non-ceria-based polishing.

Surface Roughness/Washing

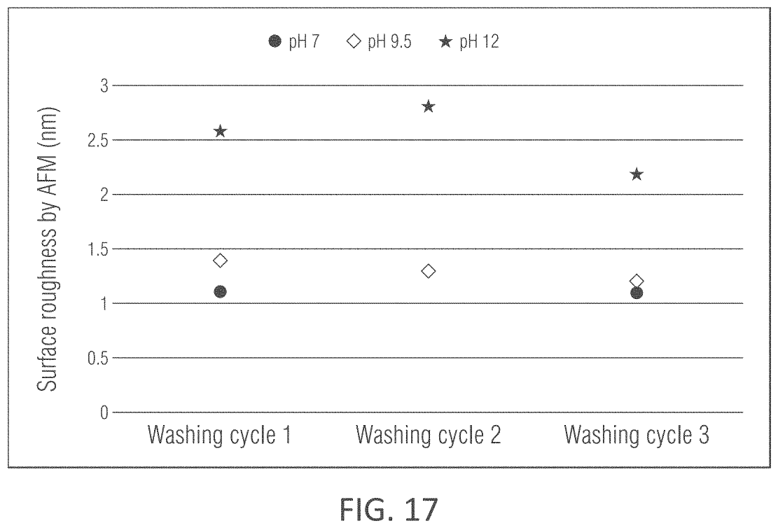

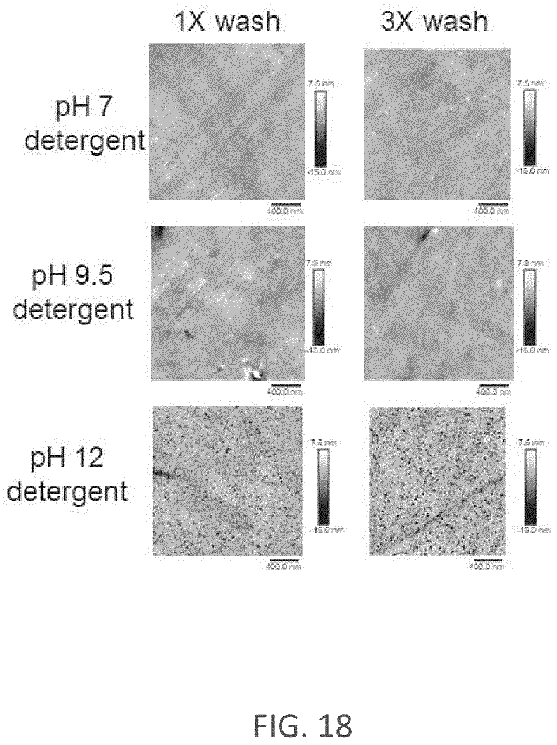

Glass-ceramic substrates having the composition of Example 1 (Table 2) were prepared and ion exchanged under the same conditions. Following the ion exchange process, the samples were polished with the same polishing compound under the same conditions. Following polishing, sets of samples were washed in an ultrasonic wash at 71° C. using different detergents. The detergents had a pH of 7, 9.5, and 12. After washing the surface roughness Ra of each sample was measured and AFM images of the surfaces of the samples were measured. The results are presented in FIGS. 17 and 18.

As show in FIGS. 17 and 18, the samples washed with detergents having lower pH also had a lower surface roughness than those washed with detergents having higher pH. It was determined that detergents with a pH of approximately 9.5 (9.5-10) yielded the cleanest surface while also providing a relatively low surface roughness. In FIG. 18, the top row shows AFM images using a detergent having a pH of 7, the middle row shows AFM images using a detergent having a pH of 9.5, and the bottom row shows AFM images using a detergent having a pH of 12. In FIG. 18, the left column shows AFM for a single wash using the corresponding detergent and the right column shows AFM for a triple wash using the corresponding detergent.

While not wishing to be bound by theory, it is believe that higher pH detergents etch the glass, increasing the surface roughness. As further support of this theory, ion exchanged samples were soaked in an aqueous solution having a pH of 12 for 8 hours at 60° C. Following soaking, the solution was analyzed by ICP-MS and it was determined that the solution had elevated concentrations of Na, Si, and K, indicating that these constituent components of the glass-ceramic had been removed from the surface of the glass ceramic by etching.

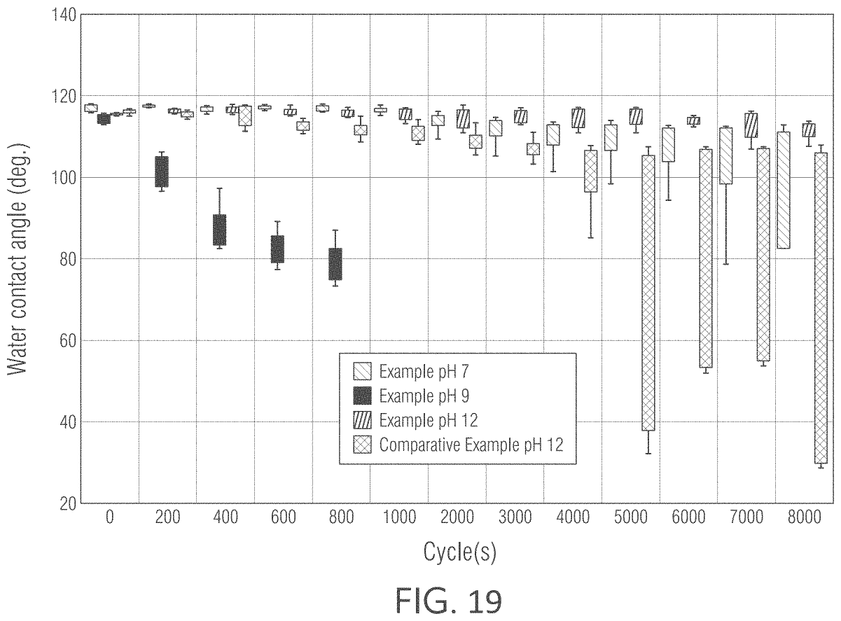

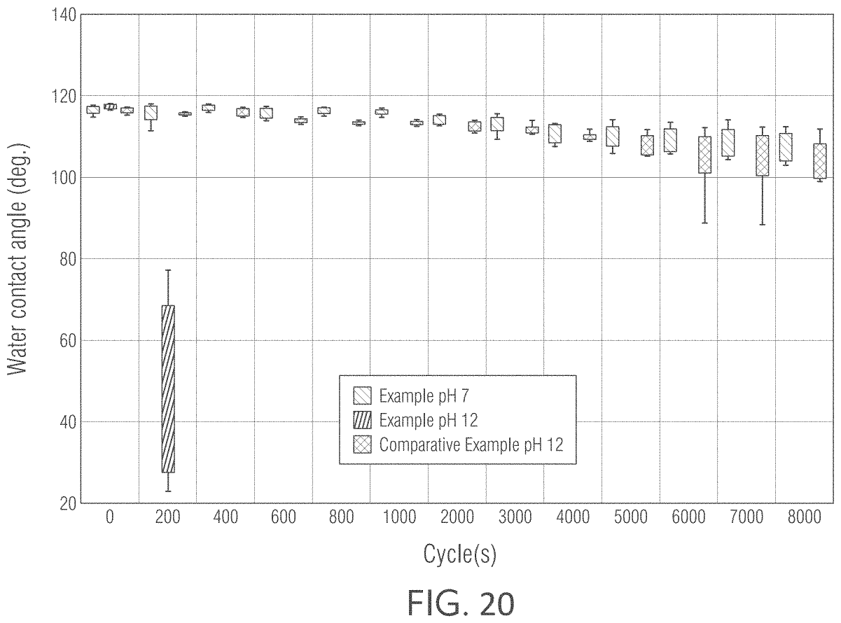

The coating adhesion of the of the glass-ceramic samples was also measured to determine the effects of washing/pH. Samples were prepared as described above with respect to FIGS. 17 and 18. Comparative samples formed from Corning Gorilla Glass® were also prepared and washed in a detergent having a pH of 12. The sampled were then abraded with Bonstar 0000 steel wool under a 1 kg load, 60 cycles/minute, 50 mm track length, 5 measurements on the track. The water contact angle of the samples were measured at various cycle counts. The results are presented in FIGS. 19 and 20 for a single wash cycle (FIGS. 19) and 3 wash cycles (FIG. 20). The results shown in FIG. 19 and FIG. 20 were measured using Bonstar 0000, 1 kg, 60 cycles/min, 50 m track length, and 5 measurements on the track.

As shown in FIGS. 19 and 20, the water contact angle for all samples was generally greater for the lower pH detergents. The water contact angle was also generally greater for the glass-ceramic samples washed in the lower pH detergents compared to the Gorilla Glass® sample.

Stress Profile

Glass-based articles commercially available from Corning Inc. and according to embodiments having various thicknesses as shown in Table 5 below were ion exchanged using a single ion exchange (SIOX) with the parameters as shown in Table 5 below:

TABLE 5

| | Thk | | KNO3 | NaNO3 | LiNO3 | NaNO2 | Silicic acid | Temp | Time | CS | CT | DOC |
|---|---|---|---|---|---|---|---|---|---|---|---|---|
| Recipe | (mm) | Step | (wt %) | (wt %) | (wt %) | (wt %) | (wt %) | (° C). | (hrs) | (MPa) | (MPa) | (um) |
| SIOX 1 | 0.8 | N/A | 60 | 40 | 0.1 | 0.5 | 0.5 | 500 | 8 | 342 | 112 | 181 |
| SIOX | 0.65 | N/A | 60 | 40 | 0.1 | 0.5 | 0.5 | 500 | 7 | 286 | 113 | 150 |
| SIOX | 0.6 | N/A | 60 | 40 | 0.1 | 0.5 | 0.5 | 500 | 6 | 298 | 115 | 137 |
| SIOX | 0.5 | N/A | 60 | 40 | 0.1 | 0.5 | 0.5 | 500 | 5 | 284 | 115 | 104 |

As can be seen in Table 5, the CS for each sample was greater than 280 MPa, the CT for each sample was greater than 110 MPa, and the DOC for each sample was greater than 100 μm.

Glass-based articles commercially available from Corning Inc. and according to embodiments having various thicknesses as shown in Table 6 below were ion exchanged using a single ion exchange (SIOX) or a double ion exchange (DIOX) with the parameters as shown in Table 6 below:

TABLE 6

| | Thk | | KNO3 | NaNO3 | LiNO3 | NaNO2 | Silicic acid | Temp | Time | CS* | CT** | DOC** |
|---|---|---|---|---|---|---|---|---|---|---|---|---|
| Recipe | (mm) | Step | (wt %) | (wt %) | (wt %) | (wt %) | (wt %) | (° C.) | (hrs) | (MPa) | (MPa) | (um) |
| SIOX | 0.5 | N/A | 60 | 40 | 0.1 | 0.5 | 0.5 | 500 | 5 | 284 | 115 | 104 |
| DIOX | 0.5 | 1 | 60 | 40 | 0.1 | 0.5 | 0.5 | 500 | 4 | 330 | 108 | 101 |
| | | 2 | 50 | 50 | 0.1 | 0.5 | 0.5 | 500 | 1 | 345 | 119 | 110 |

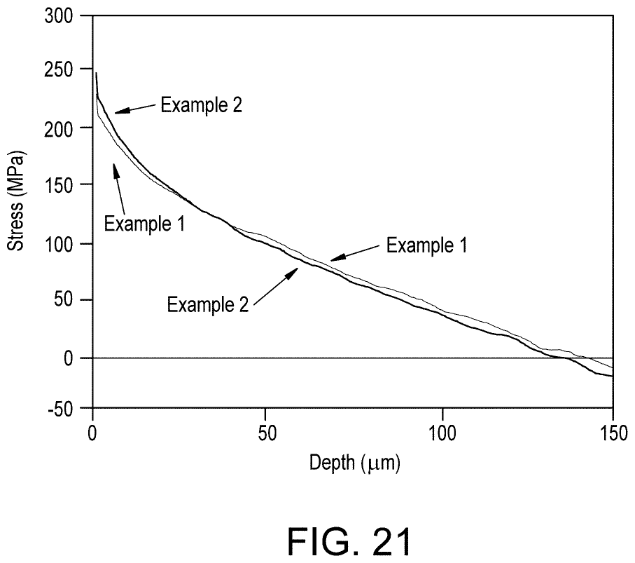

The results from Table 6 are shown graphically in FIG. 21. As can be seen in Table 6, the CS for each sample was greater than 280 MPa, the CT for each sample was greater than 105 MPa, and the DOC for each sample was greater than 100 μm.

Glass-based articles commercially available from Corning Inc. and according to embodiments a thickness of 0.4 mm were ion exchanged according to the parameters in Table 7 below:

TABLE 7

| | Thk | | KNO3 | NaNO3 | LiNO3 | Silicic acid | Temp | Time |
|---|---|---|---|---|---|---|---|---|
| Recipe | (mm) | Step | (wt %) | (wt %) | (wt %) | (wt %) | (° C.) | (hrs) |
| SIOX 1 | 0.4 | N/A | 60 | 40 | 0.1 | 0.5 | 500 | 4 |
| DIOX* | 0.4 | 1 | 60 | 40 | 0.1 | 0.5 | 500 | 3 |
| | | 2 | 50 | 50 | 0.1 | 0.5 | 500 | 1 |

The resulting properties of the above ion exchange processes are shown in Table 8 below:

TABLE 8

| Recipe | CS LSL | CS USL | CT LSL | CT USL | DOC LSL |
|---|---|---|---|---|---|
| Maxwell GC-SIOX | 200 | 350 | 90 | 125 | 60 |
| 0.40 mm \| SIOX | | | | | |
| Maxwell GC-DIOX | 200 | 350 | 90 | 125 | 60 |
| 0.40 mm \| DIOX | | | | | |

Drop Test

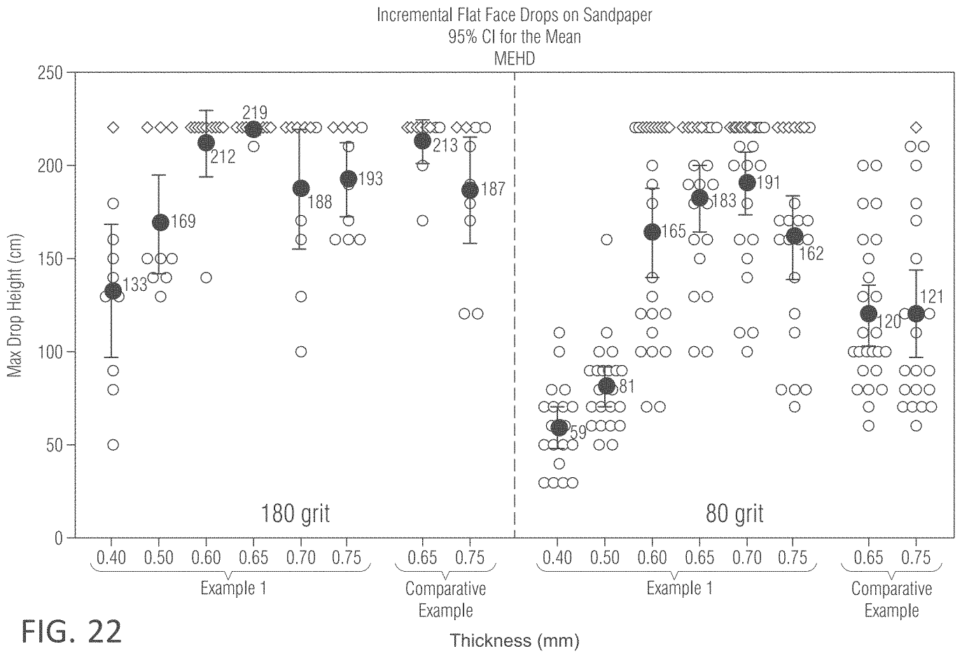

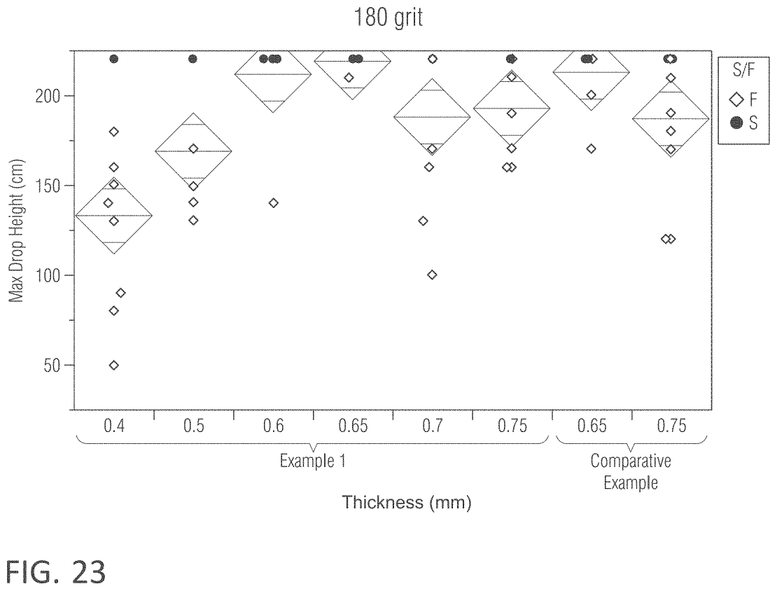

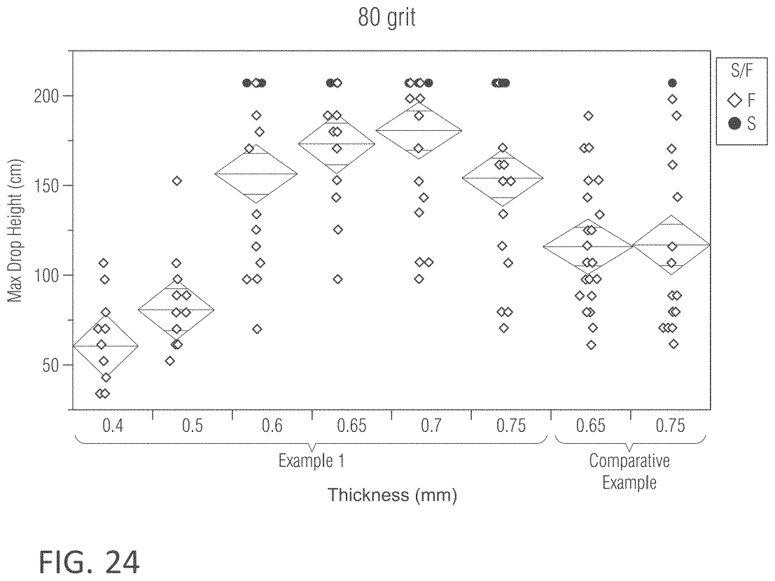

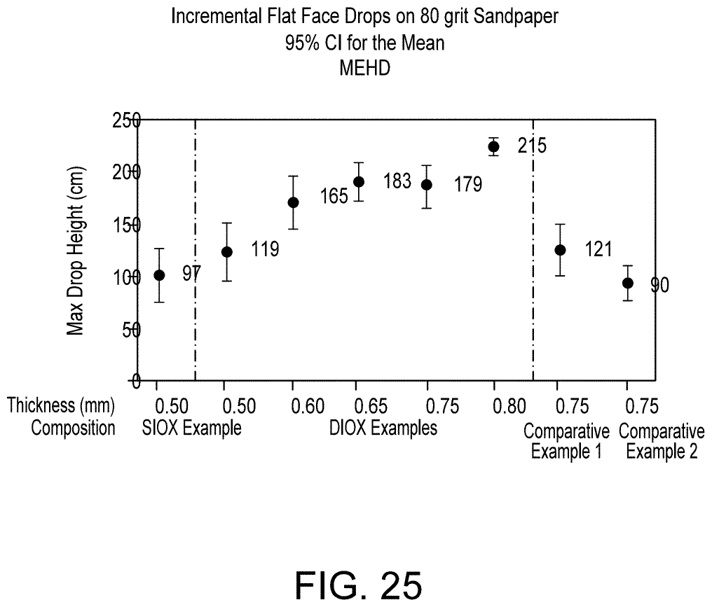

Drop tests as described herein above were performed on glass-based articles commercially available from Corning Inc. and according to embodiments having thicknesses and dropped on 80 grit and 180 grit sandpaper as shown in FIG. 22. The mean values for the drop tests described above are provided in FIG. 23 for 180 grit sandpaper and FIG. 24 for 80 grit sandpaper. FIG. 25 shows the Drop Test on 80 grit sandpaper results for glass-based articles according to embodiments and for comparative glass-based articles after SIOX or DIOX and thicknesses as indicated in FIG. 25.

Scratch Test

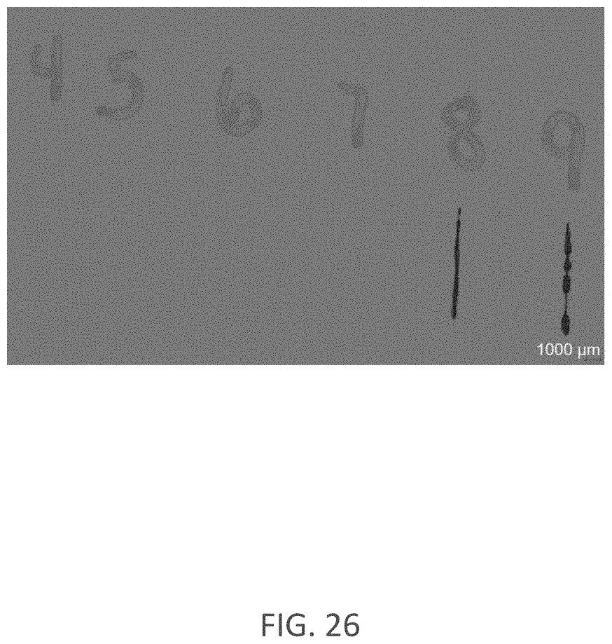

FIG. 26 shows the results of hardness measured on the Mohs scale for 0.8 mm thick glass-based articles.

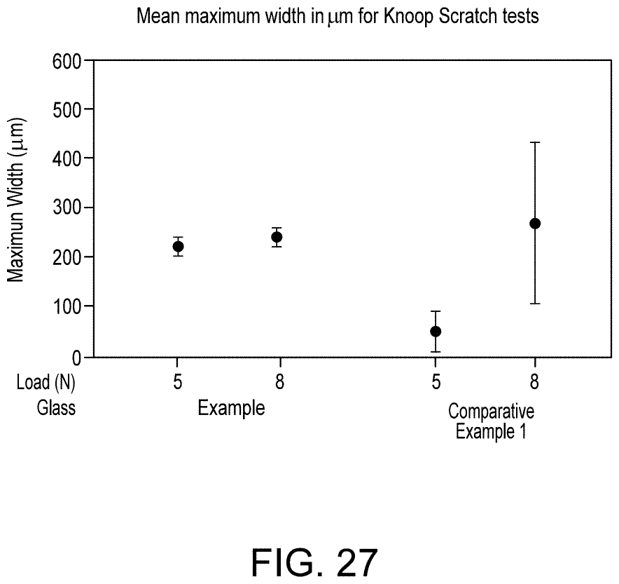

FIG. 27 shows the mean maximum width in μm for Knoop Scratch tests as described above at 5 N and 8 N for glass-based articles according to embodiments and comparative glass-based articles.

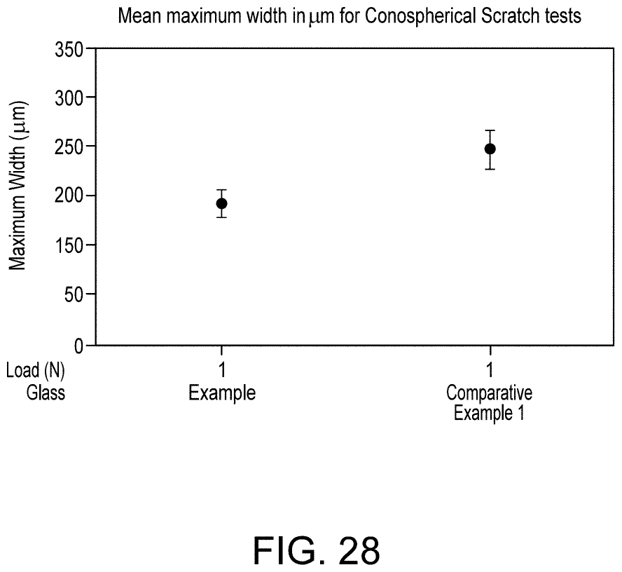

FIG. 28 shows the mean maximum width in μm for Conospherical Scratch tests as described above at 1 N glass-based articles according to embodiments and comparative glass-based articles.

Damp Heat Corrosion Resistance

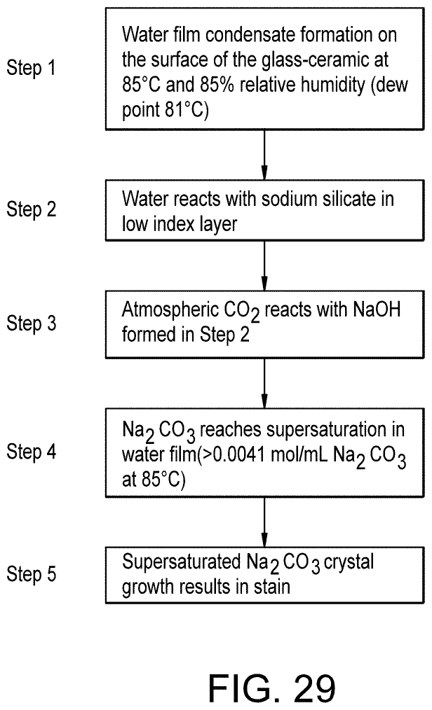

The chemical durability of glass-based articles according to embodiments is shown in FIGS. 29-58. Samples with ion exchanged using 0.05% lithium, 0.065% lithium, 0.07% lithium, and 0.1% lithium in the molten salt bath for ion exchange. SIMS surface profiles were obtained before 500 hours at 85° C. and 85% RH, and show the trend that surface sodium rises as lithium in the salt bath decreases. The results show that below 0.07% lithium there is a risk of corrosion.

FIG. 29 shows a five step process of the corrosion testing according to embodiments. Step 1 begins at the start of the heat soak, step two has a duration of less than 12 hours, step three has a duration of minutes, step four has a duration of less than 24 hours, and step five has a duration that is greater than or equal to 12 hours and less than or equal to 24 hours. The reaction mechanism of step 2 is shown below:

H₂O+≡Si—O⁻Na⁺_{(glass)}↔≡Si—OH_{(glass)}+Na⁺OH⁻

The reaction mechanism of step 3 is shown below:

2NaOH+CO₂↔Na₂CO₃+H₂O

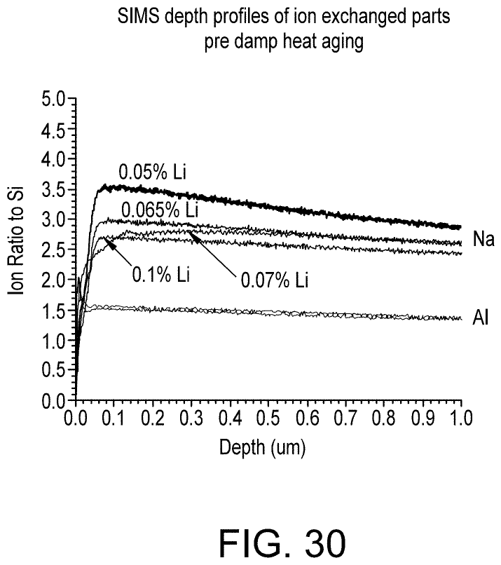

FIG. 30 shows SIMS depth profiles of ion exchanged parts in pre-damp heat aging. FIG. 30 shows that there is a general trend toward higher sodium surface concentrations with lower LiNO₃ bath additions. In FIG. 30, the Al/Si signal is plotted as a reference to show that the reproducibility of the measurement is higher than the observed changes in Na/Si.

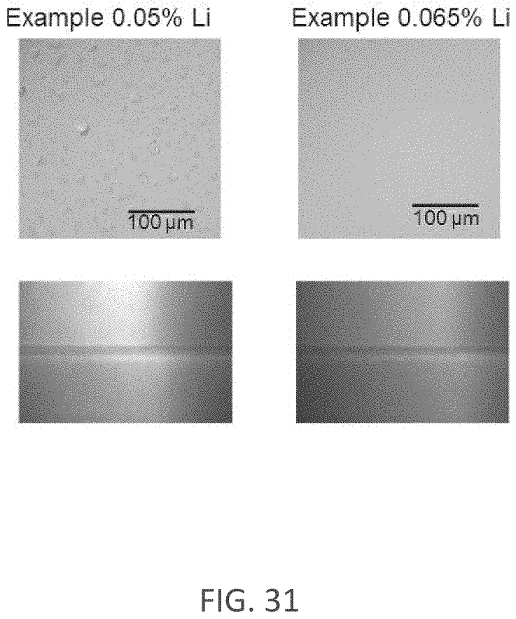

FIG. 31 shows optical micrographs glass-ceramics held for 500 hours at 85° C. and 85% relative humidity after being treated with 0.05% Li and 0.065% Li, from left to right.

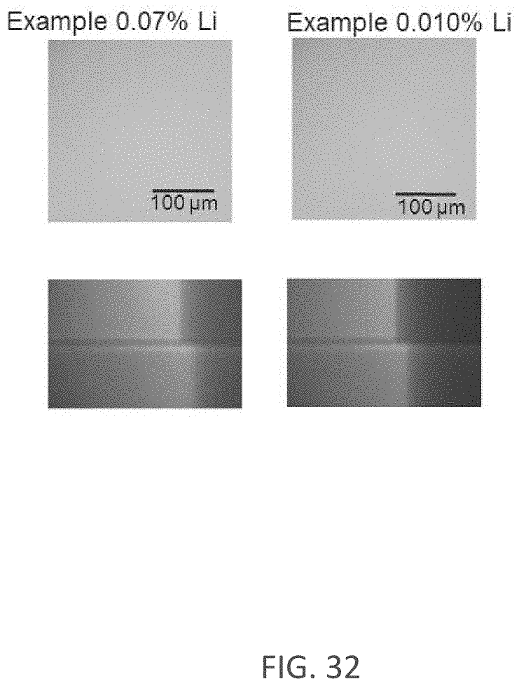

FIG. 32 shows optical micrographs glass-ceramics held for 500 hours at 85° C. and 85% relative humidity after being treated with 0.07% Li and 0.10% Li, from left to right.

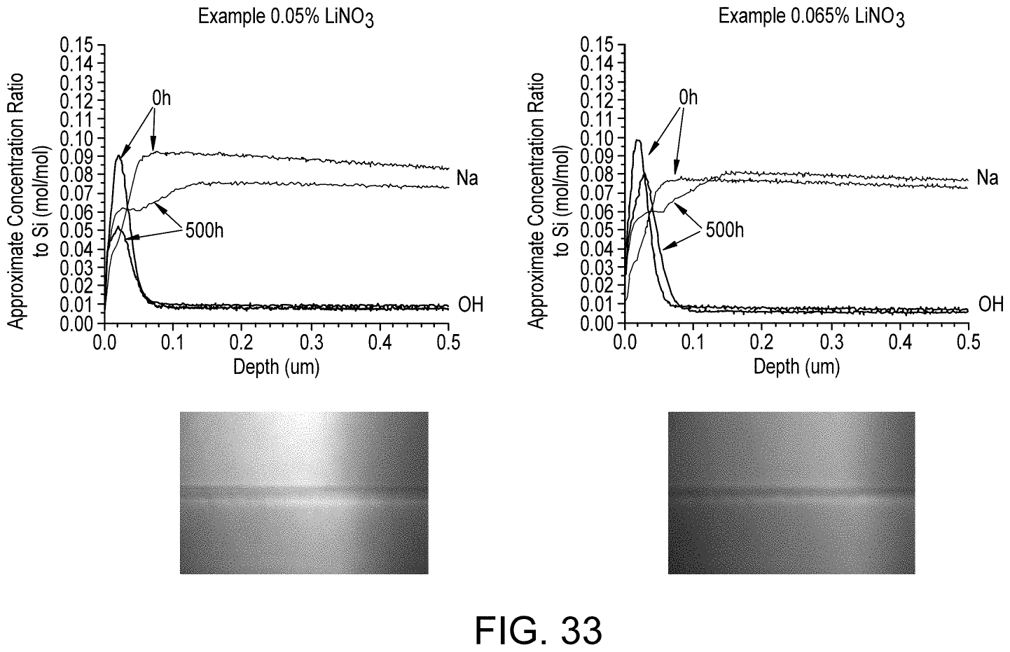

FIG. 33 shows SIMS depth profiles of approximate Na and OH concentrations before and after 500 hours at 85° C. and 85% relative humidity on glass ceramics that were ion exchanged using 0.05% Li and 0.065% Li, from left to right, and corresponding FSM.

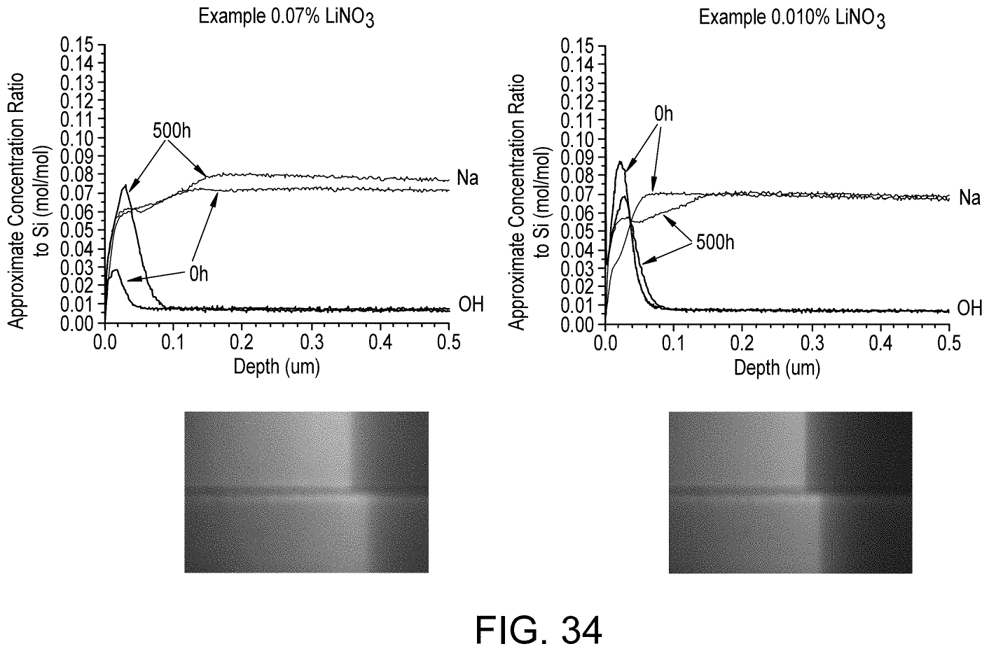

FIG. 34 shows SIMS depth profiles of approximate Na and OH concentrations before and after 500 hours at 85° C. and 85% relative humidity on glass ceramics that were ion exchanged using 0.07% Li and 0.10% Li, from left to right, and corresponding FSM.

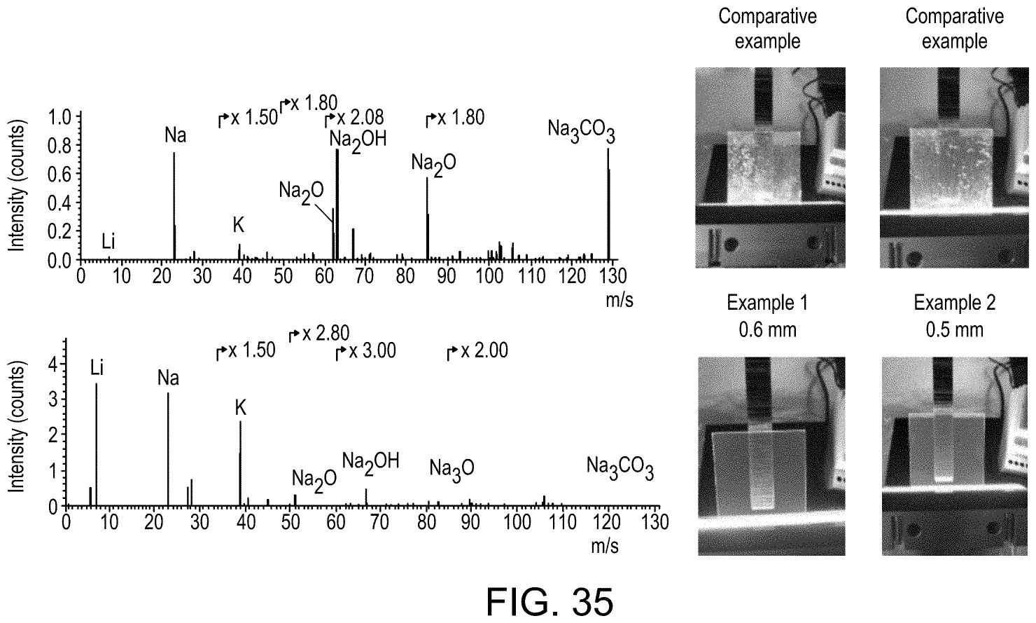

FIG. 35 shows corrosion of glass-ceramics after 500 hours in 85° C. and 85% relative humidity. As shown in FIG. 35, no visible corrosion and no sodium carbonate is detected on the surface of 0.5 mm double ion exchange (DIOX) glass-ceramics and 0.6 mm single ion exchanged (SIOX) glass-ceramics. The top images show that original DIOX has visible corrosion with sodium carbonate and sodium hydroxide ions in the surface SIMS spectrum. The bottom image shows 0.6 mm SIOX and 0.5 mm DIOX (From left to right) do not show visible signs of corrosion, and sodium carbonate species are not detected on the surface after 500 hours at 85° C. and 85% relative humidity.

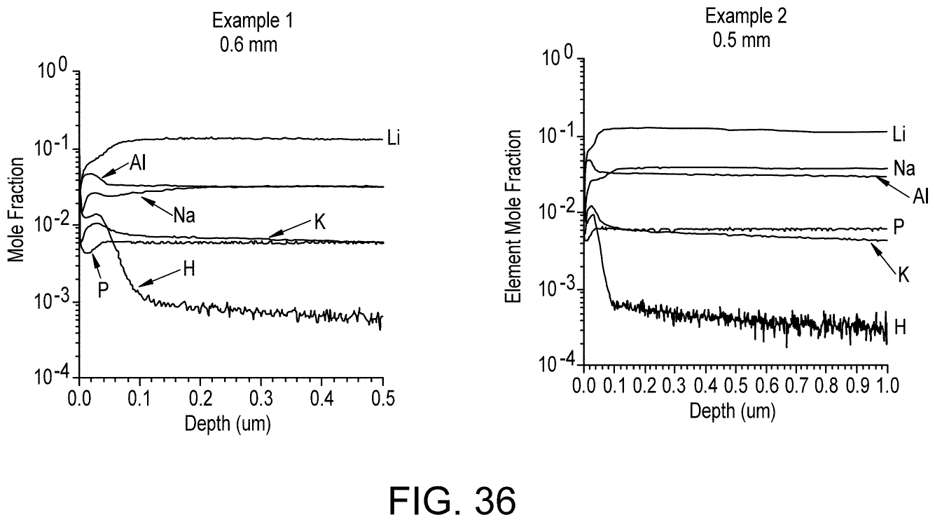

FIG. 36 is SIMS showing depth profiles of 0.6 mm SIOX and 0.5 mm new DIOX with near surface alkali changes limited to less than 0.1 μm after 500 hours in 85° C. and 85% relative humidity.

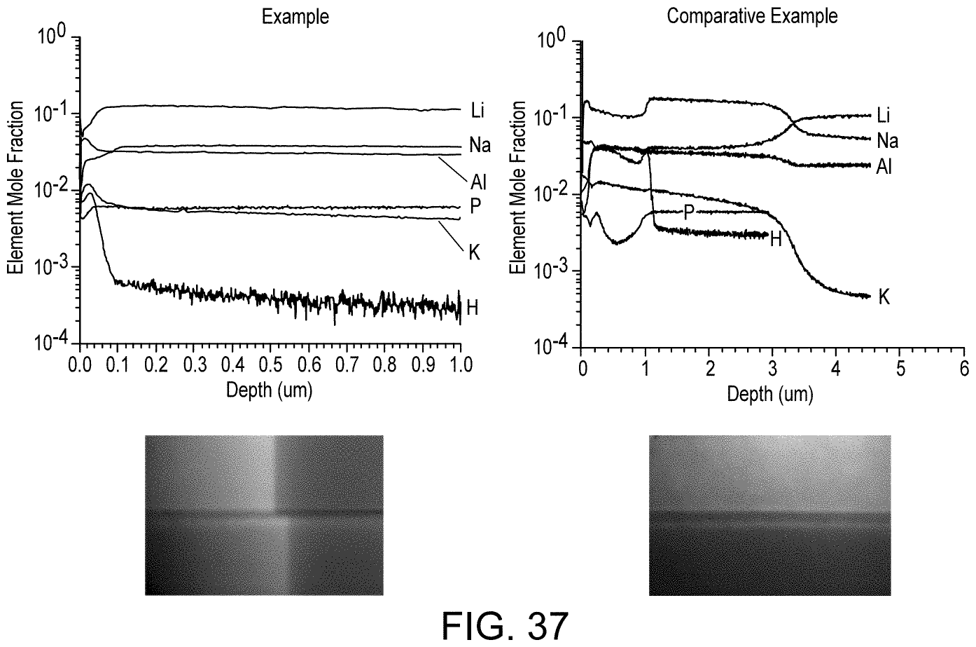

FIG. 37 is SIMS showing depth profiles of 0.5 mm new DIOX that has minimal near surface alkali changes compared to original DIOX after 72 hours in 85° C. and 85% relative humidity. The lower imaged in FIG. 37 are FSM that indicated a good correlation between damp heat performance by a sharp transition without evidence of blurriness caused by low refractive index layers. The new DIOX consists of 4 hours in a bath comprising 60% KNO₃, 40% NaNO₃, and 0.1% LiNO₃ at 500° C. followed by 1 hour in a bath comprising 50% KNO₃, 50% NaNO₃, and 0.1% LiNO₃ at 500° C.

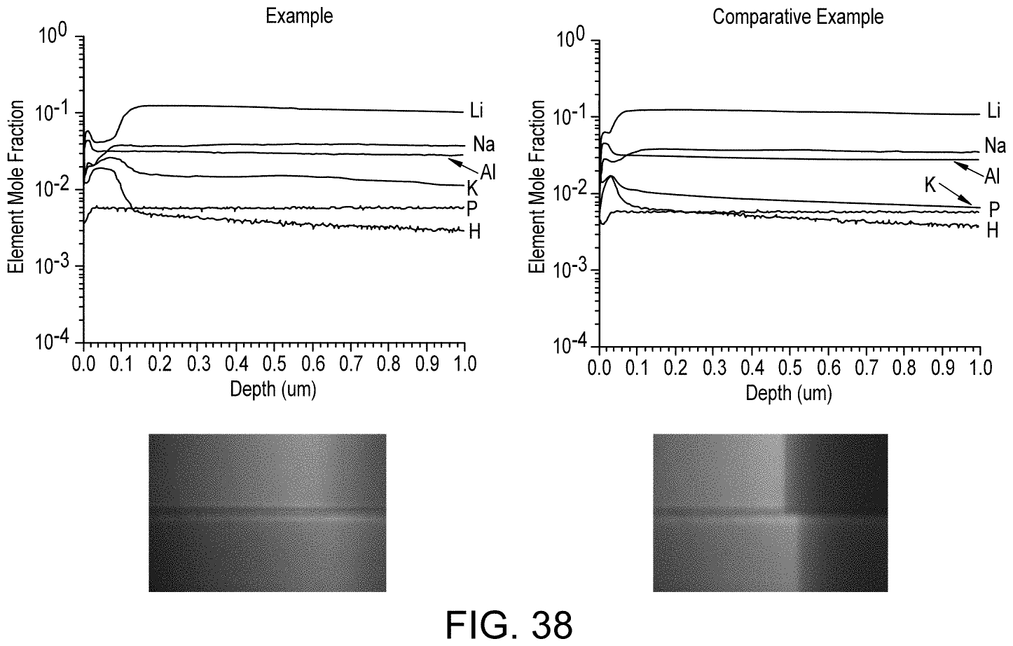

FIG. 38 is SIMS showing depth profiles of 0.5 mm new DIOX compared to 0.8 mm original DIOX that has minimal near surface alkali changes compared to original DIOX after 72 hours in 85° C. and 85% relative humidity. The lower imaged in FIG. 38 are FSM that indicated a good correlation between damp heat performance by a sharp transition without evidence of blurriness caused by low refractive index layers for the new DIOX sample on the left and blurry FSM transition for the original DIOX on the right.

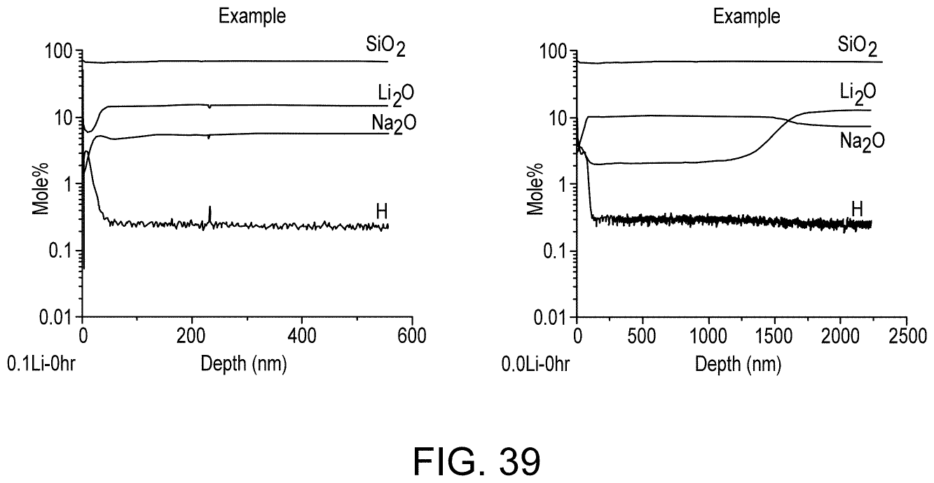

FIG. 39 is SIMS showing depth profiles of 0.8 mm new SIOX without Li on the left compared to 0.8 mm SIOX with Li on the right. The sample without Li has deeper hydration than the sample with Li, which has no evidence of corrosion as indicated by the absence of sodium carbonate and heavy stain. The lower imaged in FIG. 39 are FSM that indicated a good correlation between damp heat performance by a sharp transition without evidence of blurriness caused by low refractive index layers for the sample containing Li on the right and blurry FSM transition for the sample without Li on the left.

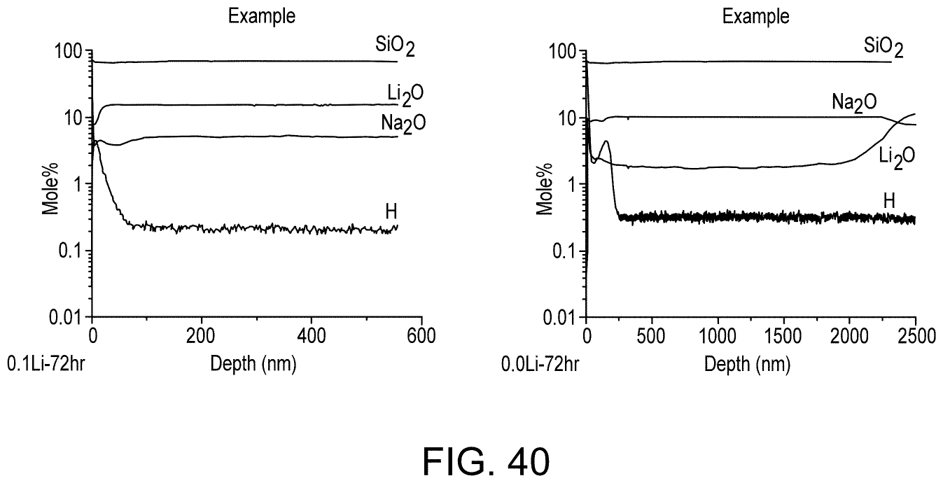

FIG. 40 is SIMS profiles of a sample ion exchanged with 0.1% Li (on the left) and ion exchanged without Li (on the right) analyzed on the corner at 0 hours in 85° C. and 85% relative humidity.

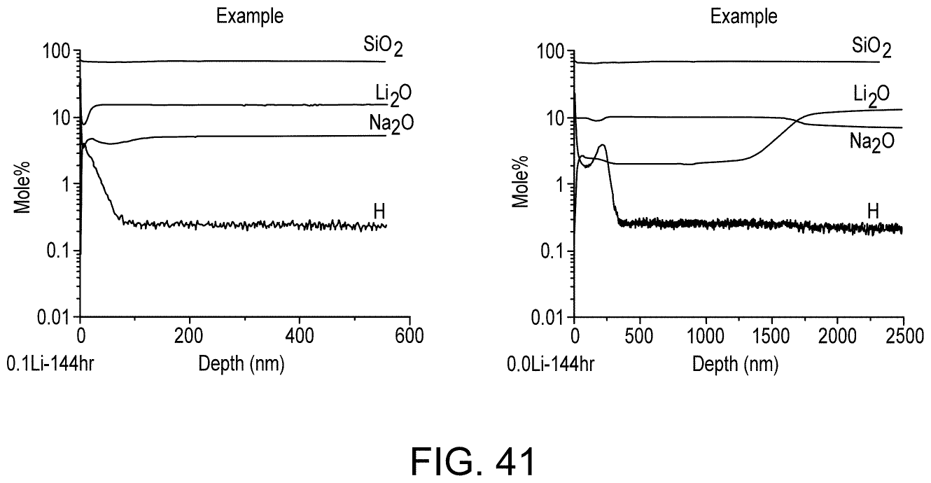

FIG. 41 is SIMS profiles of a sample ion exchanged with 0.1% Li (on the left) and ion exchanged without Li (on the right) analyzed on the corner at 72 hours in 85° C. and 85% relative humidity.

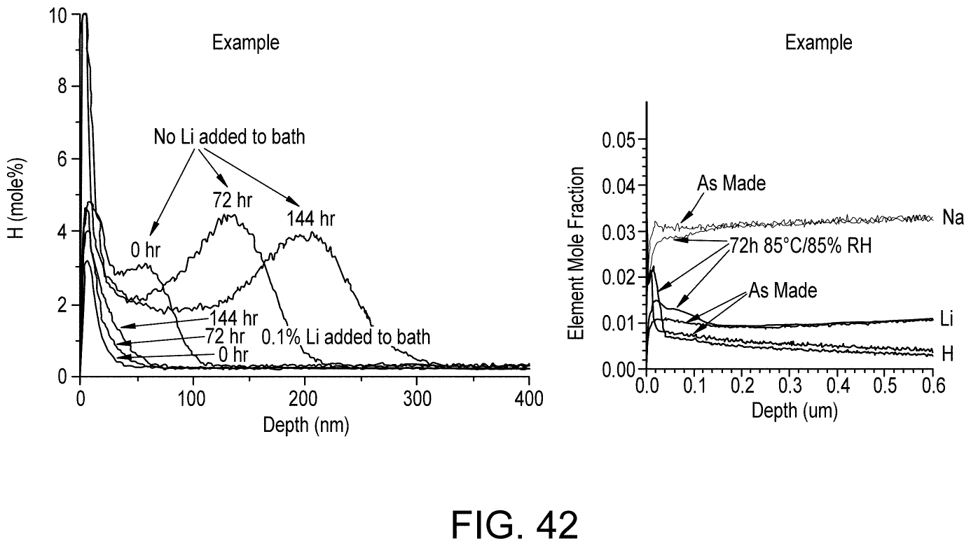

FIG. 42 shows hydrogen (H) diffusion relative to depth for samples that were not ion exchanged with Li and for samples that were ion exchanged with 0.1 wt % Li at 0 hours in 85° C. and 85% relative humidity, at 72 hours in 85° C. and 85% relative humidity, and at 144 hours in 85° C. and 85% relative humidity. As shown in FIG. 42 hydrogen diffusion gets deeper with further exposure to humid environments. Parts that were ion exchanged with no Li are substantially more prone to hydrogen ingress. Low level of hydrogen diffusion was seen in samples where Li was present during ion exchange.

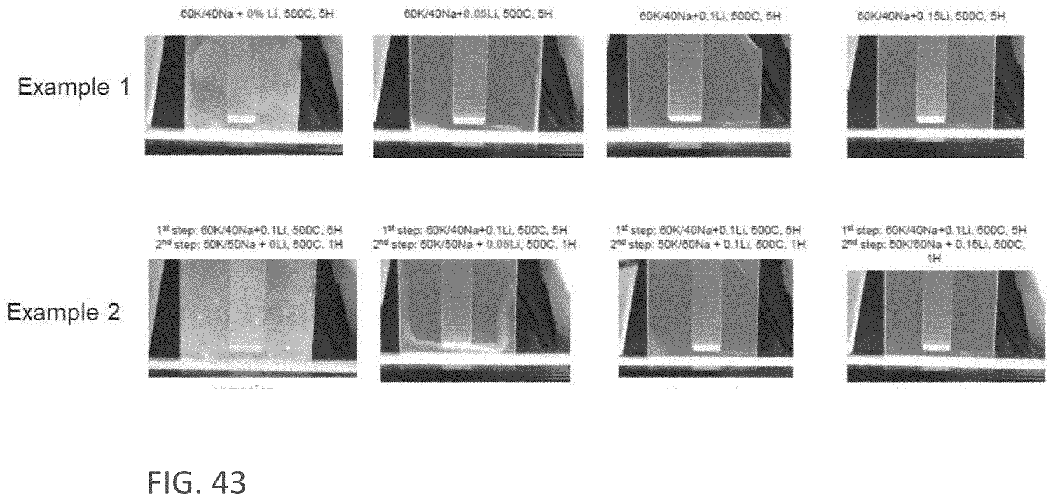

FIG. 43 shows corrosion of glass ceramics after 500 hours in 85° C. and 85% relative humidity. The top set of images show, from left to right, for SIOX at 500° C. for 5 hours with (1) corrosion where no Li is present in the ion exchange, (2) onset of corrosion at the edges where 0.05% Li is present in the ion exchange, (3) no corrosion where 0.1% Li is present in the ion exchange, and (4) no corrosion where 0.15% Li is present in the ion exchange. The lower set of images show corrosion for DIOX where the first ion exchange step for each image consists of 5 hours at 500° C. in a bath of 60% KNO₃, 40% NaNO₃, and 0.1% LiNO₃ the images show, from left to right, (1) corrosion where the second ion exchange step consists of 1 hour at 500° C. in a bath of 50% KNO₃, 50% NaNO₃, and 0% LiNO₃, (2) onset of corrosion at the edges where the second ion exchange step consists of 1 hour at 500° C. in a bath of 50% KNO₃, 50% NaNO₃, and 0.05% LiNO₃, (3) no corrosion where the second ion exchange step consists of 1 hour at 500° C. in a bath of 50% KNO₃, 50% NaNO₃, and 0.1% LiNO₃, and (4) no corrosion where the second ion exchange step consists of 1 hour at 500° C. in a bath of 50% KNO₃, 50% NaNO₃, and 0% LiNO₃.

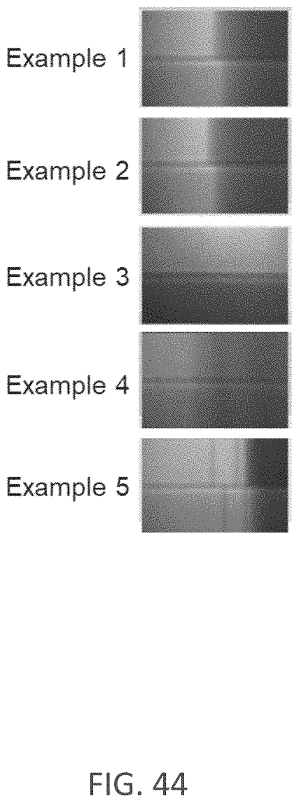

FIG. 44 is FSM images of, from top to bottom, a sample 1 of 0.6 mm SIOX no deco, a sample 2 of 0.75 mm IOX POR deco, a sample 3 of 0.8 mm IOX POR deco, a sample 4 of 0.5 mm DIOX no deco, and a sample 5 of 0.75 mm POR deco treated according to the table below, where the heat soaks were all performed at 85° C. and 85% relative humidity. CE1 is 0.6 mm with no IOX:

TABLE 9

| | Heat Soak | Comp. | Central | |
|---|---|---|---|---|
| Sample | Conditions | Stress | Tension | Notes |
| CE1 | 144 hours | N/A | N/A | No visible stain |
| 1 | 72 hours | 320 | 123 | No visible stain |
| 2 | 72 hours | 284 | 106 | No visible stain |
| 3 | 72 hours | NM | 120 | Heavy stain |
| 4 | 72 hours | NM | 132 | Heavy stain |
| 5 | 144 hours | 555 | 113 | No visible stain |

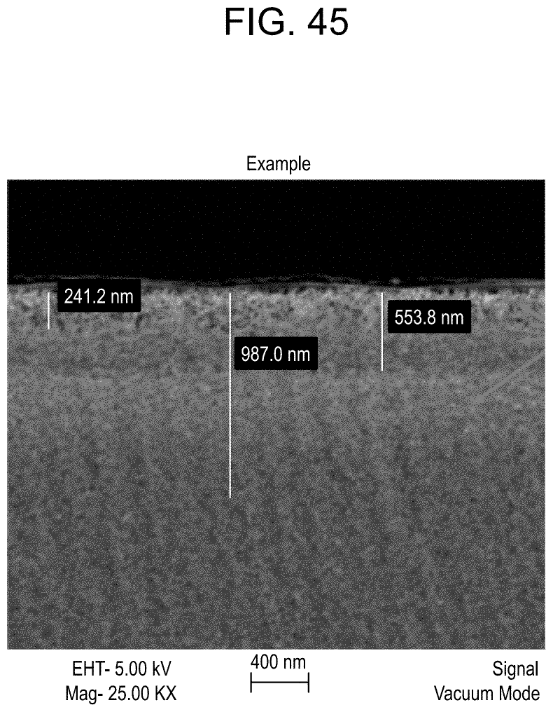

FIG. 45 is a cross hatch micrograph showing alternating layers. The ²⁸Si count rate is used to normalize the signals of the other species measured, thus it is not shown in the depth profiles. In regions where there is surface alteration, this practice avoids artifacts in the data, as shown in FIG. 45. Ions of elemental species are measures with SIMS, not the oxide molecular ions, therefore elemental concentrations are only inferred.

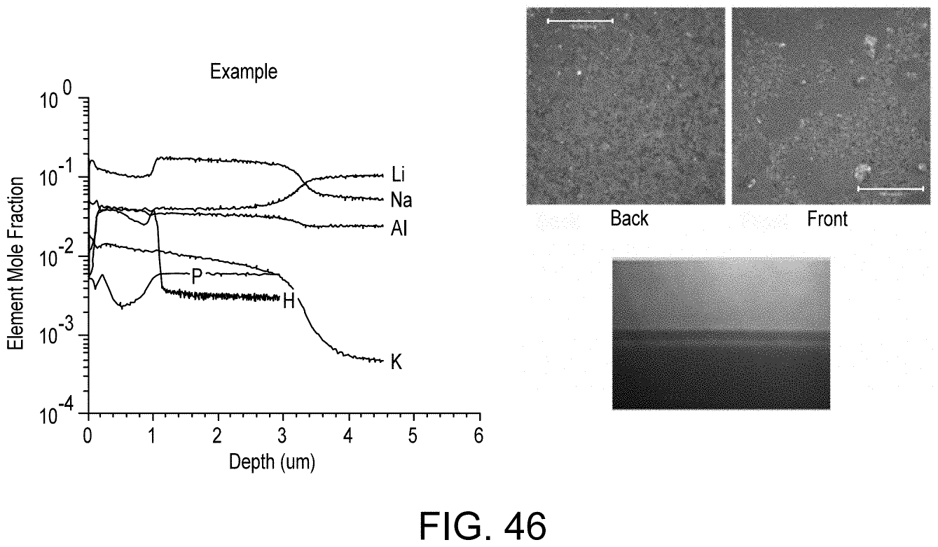

FIG. 46 shows an SIMS profile on the left and micrograph of corrosion on the right of glass-ceramics prepared without Li present in the ion exchange and having a high surface concentration of hydrogen. The SIMS profile indicates the presence of low index layer having a high sodium surface concentration that is similar to what was observed with previous POR DIOX samples. It can be seen that sodium can ion exchange with hydrogen from H₂O to about 1 μm of depth. The micrographs show the back (left) and front (right) of a glass-ceramic with extensive corrosion all over the surface. On the front, the corrosion forms islands of sodium carbonate and perfluoropolyether coating. The SIMS data is aligned with the FSM showing a blurry transition. The table below shows the properties:

TABLE 10

| | Heat Soak | Comp. | Central | |
|---|---|---|---|---|
| Sample | Conditions | Stress | Tension | Notes |
| 0.8 mm | 72 hours, | NM | 120 | Heavy stain |
| | 85° C. 85% | | | |
| | relative | | | |
| | humidity | | | |

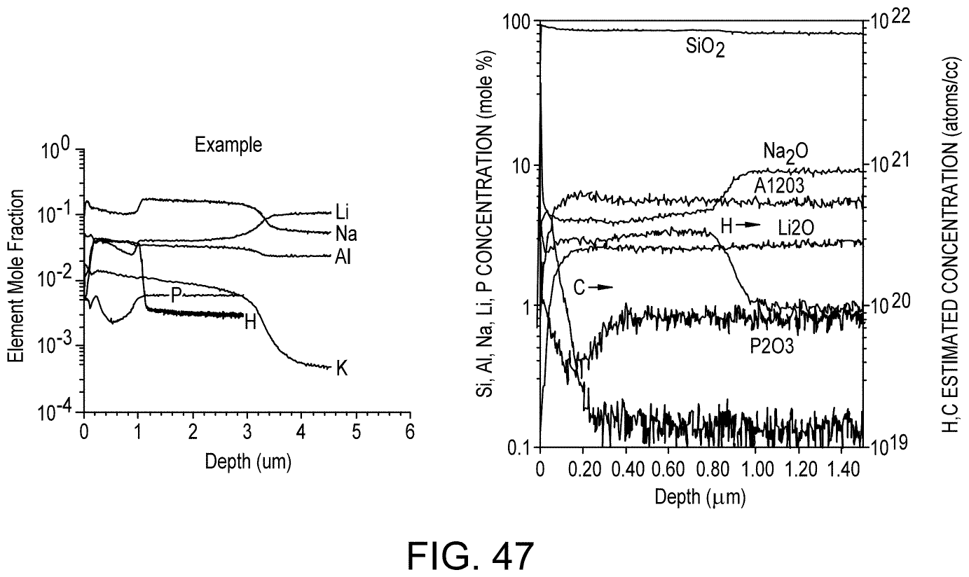

FIG. 47 shows depth of elemental ingress in mole fraction in the left image and concentration of components versus depth in the right image for the sample in the above table.

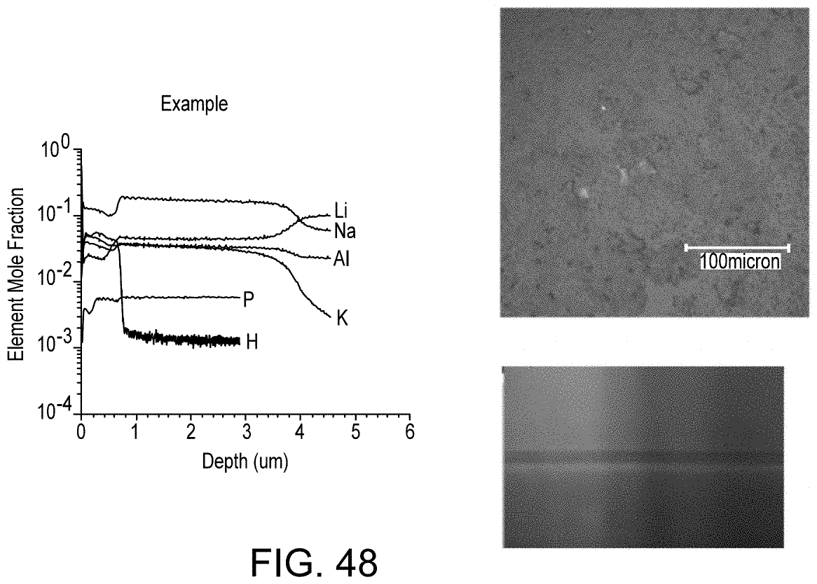

FIG. 48 shows an SIMS profile on the left and micrograph of corrosion on the right of glass-ceramics prepared without Li present in the ion exchange and having a high surface concentration of hydrogen. The SIMS profile indicates the presence of low index layer having a high sodium surface concentration that is similar to what was observed with previous POR DIOX samples. It can be seen that sodium can ion exchange with hydrogen from H₂O to about 1 μm of depth. The micrographs show the glass-ceramic with extensive corrosion all over the surface. The SIMS data is aligned with the FSM showing a blurry transition. The table below shows the properties:

TABLE 11

| | Heat Soak | Comp. | Central | |
|---|---|---|---|---|
| Sample | Conditions | Stress | Tension | Notes |
| 0.5 mm | 72 hours, | NM | 132 | Heavy stain |
| DIOX | 85° C. 85% | | | |
| no deco | relative | | | |
| | humidity | | | |

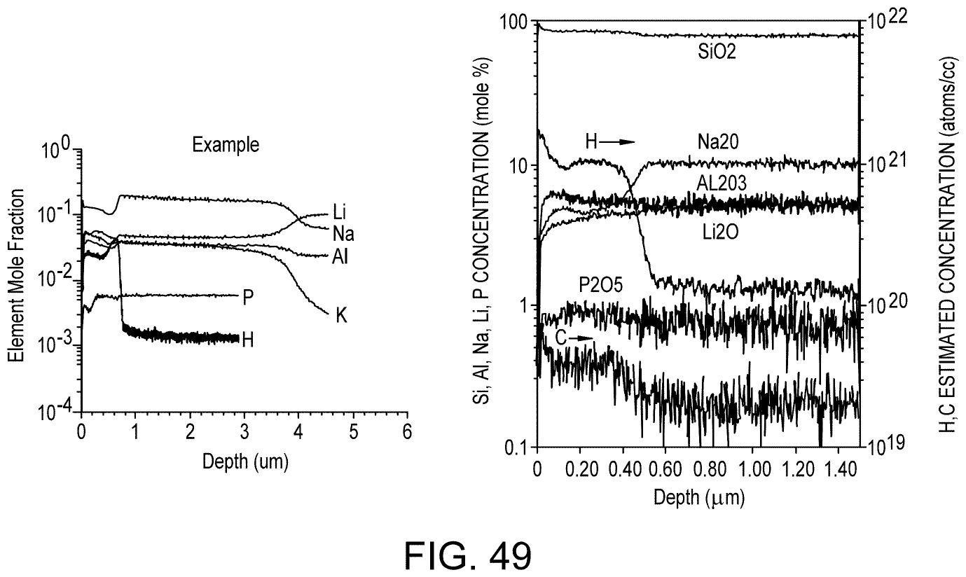

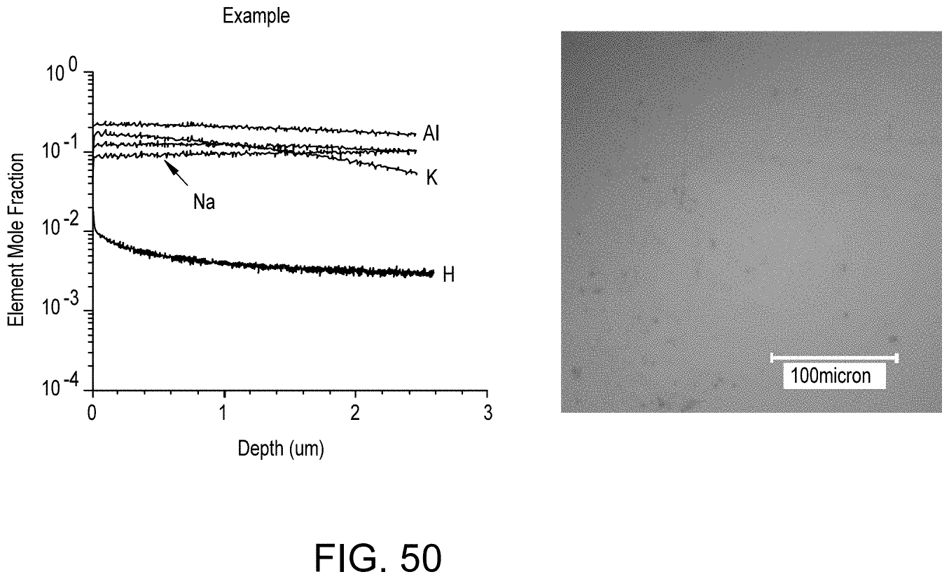

FIG. 49 shows depth of elemental ingress in mole fraction in the left image and concentration of components versus depth in the right image for the sample in the above table.

FIG. 50 shows depth of elemental ingress in mole fraction in the left image and a micrograph of the surface of the glass-ceramic where Li is present in the ion exchange. In this sample, the amount of hydrogen at the surface and into the bulk is not much different than the previous samples, but it does not corrode because it is chemically stable. Accordingly, OH/Si ratio is not necessarily a good indicator of durability and corrosion resistance. The micrograph on the right shows dirt present on the surface, but no corrosion.

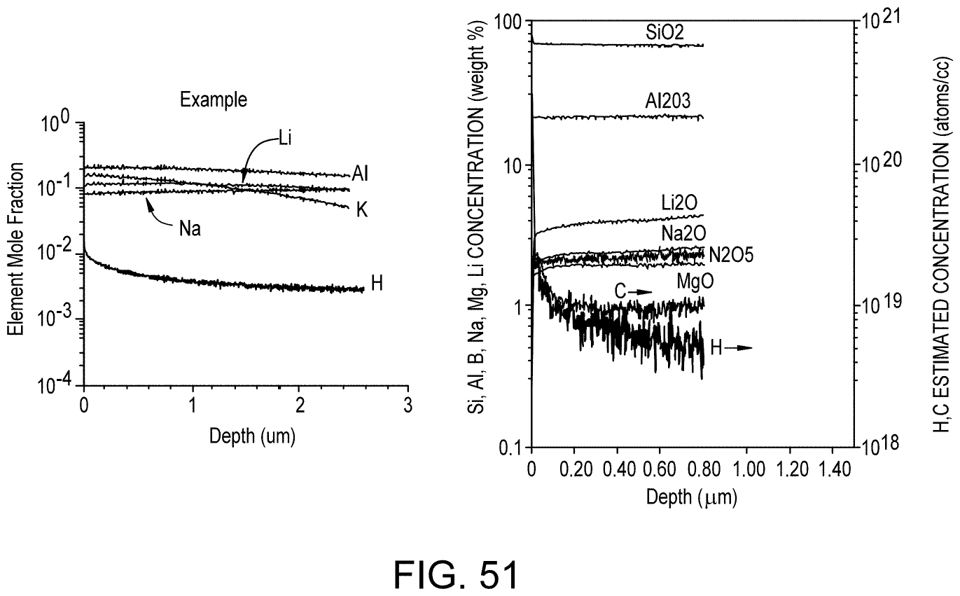

FIG. 51 shows depth of elemental ingress in mole fraction in the left image and concentration of components versus depth in the right image for the sample where Li is present in the ion exchange.

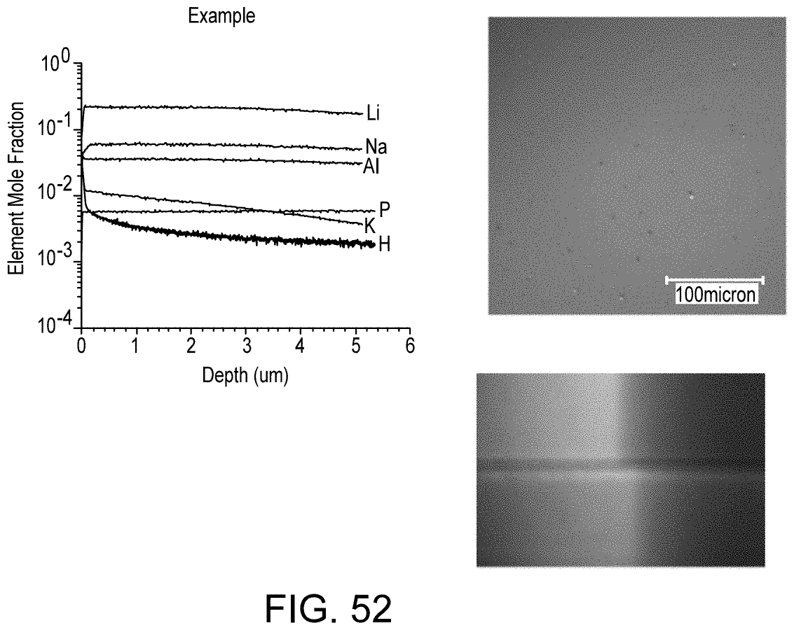

FIG. 52 shows depth of elemental ingress in mole fraction in the left image and a micrograph of the surface of the glass-ceramic where Li is present in the ion exchange. In this DIOX sample, there is no sodium rich layer as the sodium is chemically stable. There is small depletion of sodium near the surface and some hydrogen enrichment that is typical for alkali-containing glass based compositions. The micrograph on the right shows dirt present on the surface, but no corrosion. The SIMS data is aligned with the FSM showing a sharp transition. The table below shows the properties:

TABLE 12

| | Heat Soak | Comp. | Central | |
|---|---|---|---|---|
| Sample | Conditions | Stress | Tension | Notes |
| 0.6 mm | 72 hours, | 320 | 123 | No visible stain |
| SIOX no | 85° C. 85% | | | |
| deco | relative | | | |
| | humidity | | | |

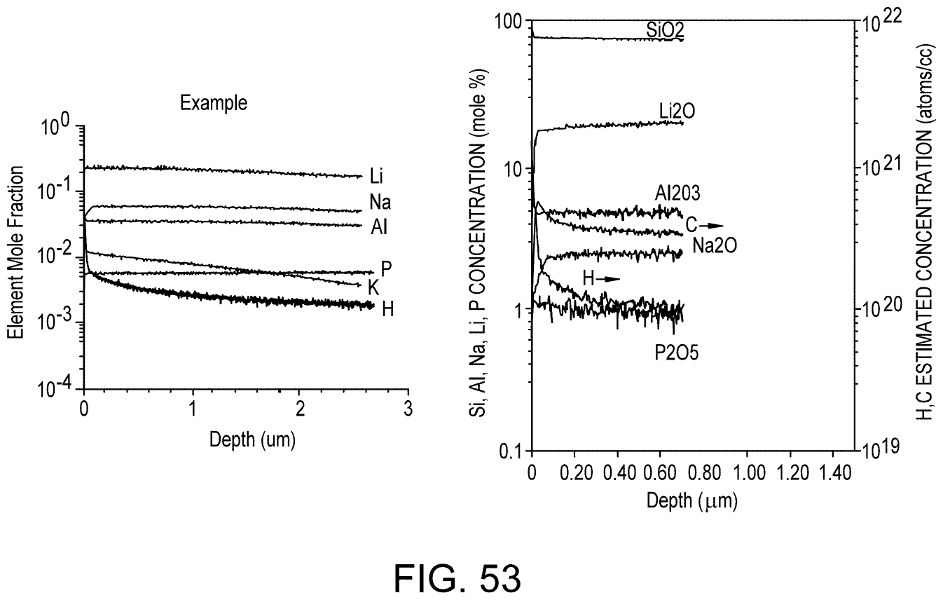

FIG. 53 shows depth of elemental ingress in mole fraction in the left image and concentration of components versus depth in the right image for the sample where Li is present in the ion exchange, for the sample in the above table.

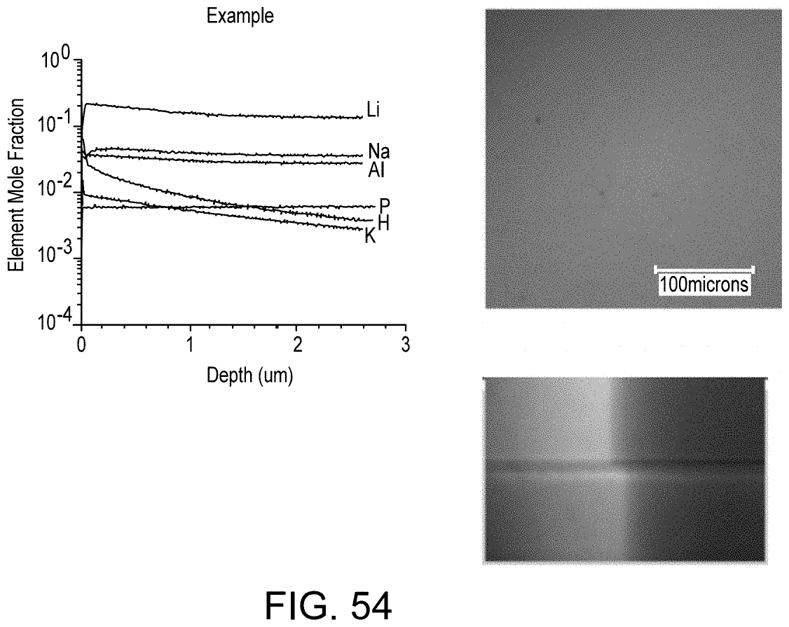

FIG. 54 shows depth of elemental ingress in mole fraction in the left image and a micrograph of the surface of the glass-ceramic where Li is present in the ion exchange. In this sample, there is no sodium rich layer as the sodium is chemically stable. There is small depletion of sodium near the surface and some hydrogen enrichment that is typical for alkali-containing glass based compositions. The micrograph on the right shows dirt present on the surface, but no corrosion. The SIMS data is aligned with the FSM showing a sharp transition. The table below shows the properties:

TABLE 13

| | Heat Soak | Comp. | Central | |
|---|---|---|---|---|
| Sample | Conditions | Stress | Tension | Notes |
| 0.75 mm | 72 hours, | 284 | 106 | No visible stain |
| IOX | 85° C. 85% | | | |
| POR | relative | | | |
| deco | humidity | | | |

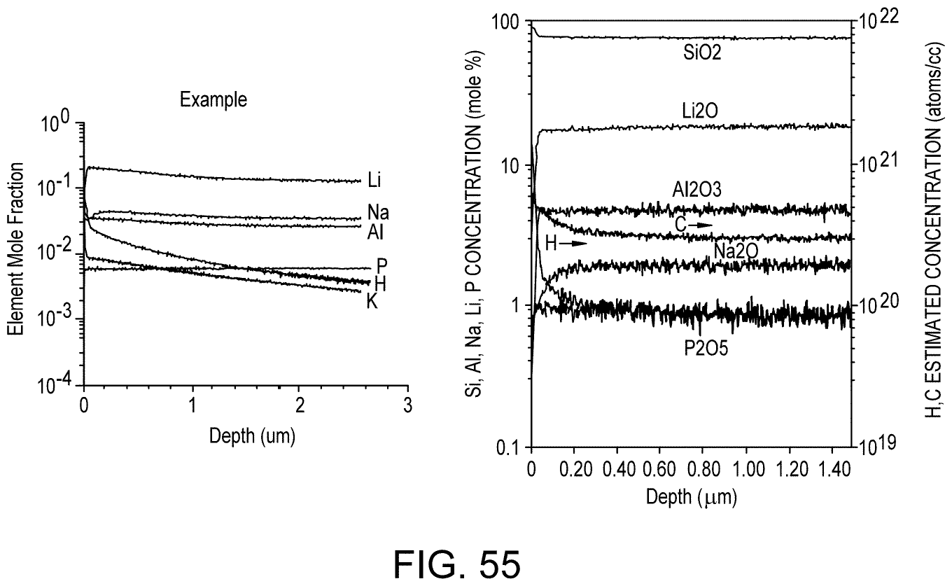

FIG. 55 shows depth of elemental ingress in mole fraction in the left image and concentration of components versus depth in the right image for the sample where Li is present in the ion exchange, for the sample in the above table.

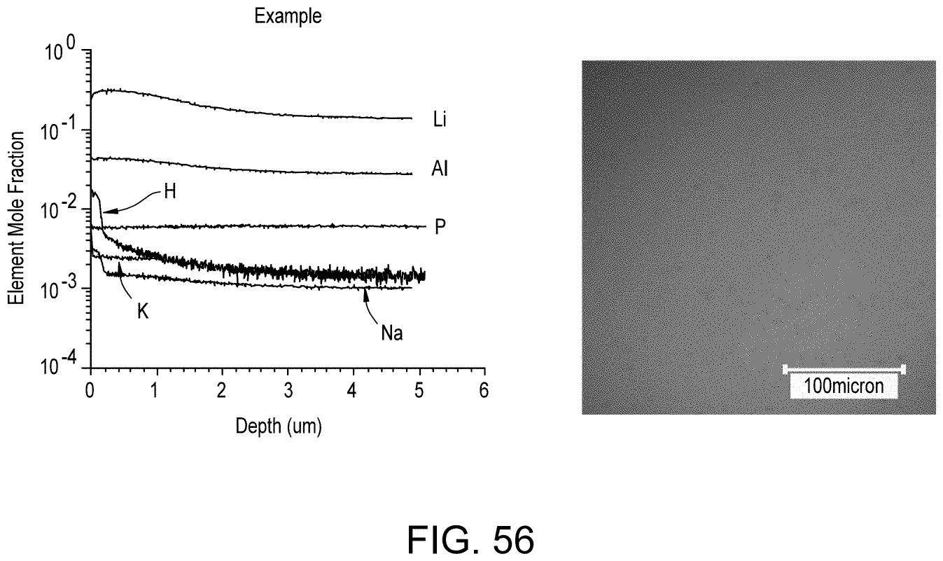

FIG. 56 shows depth of elemental ingress in mole fraction in the left image and a micrograph of the surface of the glass-ceramic where Li is present in the ion exchange. In this sample, there is some correlation between the sodium and hydrogen near the surface, but in this case it is the opposite of what is seen on the samples that exhibit corrosion; both sodium and hydrogen are enriched at the surface. The micrograph on the right shows dirt present on the surface, but no corrosion.

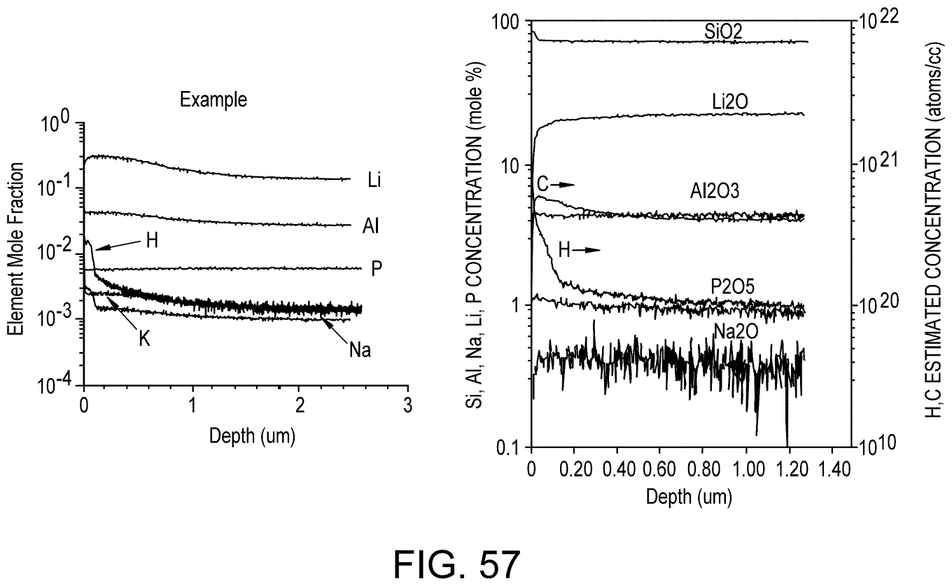

FIG. 57 shows depth of elemental ingress in mole fraction in the left image and concentration of components versus depth in the right image for the sample where Li is present in the ion exchange, for the sample in the above table.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A glass-based article comprising:
greater than or equal to 60 mol % and less than or equal to 72 mol % SiO₂;
greater than 0 mol % and less than or equal to 6 mol % Al₂O₃;
greater than or equal to 0 mol % and less than or equal to 2 mol % B₂O₃;
greater than or equal to 20 mol % and less than or equal to 32 mol % Li₂O;
greater than or equal to 0 mol % and less than or equal to 2 mol % Na₂O;
greater than or equal to 0 mol % and less than or equal to 2 mol % K₂O;
greater than or equal to 0.7 mol % and less than or equal to 2.2 mol % P₂O₅; and
greater than or equal to 1.7 mol % and less than or equal to 4.5 mol % ZrO₂, wherein:
the glass-based article has a phase assemblage comprising from 35-50 wt % petalite, 35-50 wt %, lithium disilicate, wherein a ratio of lithium disilicate to petalite is 0.8-1.

2. The glass-based article of claim 1 comprising:
a surface compressive stress greater than or equal to 200 MPa and less than or equal to 350 MPa; and
a depth of compression of greater than or equal to 0.14*t to less than or equal to 0.24*t, wherein t is a thickness of the glass article.

3. The glass-based article of claim 1, wherein the depth of compression is greater than or equal to 85 μm and less than or equal to 150 μm.

4. The glass-based article of claim 1, wherein the crystal grains of the glass-based article have an aspect ratio greater than 4.

5. The glass-based article of claim 1, wherein a maximum dimension of the crystal grains of the glass-based article is less than 200 nm.

6. The glass-based article of claim 1, comprising a fracture toughness greater than or equal to 1 MPa*m^{1/2}.

7. The glass-based article of claim 1, comprising a transmittance color coordinate in CIELAB color space of:
L*=from 70 to 100;
a*=from −20 to 40; and
b*=from −60 to 60
for a CIE illuminant F02 under SCI UVC conditions.

8. The glass-based article of claim 1, comprising a refractive index greater than or equal to 1.50 and less than or equal to 1.60.

9. The glass-based article of claim 1, comprising an elastic modulus greater than or equal to 95 GPa and less than or equal to 110 GPa.

10. The glass-based article of claim 1, comprising a density greater than or equal to 2.35 g/cm³ and less than or equal to 2.6 g/cm³.

11. The glass-based article of claim 1, comprising an average visible transmittance greater than or equal to 89% at an article thickness of 0.6 mm for wavelengths from 400 nm to 770 nm.

12. The glass-based article of claim 1, comprising an average visible reflectance greater than or equal to 4.4% and less than or equal to 4.8% at an article thickness of 0.6 mm for wavelengths from 400 nm to 770 nm.

13. The glass-based article of claim 1, comprising an average UV transmittance greater than or equal to 70% at an article thickness of 0.6 mm for wavelengths from 350 nm to 400 nm.

14. The glass-based article of claim 1, comprising an average UV reflectance greater than or equal to 4.7% and less than or equal to 5.0% at an article thickness of 0.6 mm for wavelengths from 350 nm to 400 nm.

15. The glass-based article of claim 1, comprising an average infrared transmittance greater than or equal to 89% at an article thickness of 0.6 mm for wavelengths from 770 nm to 1000 nm.

16. The glass-based article of claim 1, comprising an average infrared reflectance greater than or equal to 4.3% and less than or equal to 4.5% at an article thickness of 0.6 mm for wavelengths from 770 nm to 1000 nm.

17. The glass-based article of claim 1, wherein a central tension is from greater than or equal to 90 MPa to less than or equal to 125 MPa.

18. The glass-based article of claim 1, wherein a ratio of central tension to integrated tension area is from greater than or equal to 3.0 um⁻¹ to less than or equal to 5.5 um⁻¹.

19. The glass-based article of claim 1, wherein a ratio of central tension to depth of compression is from greater than or equal to 0.6 MPa/μm to less than or equal to 1.0 MPa/μm.

20. The glass-based article of claim 1, wherein a haze of the glass-based article is less than or equal to 0.15%.
